(19) United States
(12) Patent Application Publication
(10) Pub. No.: US 2015/0120447 A1
(43) Pub. Date: Apr. 30, 2015

(54) METHODS AND SYSTEMS FOR GENERATING DOMAIN NAME AND DIRECTORY RECOMMENDATIONS

(71) Applicant: Jeffrey Blemaster, Los Angeles, CA (US)

(72) Inventor: Jeffrey Blemaster, Los Angeles, CA (US)

(21) Appl. No.: 14/586,680

(22) Filed: Dec. 30, 2014

Related U.S. Application Data
(63) Continuation of application No. 14/490,573, filed on Sep. 18, 2014.
(60) Provisional application No. 61/880,164, filed on Sep. 19, 2013.
(60) Provisional application No. 61/923,609, filed on Jan. 3, 2014.
(60) Provisional application No. 61/937,547, filed on Feb. 9, 2014.
(60) Provisional application No. 62/004,203, filed on May 29, 2014.
(60) Provisional application No. 62/041,662, filed on Aug. 26, 2014.

(51) Int. Cl. G06Q 30/02; G06F 17/30

(52) U.S. Cl. CPC G06Q 30/0256; G06F 17/30864
USPC 705/14.54

(57) ABSTRACT

A system receives an indication that an entity has obtained a first domain name. The system receives an indication as to an industry type associated with a website associated with the first domain name. Based on the received industry type, a set of keywords is selected which are related to products and/or services. An entity selection of one or more keywords from the set is received. Using the keyword selections, a keyword directory is identified and associated domain names identifying a product or service is identified. A domain recommendation is generated based at least in part on the identified domain names, wherein the respective second level domains include the identity of the entity. The domain recommendation is transmitted to the entity terminal. At least partly in response to an indication that the entity obtained the first recommended domain name, the first recommended domain name is included the identified keyword directory.

### CROSS-REFERENCE TO RELATED APPLICATIONS

This application is a continuation of U.S. application Ser. No. 14/490,573, filed Sep. 18, 2014, which claims the benefit of U.S. provisional application Ser. No. 61/880,164, filed Sep. 19, 2013, U.S. provisional application Ser. No. 61/923,609 filed Jan. 3, 2014, U.S. provisional application Ser. No. 61/937,547 filed Feb. 9, 2014, U.S. provisional application Ser. No. 62/004,203 filed May 29, 2014, and U.S. provisional application Ser. No. 62/041,662, filed Aug. 26, 2014, the contents of which are incorporated herein in their entirety.

### BACKGROUND

1. Field of the Invention

The present invention relates to network directory services.

2. Description of the Related Art

A top-level domain (TLD) is at the top level in the Internet's hierarchical Domain Name System (DNS). Examples of TLDs include .com, .net, .edu, etc. The top-level domain names are installed in the root zone of the Internet.

In a uniform resource locator (URL), the right-most label is the top-level domain (e.g., the URL www.acmeexample.com has .com as the top level domain). The domain hierarchy in a URL descends from the right label to the left label in the URL, where a given label to the left lists a subdomain of the domain to the right. The domain directly below the top level domain is sometimes referred to as a second level domain (e.g., in acmebrand.com, “acmebrand” would be the second level domain of the “.com” top level domain). Further, a URL may include a subdomain (e.g., a third level domain) used to further organize websites. For example, a subdomain may act as a folder under a website's root directory. A subdomain may be a label positioned to the left of the second level domain (e.g., in shoes.acmebrand.com, “shoes” would be the subdomain of acmebrand.com). A subdomain (as used herein unless the context indicates otherwise) may be in the form of a subdirectory. For example, a URL may also include a subdirectory, which may be positioned to the right of the top level domain, after a forward slash “/” (e.g., acmebrand.com/shoes).

Initially, there were seven top level domains as well as country domains. However, recently hundreds of generic top level domains have been added, making it ever more difficult for users to find desired information and for providers of information to be found.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later. It is understood that while various aspects are described, certain embodiments may include any combination of the described aspects, or subsets thereof.

Disclosed herein are methods and systems for organizing and generating network resource directories, such as websites. Currently, the majority of Internet websites may be classified as either a brand name website or a keyword directory website. Among other optional aspects, disclosed herein are methods and systems for registering and classifying websites. For example, websites may be classified as a brand name website or as directory website. Websites are also optionally defined by industry type and/or by keywords that are associated with the products and/or services offered by the websites. Subject specific and appropriate TLD specific keyword directories may be created, and eligible brand name websites may post an advertisement on corresponding TLD specific keyword directories.

System and methods are described which may be configured to organize websites related by category, brand, location, etc. Embodiments disclosed herein utilize TLDs as an organizational tool to benefit providers (e.g., merchants, etc.), end-users, Registrars, and/or TLD registries.

An example embodiment provides a computerized system that collects information about website domain the website for which the domain is going to be used, and cross-references the domain with other domains that have relevant industry types, product types, services types, and/or locations, and generates recommendations of additional domains and/or keyword directories that would increase the effective online brand presence of the website owner. For example, a top-level domain may define or be associated with a category (e.g., cars, coupons, clothing, restaurants, memorials, etc.). The second level domains may be subcategorically related to the top-level domain, for example, by a brand, location, or a generic product or service subcategory. Optionally, a website with such a second level domain is generated using one or more approved or preselected website templates, such as one or more such templates provided by the system, the template(s) providing a structured format for content relating to the category and second level domain. Selected or all websites of third-party second level domain registrants may optionally be required to use such templates to ensure consistency the appropriate relevancy.

The system may optionally include at least one web server that is configured to serve websites for one or more of the second level domains. In this case, the system may optionally further provide an administrative module configured to permit a second level domain registrant to update and manage content on the website associated with their sub domain.

An aspect of the disclosure is a system configured to generate domain name recommendations, comprising: a computing device comprising hardware; non-transitory memory coupled to the computing device that stores program instructions configured to cause the system to perform operations comprising: receiving an indication that a first entity has obtained a first domain name; transmitting a prompt to a first entity terminal, the prompt instructing the first entity to indicate whether the first domain name is or is intended to be used as a locator for a brand name website; at least partly in response to receiving from the first entity terminal an indication that the first domain name is or is intended to be used as a locator for a brand name website, transmitting a second prompt to the first entity terminal prompting the first entity to indicate an industry type associated with the brand name website; receiving from the first entity terminal an indication as to the industry type associated with the brand name website; based at least in part on the received industry type indication, selecting a first set of keywords associated with the industry type, the first set of keywords comprising keywords related to products and services associated with the indicated industry type; providing at least a portion of the first set of keywords associated with the industry type for display via the first entity terminal; receiving from the first entity terminal a selection of one or more keywords from the first set of keywords associated with the industry type; based at least in part on the received one or more keyword selections or the industry type or both the one or more keyword selections and the industry type, identifying one or more existing Top Level Domain name-specific keyword directories and associated domain names, the domain names including one or more labels that identify a product or service of the first entity and the indicated industry type; generating one or more domain recommendations based at least in part on the identified domain names, wherein the recommended domain names include respective second level domains, the respective second level domains including the brand name of the first entity; transmitting the one or more brand name domain recommendations to the first entity terminal; enabling the first entity to obtain at least a first of the recommended one or more domain names; at least partly in response to an indication that the first entity obtained the first recommended domain name, including the first recommended domain name in at least one of the identified Top Level Domain name-specific keyword directories that has the same TLD as the first recommended domain name.

An aspect of the disclosure is a system configured to generate domain name recommendations, comprising: a computing device comprising hardware; non-transitory memory coupled to the computing device that stores program instructions configured to cause the system to perform operations comprising: receiving an indication that a first entity has obtained a first domain name; transmitting a prompt to a terminal of the first entity to indicate an industry type associated with a website associated with the first domain name; receiving from the first entity terminal an indication as to the industry type associated with the website associated with the first domain name; based at least in part on the received industry type indication, selecting a first set of keywords associated with the industry type, the first set of keywords comprising keywords related to products and services associated with the indicated industry type; providing at least a portion of the first set of keywords associated with the industry type for display via the first entity terminal; receiving from the first entity terminal a selection of one or more keywords from the first set of keywords associated with the industry type; based at least in part on the received one or more keyword selections or the industry type or both the one or more keyword selections and the industry type, identifying one or more keyword directories and associated domain names, the associated domain names including one or more labels that identify a product or service of the first entity; generating one or more domain recommendations based at least in part on the identified domain names, wherein the recommended domain names include respective second level domains, the respective second level domains including the brand name of the first entity; transmitting the one or more domain recommendations to the first entity terminal; at least partly in response to an indication that the first entity obtained the first recommended domain name, including the first recommended domain name in at least one of the identified keyword directories that has the same TLD as the first recommended domain name.

An aspect of the disclosure is a computer storage system comprising a non-transitory storage device, said computer storage system having stored thereon executable program instructions that direct a computer system to at least: receive an indication that a first entity has obtained a first domain name; transmit a prompt to a terminal of the first entity to indicate an industry type associated with a website associated with the first domain name; receive from the first entity terminal an indication as to the industry type associated with the website associated with the first domain name; based at least in part on the received industry type indication, select a first set of keywords associated with the industry type, the first set of keywords comprising keywords related to products and services associated with the indicated industry type; provide at least a portion of the first set of keywords associated with the industry type for display via the first entity terminal; receive from the first entity terminal a selection of one or more keywords from the first set of keywords associated with the industry type; based at least in part on the received one or more keyword selections or the industry type or both the one or more keyword selections and the industry type, identify one or more keyword directories and associated domain names, the associated domain names including one or more labels that identify a product or service of the first entity; generate one or more domain recommendations based at least in part on the identified domain names, wherein the recommended domain names include respective second level domains, the respective second level domains including the brand name of the first entity; transmit the one or more domain recommendations to the first entity terminal; at least partly in response to an indication that the first entity obtained the first recommended domain name, include the first recommended domain name in at least one of the identified keyword directories that has the same TLD as the first recommended domain name.

An aspect of the disclosure is a computer-implemented method comprising: receiving at a computer system comprising computer hardware configured with specific executable instructions, an indication that a first entity has obtained a first domain name; transmitting, by the computer system, a prompt to a terminal of the first entity to indicate an industry type associated with a website associated with the first domain name; receiving, by the computer system, from the first entity terminal an indication as to the industry type associated with the website associated with the first domain name; based at least in part on the received industry type indication, selecting, by the computer system, a first set of keywords associated with the industry type, the first set of keywords comprising keywords related to products and services associated with the indicated industry type; providing, by the computer system, at least a portion of the first set of keywords associated with the industry type for display via the first entity terminal; receiving, by the computer system, from the first entity terminal a selection of one or more keywords from the first set of keywords associated with the industry type; based at least in part on the received one or more keyword selections or the industry type or both the one or more keyword selections and the industry type, identifying, by the computer system, one or more keyword directories and associated domain names, the associated domain names including one or more labels that identify a product or service of the first entity; generating, by the computer system, one or more domain recommendations based at least in part on the identified domain names, wherein the recommended domain names include respective second level domains, the respective second level domains including the brand name of the first entity; transmitting, by the computer system, the one or more domain recommendations to the first entity terminal; at least partly in response to an indication that the first entity obtained the first recommended domain name, causing the first recommended domain name to be included in at least one of the identified keyword directories that has the same TLD as the first recommended domain name.

An aspect of the disclosure comprises systems and methods configured to receive an indication that an entity has obtained a first domain name; provide a prompt via a terminal of the entity to indicate an industry type or purpose associated with a website associated with the first domain name; receive an indication as to the industry type/purpose associated with the website associated with the first domain name; based at least in part on the received industry type/purpose indication, select a set of keywords (e.g., associated with the industry type, where the keywords are optionally related to products and/or services associated with the industry type); provide at least a portion of the set of keywords to the entity terminal; receive a selection of one or more keywords from the set of keywords; based at least in part on the received one or more keyword selections or the industry type or both the one or more keyword selections and the industry type, identify a keyword directory and an associated domain name (e.g., where the associated domain name includes a label that identify a product or service); optionally generate a domain recommendation (e.g., based at least in part on the identified domain names), wherein the recommended domain names include respective second level domains (e.g., where the respective second level domains include the brand name of the entity); transmit the domain recommendation to the entity terminal. Optionally, at least partly in response to an indication that the entity obtained the first recommended domain name, the first recommended domain name is included the identified keyword directory (e.g., that has the same TLD as the first recommended domain name).

An aspect of the disclosure comprises systems and methods configured to receive an indication that an entity has obtained a first domain name; transmit or otherwise provide a prompt to or via an entity terminal to indicate an industry type associated with a website associated with the first domain name; receive an indication as to the industry type; based on the received industry type, select a set of keywords associated with the industry type and related to products and/or services associated with the industry type; provide the set of keywords to the entity terminal; receive a selection of one or more keywords; based at least in part on the received one or more keyword selections or the industry type or both the one or more keyword selections and the industry type, identify a keyword directory and associated domain names identifying one or more products or services; generate a domain recommendation based at least in part on the identified domain names, wherein the respective second level domains of the recommended domains include the identity of the entity; and transmit the domain recommendation to the entity terminal. At least partly in response to an indication that the entity obtained the first recommended domain name, the first recommended domain name is included the identified keyword directory.

A system receives an indication that an entity has obtained a first domain name. The system receives an indication as to an industry type associated with a website associated with the first domain name. Based on the received industry type, a set of keywords is selected which are related to products and/or services. An entity selection of one or more keywords from the set is received. Using the keyword selections, a keyword directory is identified and associated domain names identifying a product or service is identified. A domain recommendation is generated based at least in part on the identified domain names, wherein the respective second level domains include the identity of the entity. The domain recommendation is transmitted to the entity terminal. At least partly in response to an indication that the entity obtained the first recommended domain name, the first recommended domain name is included the identified keyword directory.

The computer systems may include at least one processor, processor-accessible computer memory, and processor-executable computer instructions stored in the computer memory, the instructions configured to direct the processor to carry out the various functions and processes disclosed herein in conjunction with hardware, such as one or more web servers.

Additional features, advantages, and embodiments may be set forth or apparent from consideration of the following detailed description and claims. Moreover, it is to be understood that both the foregoing summary and the following detailed description are exemplary and intended to provide further explanation without limiting the scope of the invention.

### BRIEF DESCRIPTION OF THE DRAWINGS

Throughout the drawings, reference numbers may be re-used to indicate correspondence between referenced elements. The drawings are provided to illustrate example embodiments described herein and are not intended to limit the scope of the disclosure.

FIG. 1 illustrates an example illustrative platform architecture of a coupon-centric system embodiment (.Qpon) with respect to end-user interactions and third-party second level domain registrant administration functions.

FIG. 2 illustrates an example process enabling an end-user to access a generic second level domain within the .Coupon TLD namespace.

FIG. 3 illustrates an example website log-in process with related features.

FIG. 4 illustrates example administration modules.

FIG. 5 illustrates an example of a brand.Coupon website.

FIG. 6 illustrates an example of a reports and analytics user interface enabling the third party registrant to track coupon selection and redemption.

FIG. 7 illustrates an example second level domain registration and website setup process.

FIG. 8 illustrates an example directory website at product-subcategory.TLD that includes links to brandname.TLD websites.

FIG. 9 illustrates an example of a .Coupon website including offers and coupon links for laptop computers,

FIG. 10 illustrates an example registration process in which a third party registrant brand may request inclusion and/or premier (featured) display of their website(s) or links thereto in directories for generic location and/or generic product/service second level domains within the .TLD domain space.

FIG. 11 illustrates an example directory of listings at a generic product.Coupon website, with premier listings prominently featured.

FIG. 12 illustrates an example brand.Coupon website that is linked from the premier listing in the directory shown in FIG. 11.

FIG. 13 illustrates an example directory website at location-subcategory.TLD that includes links to related brandname.TLD websites.

FIG. 14 illustrates an example embodiment of a computer system which may be utilized with respect to processes described herein.

FIGS. 15-17 illustrate example coupon creation and redemption processes.

FIGS. 18-25 illustrate example user interfaces.

FIGS. 26a-b illustrates an example second level domain registration and domain name suggestion process.

FIG. 27 illustrates an example domain name suggestion process in greater detail and

FIG. 28 illustrates an example website creation process.

FIG. 29 illustrates an example website specification process.

FIG. 30 illustrates an example process for designating certified websites and social network pages.

FIG. 31 illustrates an example process for processing certified website requests.

FIG. 32 illustrates an example icon-based search user interface.

FIG. 33 illustrates an example utilization of an icon-based search user interface.

### DETAILED DESCRIPTION

Conventionally, top-level domain (TLD) namespace, such as the .com namespace, is not systematically organized as to subject matter of websites or by semantic relation between domain labels and the corresponding websites. Conventionally, if a user were to go to a URL such as laptops.com to search for laptop products, there may be a site there with a conventional directory (linking to other websites and roughly categorizing those links) or it may be squatted on with no content other than an offer for sale of the domain. Further, conventionally the URL may be forwarded to an unrelated website. This conventional environment is inherently inefficient and unreliable with respect to organizing network resources, such as a website. While search engines have made it possible to find desired information, they are also unreliable. For example, currently, if a user queries a search engine with the keyword “laptops”, the search results typically include many unrelated results necessitating that the user “weed through” the results in search of what they are actually looking for. In addition, the reliability of search engine search results is further degraded by practices, such as search engine optimization (SEO), which may be used by some website owners to place less relevant results above more relevant results by exploiting the factors considered by a search engine's ranking algorithm. The foregoing issues have been further exacerbated by the large increase in the number of TLDs that have been made available.

Certain embodiments address the above challenges using computer-implemented methods and computerized systems for more efficient, organized and reliable searching and provision of pertinent network content.

Currently, there is little motivation for an entity with a brand name that already has a .com website to register additional domain names with other TLD extensions. The current methods of search engines effectively discourage entities (e.g., brand owners) from registering new domain names because it takes an extended period of time and SEO efforts enhancements in order to achieve a useful placement in conventional search results (e.g., within the first three pages or 30 search result items). The great expense required to adequately brand a new website is not cost-effective. An owner of a brand name with a new website conventionally must purchase expensive sponsored listings on conventional search engines in order to achieve a useful placement in search results. If users cannot find a website, for commercial purposes it is as if the website does not exist, and so it is difficult for new brands to promote their website and conduct commerce.

What is needed and provided herein are systems and methods for organizing websites and webpages, and that create leaner, more relevant and cost effective search results, and which enable the Internet to be more efficiently utilized and exploited by both merchants and users. Additionally, the provision of such leaner, more relevant search results has become increasingly advantageous with the increasing popularity of mobile devices and their relatively smaller displays, which are less capable of displaying large number of search results.

Conventional internet directories have existed for some time. However, conventional internet directories are very disorganized because they allow different TLD websites to exist on a directory webpage which have no or little relationship to the subject matter or purpose of the directory.

Embodiments discussed herein provide such needed organization. Embodiments disclosed herein optionally provide TLD specific keyword directories. For example, a TLD specific keyword directory's URL may include a specific TLD, and the TLD specific keyword directory optionally may be restricted so as to include/list only websites that are of the same TLD extension as the a TLD specific keyword directory. Optionally, website owners may register to have links to their website(s) included on one or more TLD specific keyword directories relevant to their products or services. This technique provides an organizational tool that arranges or files the websites' locators (e.g., URLs) into TLD folders (e.g., logical folders or other organizational tools).

Optionally, the purpose of individual websites may be determined by gathering information about and/or from the websites, and the websites may be categorized by website type, industry type, and/or keywords. Such gathered information may be used to enable the system to determine what TLD specific keyword directories may be appropriate for a given website, and which other TLDs may be relevant to the website or an associated brand. The system may generate recommendations or suggestions (either of which, for the sake of simplicity, may be referred to as recommendations) for a given website owner with respect to TLDs and directory categories of relevancy, enabling the website/brand owner to beneficially create and increase their Internet presence, and to enable end-users to quickly and efficiently search for and find the brand owner's websites.

With the introduction of thousands of new TLDs, there will be a sufficient amount of TLDs in the Internet environment for end-users to reference and recognize a TLD as a theme “folder” or the specific purpose of the domain name (e.g., a user will recognize that the TLD “.memorial” is for memorials, the TLD “.cars” is for domains relating to the auto industry, etc.). The user-interpretation and user-behavior will change because the TLD itself may be used to reliably reflect the purpose and theme of a website having that TLD. Previously, with only a very limited number of generic TLDs (e.g., 22 gTLDs), a specific theme for a TLD could not be reliably achieved. For example, most registered domain names utilize the “.com” TLD. The websites with the .com TLD are directed to a vast number of purposes and themes, and so the .com TLD does not provide end-users with an indication as to the purpose of a given .com website, and so the .com TLD cannot act as an identifier of any specific subject matter or purpose.

Indeed, conventional websites often have all purposes of the website owner under one domainname.TLD, with folders (e.g., /basketball/shoes) after the TLD in the URL (e.g., domainname.TLD/basketball/shoes) for item-specific webpages within the one website. One of the motivations to maintain all online purposes (e.g., the sales of all products and all services of the website owner) of the website owner under one website is to help the placement and discovery of the website with respect to search engine search results (e.g., by Google(s) or other search engines). The Internet, as we know it, is going to change and the process in which people search needs to change with it as well to accommodate the introduction of thousands of new TLDs.

Further, conventional search systems do not effectively accommodate all of the new TLDs without favoritism because their algorithms are programmed to give substantial search engine optimization (SEO) benefits for the age of the website and they do not currently give significant relative recognition to the website TLD itself. With the introduction of thousands of new TLDs, newly registered websites with the new TLDs will often be lowly ranked (or not ranked at all) in search results as a result of the weight placed by algorithms on the age of the website. Popular search engines do not appear to adequately consider the TLD as an identifier and therefore will not effectively address companies who wish to create many websites with different themes or purposes with new TLD extensions such as .sports, .shoes, .menu, etc. If these new websites are not addressed by search engines and do not adequately appear in search results, the success of these websites will be greatly limited and so companies will be discouraged from purchasing these new domains. Certain embodiments described herein address the foregoing deficit of conventional search engines by adequately recognizing that TLDs may be used to determine a websites relevancy to a user search query.

Currently, directory listing websites return website content that is sometimes not relevant or reliable because they allow multiple types of TLD websites to be listed, and so do not provide an adequate consistency with respect to the theme of a specific niche TLD. Additionally, the website content on the websites listed in the directories are not restricted to a particular purpose, and so may include one or more a spam website, advertising website, a re-direct to another website, or other website that does not have relevant content with respect to what the user is seeking.

For example, the initial page of search results presented by popular search engines presents an unorganized listing of websites and it is very difficult for a brand to appear on a competitive search term for “Sandwiches” or “Restaurants”. For example, if a user searches for “Restaurants”, the first page of search results may include reviews, news articles, blogs, travel sites, etc., which may not be relevant to what the user is looking for. For example, when a user searches for “Restaurants”, typically the user may want to view a listing of restaurants, not news articles. As will be discussed below, using certain embodiments described herein, a user may search keyword directories within a TLD search system with “Restaurants” as the search query, and the TLD search system will return TLD organized search results of keyword directory websites for “Restaurants” (e.g., Restaurants.menu, Restaurants.Qpon, Restaurants.Coupon, Restaurants.eat, restaurants.delivery, etc.). The user can then select the TLD folder(s) that are the most relevant to what the user is are looking for and view the appropriate website listings.

Certain embodiments of a TLD Alliance Search System (TASS) can accommodate all TLDs without uncontrollable favoritism to one TLD or another. Thus, rather than being subjected to the vagaries of SEO, certain embodiments enable brand name websites to control the search result organization for their flagship website, their affiliated websites, and/or their certified websites. The TLD Alliance Search System may sometimes be referred to herein as “TASS”, “the search system”, or simply “the system”, if the context so indicates.

The TLD Alliance Search System (TASS) may be configured to recognize or specify a TLD as a filing folder and accordingly organize the websites into these TLD filing folders (e.g., by assigning a website or brand and its URL(s) to a filing folder), which achieves a more organized Internet for all or many TLD namespaces and optionally provides reciprocal search results (RSR) for TLD namespaces, as described elsewhere herein, to form an alliance and to benefit TLD Registry owners and websites that exist in the TLD namespaces by enabling reciprocating cross traffic in search results.

Certain embodiments file/organize generic keyword terms and locations into TLD specific keyword directories and optionally restrict inclusion into those keyword directories so that they contain only content relevant to that specific TLD. This approach enables an organization of search results and website focus and avoids including thousands or millions of non-relevant search results.

A TLD specific search system is optionally provided. The TLD specific search system is configured to query TLD databases of websites registered with the system to provide search results specific to a specified TLD namespace. Optionally, relevant reciprocal search results that are related to a different TLD namespace may also be included in the search results. Optionally, if both search results specific to a specified TLD namespace and relevant reciprocal search results that are related to a different TLD namespace are included in the search results, the search results specific to a specified TLD namespace are provided with a higher placement or are otherwise emphasized relative to the relevant reciprocal search results that are related to a different TLD namespace.

When a website owner registered their website for inclusion, the TASS enables the website owner to specify relevant information, such as optionally a classification of a brand name website type (where the brand name may be a name given by the website owner to a product or service, and which may be a trademark; and if the owner is using the website for personal use, the “brand name” may be the actual or user name of the owner, e.g. robjones.memorial or johnny.dating), industry type (IT) (which may reflect the type of industry the website is engaged in, or if the website is a personal website, the owner's purpose, such as the type of information the owner is sharing via the website), and/or keywords that relate to the product(s), service(s) and/or location(s) associated with the website or website owner. Such registration information enables website owners, via the TASS, to organize their Internet presence into the relevant categories, which achieves greater benefits than those provided by disorganized conventional search engines or Internet directory systems. The TASS further enables users/consumers to perform a brand name search (BNS) and/or a keyword directory search (KDS). The TASS provides a user interface via which the user can specify brand names and/or keywords for a search query. The TASS receives the user query, performs the search, and organizes the search results according to brand name, product/service, and/or location, etc., and reduces or eliminates search results that are not sufficiently relevant to the user query. Optionally, the system enables links of websites affiliated with a brand name's main/flagship website to be presented together, which efficiently increases brand awareness for such affiliated websites and enables the affiliated websites to benefit from marketing efforts and expenditures made on behalf of the main/flagship website. Further, such search techniques enables brand name owners to create their own SEO for their brand name in the search results. The end-user also benefits from the TLD specific search results because they directly relate to their search query while at the same time receive search results organized into TLD “folders.”

Computerized systems and methods are described herein which ensure that website content for second level domains within a specific top-level domain space are subcategorically related to a category associated with the top-level domain according to a framework imposed by a TLD Registry operator, a registrar, or the TASS operator. As similarly discussed above, the information architecture described herein enables users to rapidly find TLD specific websites having the information they are seeking while greatly reducing or eliminating less relevant search results.

Throughout portions of the following description and in certain drawings, the term TLD operator may also be referred to interchangeably as the “TLD registry” or “the Company”, or “registrar” or “TASS operator”, or may be described as “.Coupon”, “.Qpon”, “.Qpn,” or “.Memorial” as particular examples if the context so indicates. The label “.Qpon” (or sometimes .Coupon) is an example of a specific TLD, which is the following description, is used in accumulating coupon related subject matter for products, services and locations. While embodiments herein may be described with respect to a particular category TLD, (e.g., .Qpon or .Coupon), it should be understood that the systems and methods described herein may be similarly employed with respect to other TLD product or service categories. For example, the TLD “.Memorial” may be used for memorial websites selected from curated category-relevant templates (here, memorial website templates) where the second level domain label (and/or higher level domain labels) identifies the person, such as a deceased loved one, who is the subject of the memorial website. Similarly, embodiments described herein may also be employed using still other TLDs, such as but not limited to .Travel, Hotel, .Resorts, .Hawaii, .Clothing, .Menus, .Restaurants, .Movies, .Electronics, etc.

Embodiments may utilize a specific URL consisting of a term to the left of the period character (“.”) and a specific TLD to the right of the period character (Left Side.Right Side). Optionally, the specific or generic TLD to the right of the period character, dedicated to a specific niche such as “.Qpon,” remains the same throughout the entire process as a user navigates from one site to the next within the specific TLD namespace. Non-limiting examples of second level domain name examples (for a label to the left of the period character “.”) for brand names, generic keywords, and locations, are as follows:

BrandName.Specific TLD

### 1. Brand Name.Qpon Sites:

AcmeBrand.Qpon
BetaBrand.Qpon
GammaBrand.Qpon
DeltaBrand.Qpon

Generic Keyword.Specific TLD

### 2. Generic Name.Qpon Sites:

Pizza.Qpon
Coffee.Qpon
Grocery.Qpon
Drugstore.Qpon

Location Keyword.Specific TLD

### 3. Location Name.Qpon Sites:

NewYorkCity.Qpon
California.Qpon
Paris.Qpon
SouthBeach.Qpon

As noted previously, while navigating within a TLD namespace, the label on the right side of the period character (the TLD) stays the same throughout the process. This process provides interconnectivity within a specific TLD namespace, but may optionally include connectivity with other TLDs with similar dedicated focus (e.g., having a similar niche or theme), such as .Qpon, .Deal, and .Save since they all have the same niche/theme of discounts. Other examples of TLDs having a related theme include .Airlines, .CarRental, and .Hotel as they all relate to the travel industry and may be marketed as such. The TLD registry operator implements this process in order to maintain reliability and uniformity of website URLs and TLD specific keyword directories.

For example, the left side of the period character may specify a “Product/Service” or “Location” which references the right side of the period character, the “Niche” (TLD). By implementing this framework, the user receives very targeted search results, which are TLD specific webpages dedicated for a very specific purpose. Advantageously, utilizing systems and methods described herein, use of a conventional search engine is not required (although may be used), yet the results obtained by using the system are consistently more reliable and TLD specific than those obtainable with conventional search engines.

The present method and system are further exemplified below with respect to the TLD “.Qpon”, which is directed to providing pertinent coupons (or related savings offers) to consumers. The TLD .Qpon is used to provide an online and/or mobile platform where consumers can quickly and easily use a sophisticated search and filtering system that optionally does not require a search engine to find goods and services they want, and, whether they are at home on a computer or on the go with their mobile devices, enables users to be able to compare coupons, coupon codes, and offers across a huge selection of retailers. After they compare and select offers and coupons from a multitude of options, they simply click on (or otherwise select) the best offer per their criteria and conclude their transaction by going to the merchant's website where they will have the ability to print, text, save to cart, and/or send/save to an application (e.g., a Qpon app) their chosen coupon or coupon code, optionally without being charged any fees. Thus, a coupon TLD registry system enables a user to compare competing offers/discounts via the website or application and makes the couponing process fast, easy and convenient. Optionally, the user is spared from having to sign-up for daily deals that do not meet the user's needs or search for deals from individual retailers without having the ability to compare them to a group of competing deals. Optionally, coupons are enabled at point-of-sale and through the mobile app, optionally utilizing GPS, beacon, or other technology to identify a user's location in order to deliver current offers from participating brand name businesses closest to the user's proximity.

Certain optional benefits provided by the coupon-related processes and systems described herein will now be discussed. Consumers typically prefer to pay less for items and services. However, in the current consumer landscape, finding coupons, coupon/promotional codes, and offers can be very time consuming and it is often not worth the time and effort of hunting down the deal. To address this challenge, for a given retailer having a brick and mortar presence, the system may enable the retailer to provide, via a website whose domain is QPON (or other TLD indicating coupons) and whose second level domain in the retailer's name (e.g., RETAILERNAME.QPON), to provide users with the retailer's coupons and sales information, conveniently listed. The system (or another system) may provide scannable coupon(s) which may be downloaded to and displayed on the user's mobile device (e.g., smartphone or tablet) for scanning at the cash register and for application to the purchase.

The coupon-related embodiment optionally enables the consumer to enter a generic search term for the product (or service) they are inquiring about via a user interface provide via a terminal (e.g., a desktop computer, a laptop computer, a mobile communication device, such as a tablet or smart phone, etc.) to receive and to compare many different companies' coupons and offers. For example, if the consumer enters pizza.Qpon, the participating pizza restaurant coupon listings will be returned by the coupon TLD registry system to the consumer's terminal via a webpage, application interface, or otherwise. The .Coupon (e.g., .QPON) sites will be included in the listings, enabling the consumer to quickly see who has the best offer and to take advantage of such offer (e.g., the listing may list the following illustrative example listings: $2 off a Large AcmePizza 1 ingredient pizza vs. $2.50 off a Medium BetaPizza 2 ingredient pizza vs. $3 off an Extra Large Pizza from the local independent pizzeria, etc.). The operator of the system (e.g., the domain name owner, the TLD registry, the registering registrar of the domain name and/or system, etc.) may optionally earn “Pay-Per-Click” (PPC) revenue when the consumer clicks on (or otherwise selects) the deal/coupon they prefer. The operator of the system may optionally reserve selected generic and location domain names such as fast-food.Qpon, hotels.Qpon, restaurants.Qpon, cars.Qpon, Vegas.Qpon, and a multitude of others for its own use, rather than permitting the selected domain names to be registered by third parties.

The coupon-related embodiment enhances the user experience by providing Internet users a reliable registry service using customizable TLD specific software that helps them to easily find offers (e.g., the best deals) on a wide variety of products and services when and where they need them. If a user (consumer) is looking for a specific service, they may simply enter ExampleService.Qpon. into their web browser address field. If it is a particular product the user is searching for, they may simply enter ExampleProduct.Qpon. Whatever the product or service may be, the coupon registry system makes it easy for consumers to save time and money. The system and method benefits businesses by cost-effectively allowing them to deliver coupons and deals into the hands of consumers without the added cost to print the mailers, postage to send it, and employees to execute the system.

Consumers

The coupon TLD registry system platform improves upon discount and e-commerce systems by enabling the consumer to search for coupons, deals and other promotional codes, optionally using a centralized web and mobile platform containing the aggregation of a wide universe of brand names, locations, and generic key words in a structured framework of web content imposed or specified by the registry operator. Conventional discount retail sites are limiting, due to consumers' inability to actually compare goods and services in a widespread fashion. In addition, conventionally deals are frequently restricted to goods and services that can be significantly limited in choices (or time period of usage), and not always satisfactory to consumers. The coupon platform reduces the effort of trying to search for deals, enabling consumers to use a central platform while selecting from a massive array of coupons for goods and services within the universe of quickly accessible and easy-to-use, coupon (e.g., .Qpon) websites. This controlled environment offers a much more organized Internet, in contrast to conventional online directories and search engines, which typically return too many results unrelated to the specific niche the user is searching.

Optionally, consumers utilizing the platform only have to identify the specific product, service or location they are seeking, and the second level domain (the label on the left side of the period character), and the coupon TLD registry system will search and automatically aggregate the coupons or discount codes that are available within a specific TLD namespace so that consumers are presented with a summary (e.g., a single summary) that enables offers to be compared and optionally has one-click access to the end on-line or mobile merchant that they chose. The system may optionally rank the coupons or discount codes based at least in part on the amount or percentage of the discount, and present the consumer with a specified number of the best coupons and/or discount codes (e.g., the top 10, 20, or 30 coupons and/or discount codes). As the process flow above illustrates, the coupon TLD registry system not only provides consumers with the opportunity to compare retailers, but also optionally researches and delivers the best relevant deals available on the Internet.

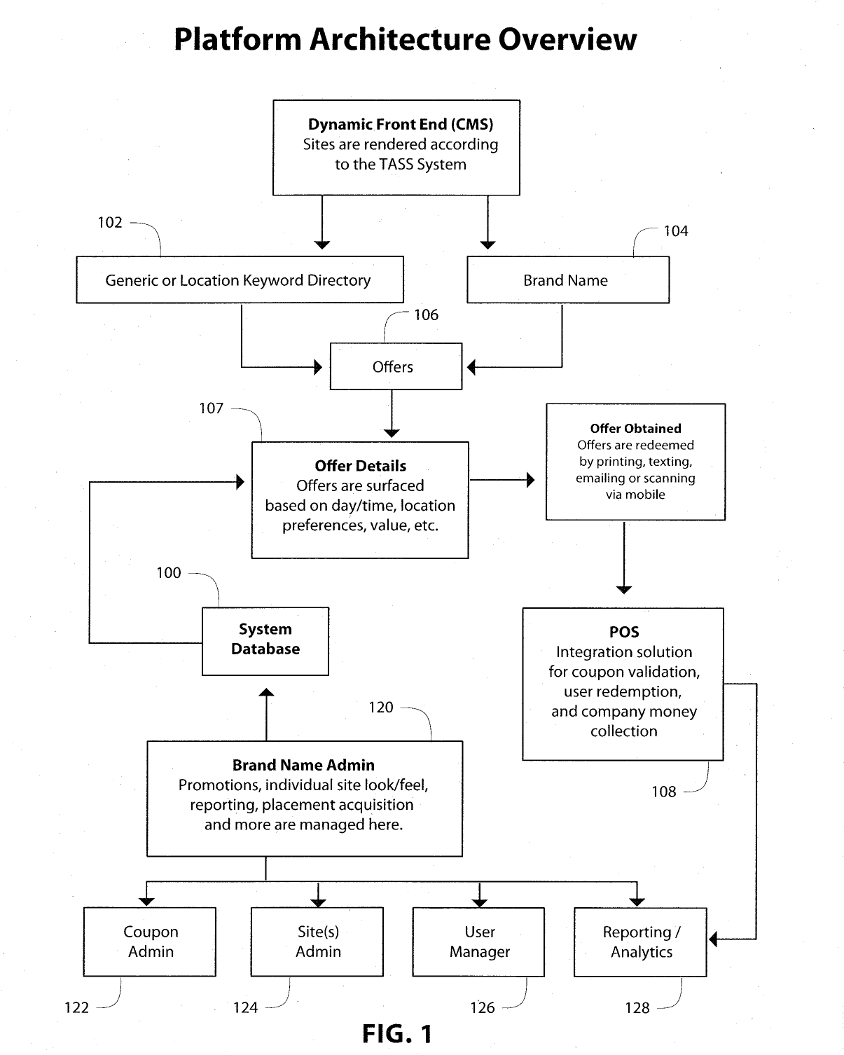

FIG. 1 illustrates an example platform architecture of a coupon-centric system embodiment (.Coupon) 100 with respect to consumer (end-user) interactions and third-party second level domain registrant administration functions. On the consumer side, the site provides a dynamic front end that renders sites that have generic (product/service) or location-based second level domain (e.g., second-level domain) labels 102 or brand name based second level domain labels 104 within the .Coupon TLD space controlled by the system (which optionally operates the registry for the TLD). Upon accessing one of the sites, the system generates and presents an initial listing of offer summaries to consumers 106. Upon receiving a consumer selection of an offer in the initially listed offer summaries, offer details 107, such as a usable coupon, are provided to the consumer (e.g., by serving a printable or scannable image to the consumer's computing device, texting, and/or emailing). The consumer may then use the coupon to receive a discount at a point of sale (POS) device 108. On the brand name administration side, the system 100 provides an administration module and interface 120 enabling the brand name company (or second level domain registrant generally) to manage and administer various functions such as coupon administration 122 (creating and managing the offers that will be provided to end-users), site administration 124, user management 126 (permitting management of conditional access and privileges for various users), and reporting/analytics 128 (providing statistics regarding end-user selection of the coupons presented)

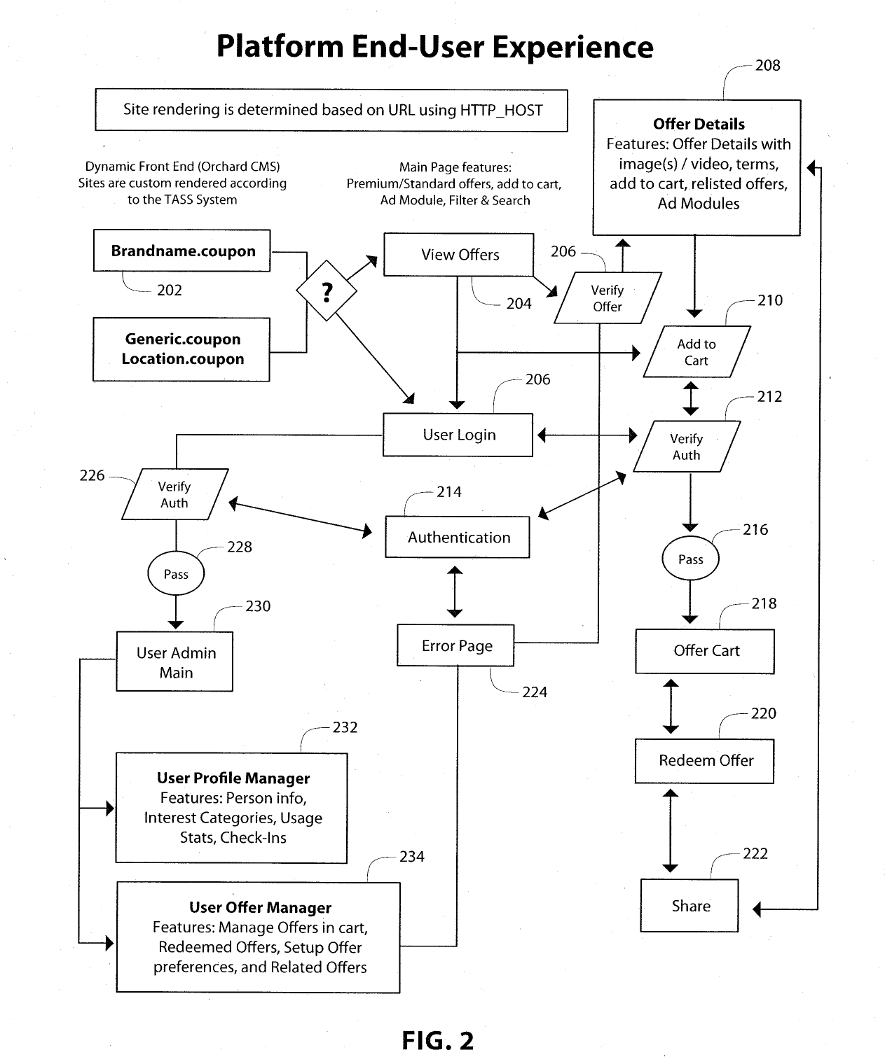

FIG. 2 illustrates an example of a process relating to an end-user accessing a generic second level domain within the TLD namespace (the .Qpon or .Coupon TLD namespace in this example). At 202 the system serves a Brandname.TLD, Generic.TLD, or Location.TLD website (e.g., brandname.Qpon, Generic.Qpon or Location.Qpon, or brandname.Coupon, Generic.Coupon or Location.Coupon) website to the end-user. The main page served may present a listing of some or all offers 204 for that site (e.g., summary versions of the offers) and optionally also provide a field for the end-user to log-in 206 (or register and then login). Log-ins are authenticated (210, 212, 214, 216, 226). Optionally, some offers may require an end-user to log-in (or register and log-in for an unregistered user) to receive the offer details. The main page may further include an add-to-cart feature and a search field may be provided configured to receive user-queries regarding coupons available via the site (or other sites handled by the system), where the search queries may be executed by a search engine and appropriate coupons may be returned in the search results. In the instance a log-in is not required, selection of an offer listing may be followed by verification of the offer 206 (e.g., a verification that the offer is still available and has not expired) followed by providing the offer detail to the end-user 208 or adding the offer first to the offer cart 218 for later retrieval by the end-user, while optionally passing first through offer verification 206 to ensure the offer is still valid.

A user who engages the log-in process 206 is authorized 226 and passes 228, may access a user administration module 230 that includes a user profile manager 232. The user profile manager 232 may present a profile user interface via which the user can enter a profile of personal information, indicate interests and check their user statistics. A user offer manager 234 may be provided which may present a user interface via which users can manage offers saved in their offer cart, set up offer preferences, such as social media account information for sharing offers (and select automatic or manual options), and the like. If the log-in process fails (e.g., as a result of an authentication failure) or the user is attempting to obtain offer details for an offer that is no longer valid, an error page 224 is optionally presented which explains the error. An offer may be redeemed at a point of sale such as a brick-and-mortar store and/or may be redeemed online 220 for an online purchase such as via a direct link from offer details provided to the end-user. The system may also provide the end-user with options to share the offer with others via social media such as Google+®, Facebook®, and/or Twitter®.

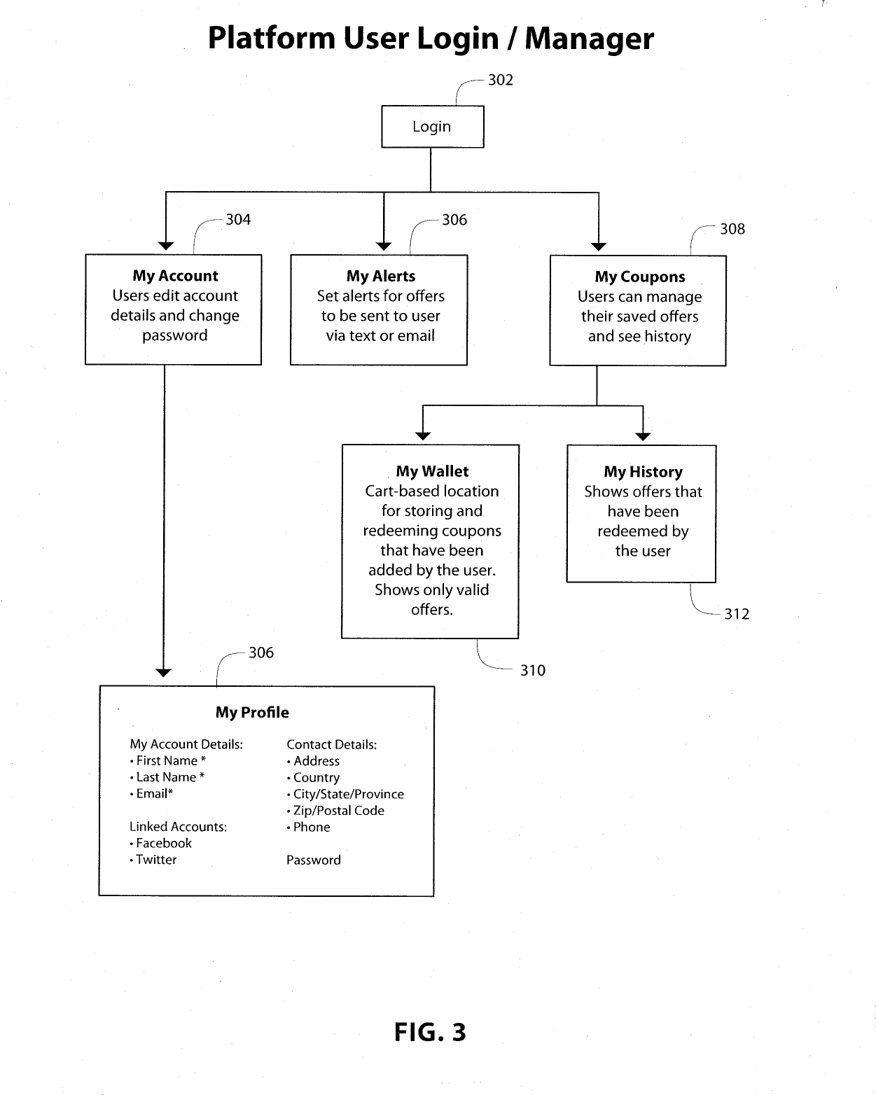

FIG. 3 illustrates an example of a user coupon account administration process with related features, related to an end-user accessing a second level domain within a TLD namespace (the .Qpon TLD namespace in this example). An end-user logs on at 302. Using the My Account submodule 304 the user can edit their account details and manage their username and password. Using the linked My Profile submodule 306, the user can enter information including, for example, any of their real name, email addresses, linked social media accounts, mailing address and telephone contact information. Using the My Alerts submodule 306, an end-user can configure alerts to be sent, for example via text or email, regarding offers of interest, such as within an indicated category of interest or from a brand of interest. Using the My Qpons module 308, a user can manage their saved offers and view a history of their activities on the site. For example, in the My Wallet submodule 310, still valid offers saved in the user's offer cart can be viewed and the offer details obtained for redemption. Using the My History submodule 312, an end-user can view the offers for which they previously obtained offer details. Links to similar current offers may be presented in proximity to the listing of prior obtained offer details. Information and instructions provided by the end-user may be stored by the system in a user database in associated with the end-user's account records for later access.

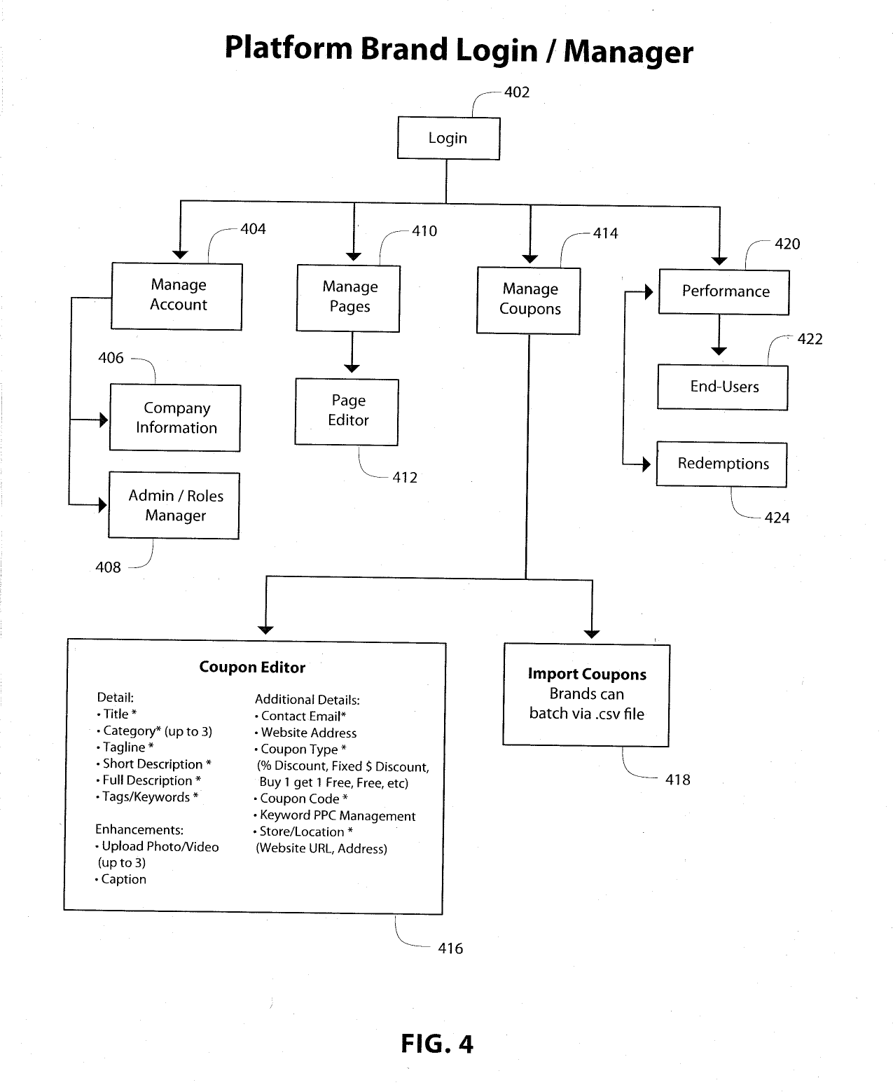

FIG. 4 illustrates example administration modules and functions for a brand name account of a third party second level domain registrant. An authorized person logs-in to the brand management platform 402. The authorized person may access the manage account module which includes the company information submodule 406 that enables company (e.g., third-party registrant) information to be entered and edited, such as name, mailing address, contact information, financial account information, etc. The admin/roles manager submodule permits conditional access and privileges to be granted and managed for users working for the registrant. The manage pages module 410 enables the registrant user to select from different system-provided webpage/website templates for use in creating/designing the website for the registrant's second level domain. The page editor submodule 412 enables the registrant user to upload and manage non-coupon content within the framework of the selected template, such as uploading the company's logo or other non-coupon content within the framework of the template.

The manage coupons module 414 enables the registrant user to create coupon offers online using coupon submodule 416 or to batch import coupon offers via import coupons submodule 418, for example, using a .csv or other type of file. Coupon fields that may be edited in the coupon editor may include some or all of the following: expiration date (or window of validity); coupon details such as title, category (e.g. up to three selections), tagline, short description, full description, and/or tags/keywords. Enhancements to the coupon may include use of a photo image or video (uploaded or selected from a library of image content) with or without an alphanumeric caption. Optionally, additional coupon details that may be edited or managed may include some or all of the following: contact email(s), website address, coupon type (e.g., percent discount, fixed money amount discount, buy one get one free, buy one get one half off, etc., pay-per-click on coupon listing (and/or pay-per-end-user-opens offer details) settings, coupon code, and the URL and/or physical address of participating establishments. Performance module 420 generates and enables the registrant user to view data, statistics and reports regarding the effectiveness of the various coupons. The end-users submodule 422 provides access to the information of users who viewed coupon listings and/or viewed the offer details (e.g., the actual coupon information) linked therefrom. Redemptions submodule 424 generates and provides statistical data as to the viewing of offer details (e.g., the provision of actual coupons). The data may, for example, include gross numbers as well as geographic or time-wise breakdowns of the viewings, and/or performance comparisons between different coupons.

Information and instructions provided by the authorized may be stored by the system in a user database in associated with the brand name owner's/company's account records for later access.

The system may optionally be configured to impose its framework of controlled content when the websites for second level domains are hosted by remote web servers that are not part of the system itself or not controlled by the system. The system may be configured to interrogate such websites, for example, periodically, to determine if they are in compliance with the template requirement (by comparing the web content of the subject web page with a reference template) and/or a “Report webpage” control may be placed on a landing page of an entity's website (e.g., which a user can activate if the user believes that the entity's website does not appropriately correlate with the keyword directory) and, if they are not, change the DNS record in the computerized domain registry so that the second-level domain no longer resolves to the remotely hosted non-compliant website. Thus, optionally: one or more of the second level domains are hosted by a remote web server that is not part of the system or controlled by the system; a DNS record for a remote web server associated with a second level domain is recorded in the computerized domain registry; and the computerized domain registry is further configured to automatically change the DNS away from the remote server for the second level domain if the website at the second level domain is not based on the one or more preselected templates.

Brand Name Sites

A brand name coupon website with a URL that includes the coupon TLD and the brand name as a second level domain (e.g., BrandName.Qpon or BrandName.Coupon) will help the consumer find a brand name coupon or coupon code by going directly to the company's coupon website (e.g., Acmebrand.Coupon to obtain coupons for the Acmebrand company).

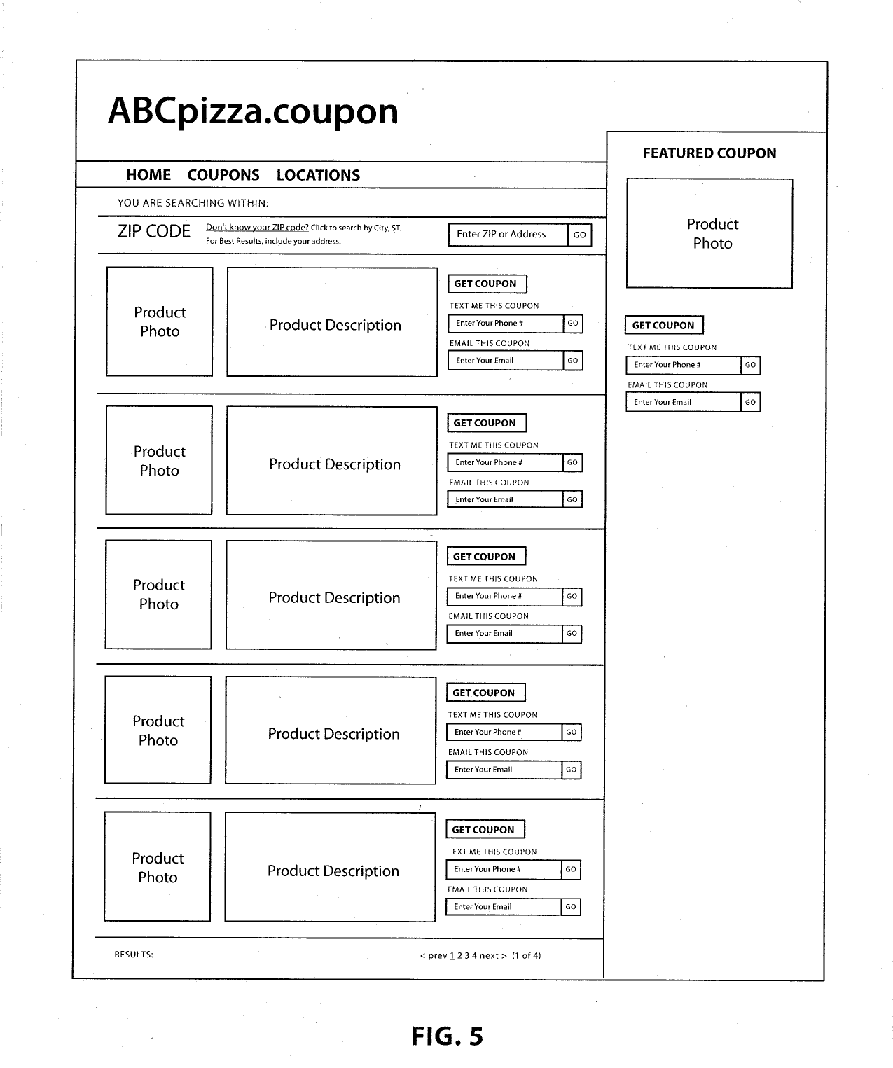

As similarly noted above, the owner of a BrandName.Qpon site may be provided with access to a variety of templates which may be used to create a customized web page (e.g., to display the brand name merchant's colors and logos), which can be saved or uploaded. FIG. 5 illustrates an example of a brand.Coupon website having the URL ABCPizza.Coupon.

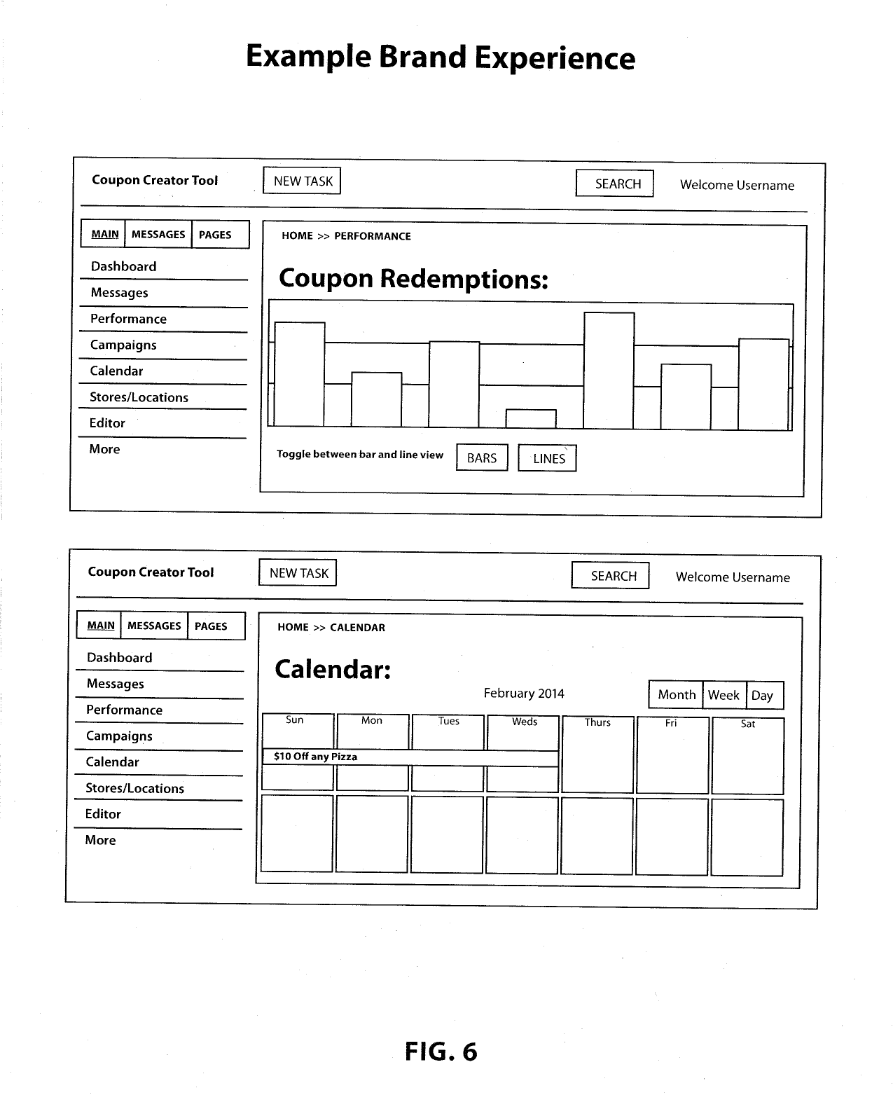

FIG. 6 illustrates an example of a reports and analytics user interface (e.g., presented via a web page or app) that can be generated by the system for a coupon (e.g., a .Qpon or .Coupon) website enabling the third party registrant to track user coupon selection and redemption based on a specified or selected time frame and/or location. The example user interface optionally includes a calendar function that indicates which coupons (e.g., the products that are eligible for the application of the coupon and the coupon value) are active on which calendar days.

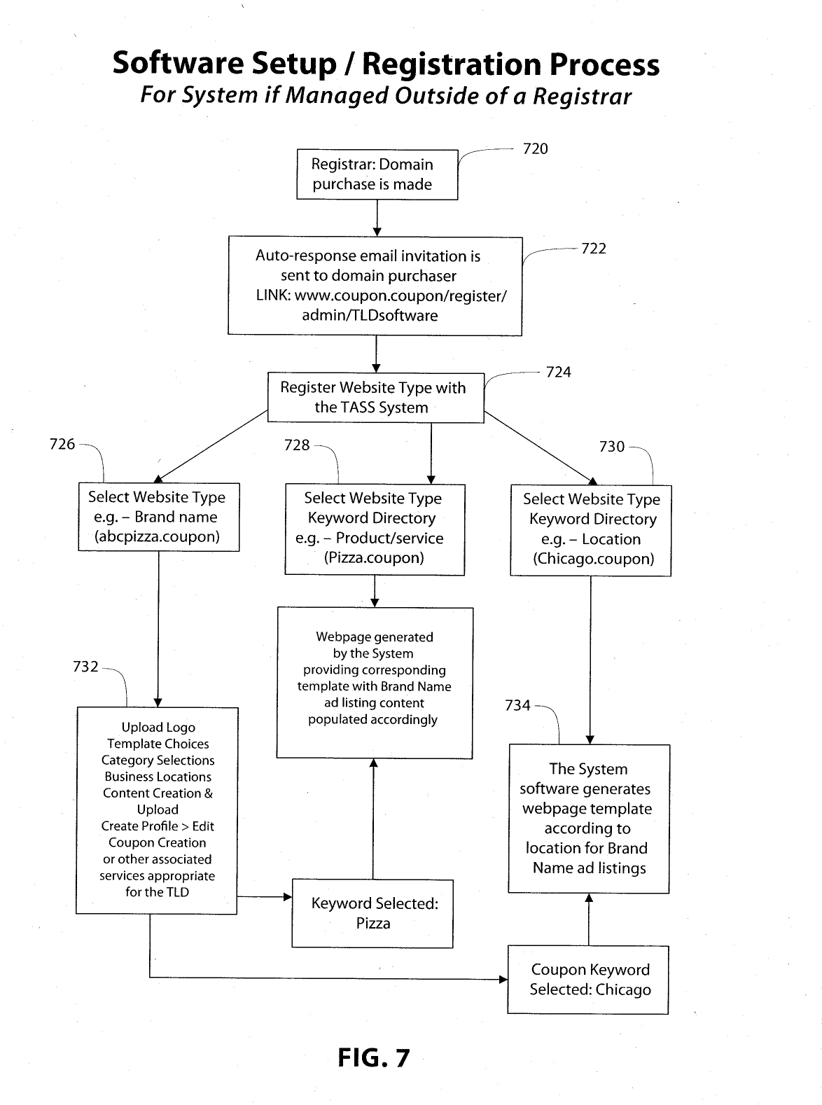

FIG. 7 depicts a flowchart illustrating an example process for registering a domain name with a TLD (a coupon “.Coupon” TLD in this example) second level domain and for setting up a website according to the framework imposed or specified by the TLD registry operator and/or a registrar, and/or an operator of the TASS system. This process may optionally be executed in whole or in part by a system operated by an entity different than the domain registrar. At block 720, the user purchases a domain name with a TLD associated with the end-user's website theme or purpose. For example, the user may purchase a coupon-related domain name (e.g., a .Coupon domain name, such as ABCelectronics.Coupon) at a registrar (e.g., GODADDY.COM®, NAMECHEAP.COM®, etc.). At block 722, an auto-response communication (e.g., an email, SMS message or other communication) is generated and transmitted from the TLD registry operator system to the end-user that purchased the domain (e.g., directly to the end-user that purchased the domain). The communication may prompt the end-user to setup a website using tools provided by the system (e.g., an example prompt may recite: “Welcome to .Coupon!˜Thank you for purchasing your .Coupon domain name. Click on the link below to start setting up your .Coupon website with our user-friendly software.”). The communication may include a link that directs the user to a website (e.g., www.Qpon.Qpon or other website) where the user may register for an account and set up their website so as to comply with the theme of the TLD.

Optionally, the website presents a user interface providing instructions regarding setting up the purchaser's website (e.g., “Get started setting up your .Qpon website. With your purchase of .Qpon domain, you are provided with our cutting-edge .Qpon Coupon application to help you easily set up your .Qpon website design and functionality. Our user-friendly, customizable templates and .Qpon Control Center enables you to update your coupons and promotions daily, weekly or monthly.”)

At block 724, the purchaser optionally designates via the system a website type to be associated with the domain name. As described above and shown in FIG. 7, multiple types of websites may be made available for selection (e.g., brand name, website type or product, service, or location keyword directory website types). Block 726 depicts the selection of a brand name website (e.g., Brandname.Coupon), such as abcpizza. Coupon, where the brand name is used as the second level domain. Block 728 depicts the selection of a product/service generic name website (e.g., Pizza. Coupon), where the second level domain generically describes the relevant goods are services being offered or for which coupons are being offered (e.g., pizza, cars, clothing, shoes, etc.). Block 730 depicts the selection of a location website, where the desired location (e.g., city, country, neighborhood) is used as the second level domain (e.g., Chicago. Coupon).

In the event that the user selects the website type “brand name”, at block 732 the process enables the user to upload data, such as its business logo, and provides various website selection features. In the event that the user selects, at block 728, the website type keyword directory for a product/service keyword, the system generates the directory webpage. and the system will populate the corresponding brand name/ad listings and content with that TLD extension populated accordingly.

Similarly, if the user selects the website type “location”, the system generates a webpage template according to the user-specified location and the brand name ad content is used to populate the template accordingly.

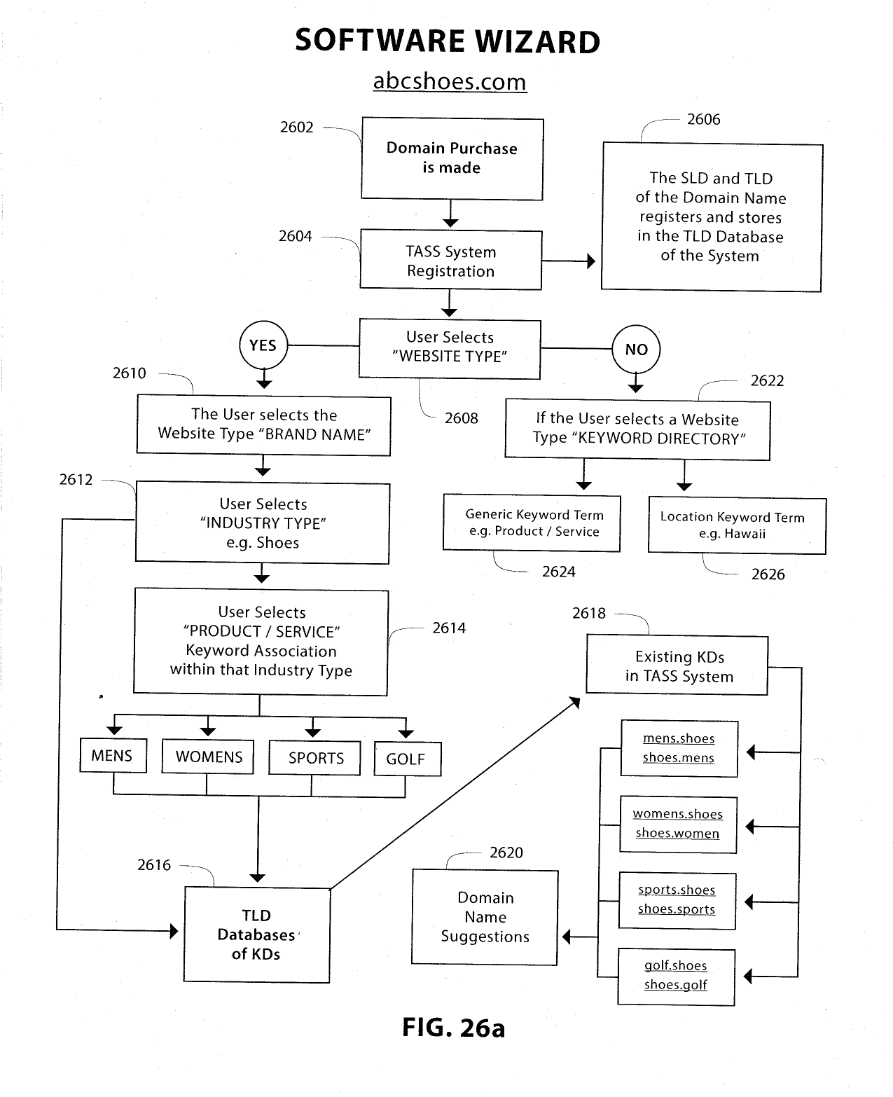

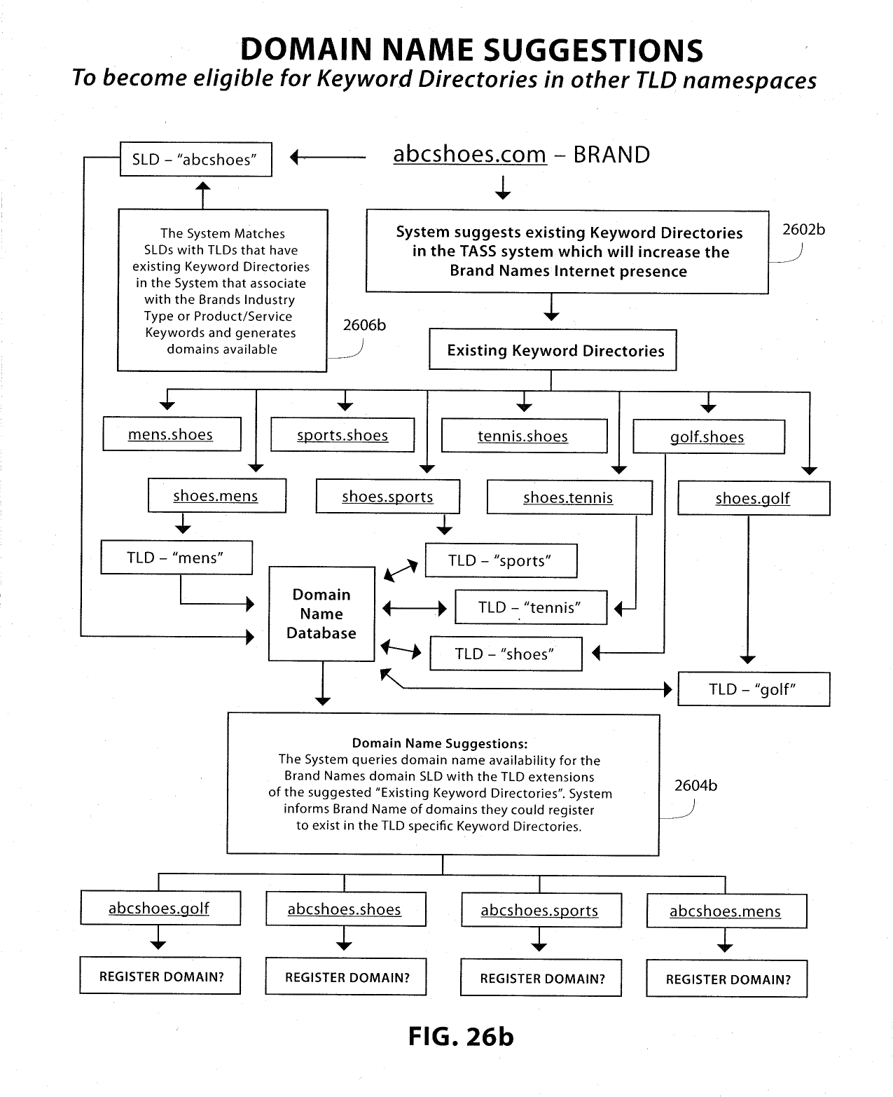

FIG. 26a illustrates another example domain name registration process. Some or all of the process may be executed by a registration system, which may be included in the search system (e.g., the TASS). At block 2602, an entity, such as a company “ABC Shoes” having a brand name “ABC Shoes”, purchases a domain name (e.g., abcshoes.com) from a registrar. Optionally, a communication (e.g., an email, SMS message or other communication) is generated and transmitted from the registrar system to the entity that purchased the domain. The communication may include a link that directs the entity to a website where the entity may register for an account with a TLD search system (e.g., the TASS).

At block 2604, the entity (a user associated with the entity) accesses a registration user interface associated with the search system (e.g., by activating the link in the communication from the registrar system) via a terminal (e.g., a laptop computer, a desktop computer, a tablet computer, a smart phone, or other user terminal). At block 2608, the registration user interface prompts the entity to indicate the website type being registered. For example, the user interface may provide the option to select either “brand name” or “keyword directory” as the website type. If the entity selects “brand name” as the website type at block 2610, then in response, the user is prompted to indicate an industry type. For example, the registration user interface may offer a variety of industry types from which the entity can select (e.g., shoes, restaurants, clothing, travel, transportation, florist, funeral homes, home repairs, medical, etc.). Optionally, the registration user interface may enable the entity to select more than one industry type. At block 2614, the registration system identifies related keywords, which may include products or services typically offered by companies within the industry specified by the entity. By way of illustration, if the entity specified “shoes” as the industry, the system may identify, access and present a list of related keywords, such as those that identify types of shoes or shoe categories (e.g., men's, women's, sports, golf, basketball, baseball, running, etc.). The entity can select one or more of the keywords (e.g., men's, women's, sports, golf) that accurately reflect the entity's offerings.

The registration receives the keyword selection, and based on the industry type and keywords, at block 2618 the registration system identifies, via a TLD database of TLD specific keyword directories 2616, existing keyword directories that include the industry type and/or at least one of the selected keywords in the keyword directory domain name. For example, if the entity selected “shoes” as the industry, and men's, women's, sports, and golf as keywords, the registration system may identify keyword directories at domain names mens.shoes, shoes.men, womens.shoes, shoes.women, sports.shoes, shoes.sports, golf.shoes, and shoes.golf as keyword directories the entity may wish to be listed on. For example, if the entity wanted to be listed on a keyword directory with a particular TLD (e.g., .shoes), the entity may need to purchase its own domain name with the same TLD (e.g., abcshoes.shoes), and the new entity domain name would then be listed on the corresponding keyword directory.

At block 2618, the registration system may provide for display the suggested TLD specific keyword directory domain names to the entity as a menu from which the entity may select keyword directories on which the entity may wish to advertise a domain name for the entity's brand. For example, the registration system may suggest or recommend associated existing TLD specific keyword directories in the search system which may increase the presence of the entity's brand names on the Internet. The entity may then select one or more of the keyword directory domain names it wishes to participate in. The registration system may determine whether domain names with the entity's brand name with the TLDs of the selected keyword directories is available by querying a domain name database. For example, if the brand name is ABC Shoes, and the entity selected the keyword directories: shoes.golf and shoes.sports, the registration system may access a domain name database in the system that associates the TLD of the keyword directory choice and queries the database to determine if the second level domain name of the brand name website is available (e.g., to and determine if the domains abcshoes.golf and abcshoes.sports are available) for the entity to purchase with the correlating TLD, to thereby become eligible to be posted on the TLD specific keyword directory. If available, the registration system may offer the domain names to the entity for purchase. For example, the user interface may request that the entity indicate whether it wants to purchase the domains abcshoes.golf and abcshoes.sports. The registration system may optionally facilitate the purchase and payment process.

If, at block 2608, the entity selected “keyword directory” as the website type, at block 2624, the entity is requested to specify if its domain name for the keyword directory relates to a generic keyword term or a location keyword term. If the entity specifies that its domain name for the keyword directory relates to a generic keyword term (e.g., that generically describes a product/service for brand names to post associated website ad listings on, such as sports.shoes), its second level domain may generically describes the relevant goods or services being offered (e.g., pizza, cars, clothing, shoes, etc.). At block 2626, the entity is requested to specify if its domain name for the keyword directory relates to a location keyword term (e.g., Hawaii, city, country, neighborhood) in the domain name's second level domain (e.g., Hawaii.shoes). Thus, a keyword directory may provide brand names with having domains with the same top level domain extension the ability to advertise on the keyword directory (optionally for a periodic fee, a fee paid via pay-per-click ads or otherwise).

FIG. 26b illustrates the domain recommendation/suggestion process in greater detail. At block 2602b, the system examines the entity's brand name domain name and searches through records of existing keyword directories to identify keyword directories that would help effectively increase the brand name online presence if it were included on such keyword directories. For example, the system may locate keyword directories having second level domains or top level domains that correspond to the industry type specified by the entity or that correspond to keywords selected by the entity (e.g., keywords that describe goods are services offered by the entity via its website). For example, if the entity's brand name is ABC Shoes and the entity sells shoes, the system may identify keyword directories having domain names such as mens.shoes, tennis.shoes, sports.shoes, golf.shoes, shoes.mens, sshoes.sports, shoes.tennis, shoes.golf, etc. The system, at block 2606b, will match second level domains with top level domains that have one or more existing keyword directories registered with the system that are associated with the entity's industry type and/or product and/or service keywords, and generates a listing of available domains. The system, at block 2604b, will access a domain name database to determine the availability of domain names that include the entity's brand name (or optionally a close variant thereof, such as ABC Shoe instead of ABC Shoes) in the second level domain, and that have a top level domain that matches one of the top level domains of the keyword directories identified at block 2602b (e.g., “sports”, “tennis”, “shoes”, “golf”, etc.). The system may then transmit recommended or suggested domain names to the entity's terminal (e.g., abcshoes.golf, abcshoes.shoes, abcshoes, sports, abcshoes.mens, etc.). The system may prompt the entity to indicate whether it wishes to acquire the recommended/suggested domains. The system may optionally facilitate the purchase and payment process. The system may optionally automatically post any purchased recommended/suggested domains to the corresponding keyword directory (e.g., having the same top level domain as the purchased domain).

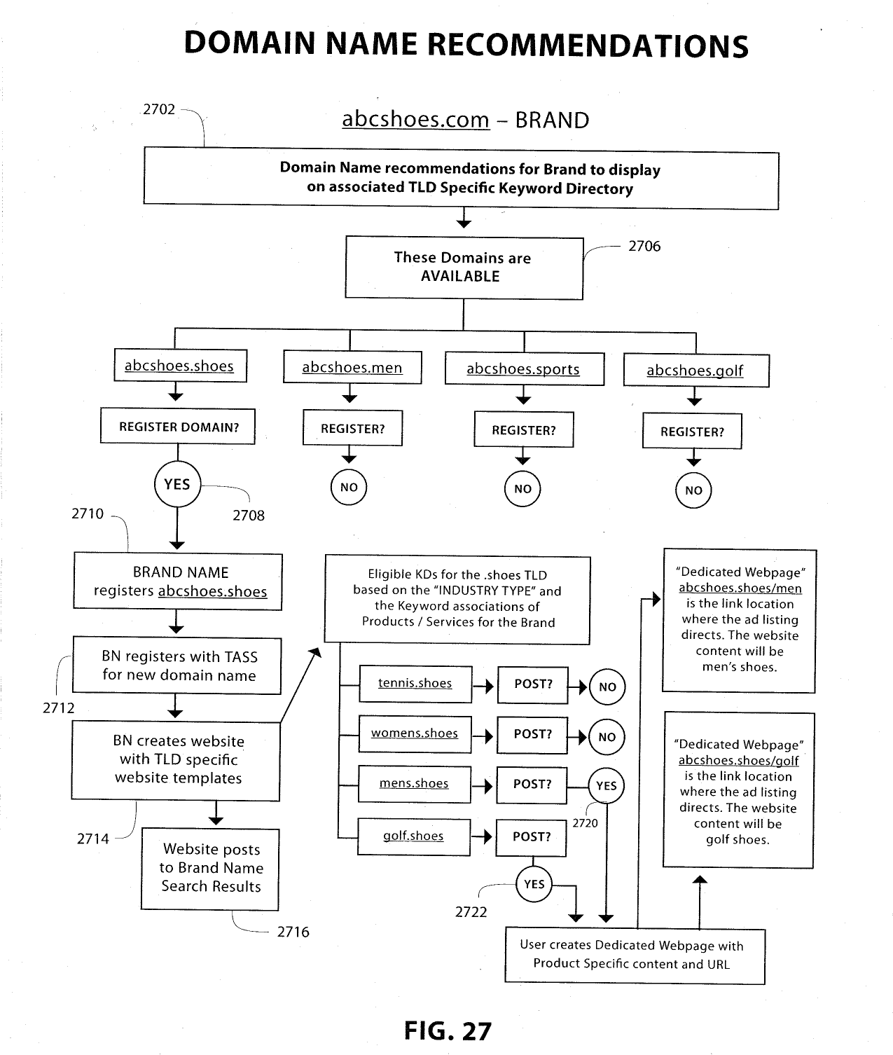

FIG. 27 illustrates the domain name suggestion process in greater detail. At block 2702, the domain name suggestions for inclusion in suggested TLD specific keyword directories are presented via a user interface, displayed on a terminal, to the entity, as similarly discussed above with respect to FIGS. 26a-b. At block 2704, the process cross-references the second level domain, with the TLDs of the suggested keyword directory to generate domain name suggestions. For example, if the brand name is ABC Shoes, and the entity selected the keyword directories shoes.golf and shoes.sports, the process may generate the domain names abcshoes.golf and abcshoes.sports. At block 2706, the process queries one or more databases to determine the domain name availability for the entity's brand name second level domain with the TLD extensions of the suggested keyword directories. At block 2706, the process informs the entity via a user interface as to which suggested domain names are available. At block 2707, the entity is prompted to indicate whether the entity wants to register one or more of the suggested available domain names. At block 2708, the process receives, via the user interface, an indication as to which, if any, domain names the entity wishes to register.

At block 2710, the process registers the domain names that the entity indicated it wants to register. At block 2712, the registered domain name is further registered with the search system (e.g., the TASS). At block 2714, the process optionally selects and optionally at least partly prepopulates TLD specific website templates, which the entity may further populate (e.g. with logos, text, images, etc.). At block 2716, the website is posted to be included in brand name search results for the entity.

At block 2718, the process identifies various eligible keyword directories for the TLD of the entity's new domain name (new in the sense that it is newly registered with the system). For example, the identification may be based at least in part on the industry type and product/services keywords specified by the entity. The process provides the identified keyword directories to the terminal for display to the entity as suggested keyword directories for posting (e.g., mens.shoes, womens.shoes, tennis.shoes, golf.shoes, etc.). The process requests that the entity indicate on which of the suggested keyword directories the entity wants the new domain name to be posted. In this example, at blocks 2720 and 2722, the entity indicated that it wanted the new domain name to be posted at mens.shoes and golf.shoes. A dedicated webpage (to which an ad listing will direct) with product specific content and URL are created that correspond to each of the selected keyword directories (e.g., abcshoes.shoes/men, abcshoes.shoes/golf). For example, abcshoes.shoes/men will link to a webpage of men's shoes at the abcshoes.shoes website, and abcshoes.shoes/golf will link to a webpage of golf shoes at the abcshoes.shoes website. The corresponding keyword directories are edited to include the URLs as links to the webpage.

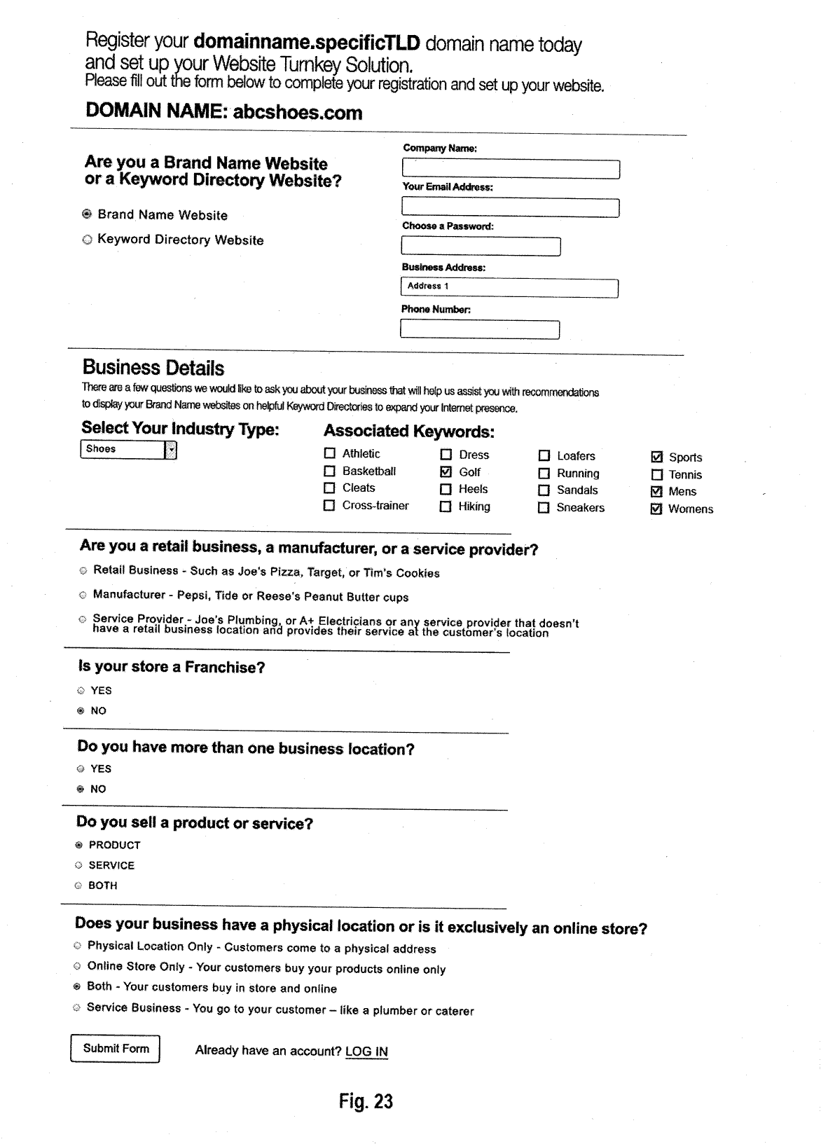

FIG. 23 illustrates an example search system (e.g., the TASS) registration user interface. Fields are provided to receive a company name of the registrant, contact information (e.g., the name of a human contact, the email of a contact, a business address, a phone number, etc.), and a password. In addition, fields are provided via which the registrant can specify business details. For example, a menu (e.g., a drop down menu or a checklist) may be provided via which the registrant can specify its industry (e.g., shoes, restaurants, clothing, travel, transportation, florist, funeral homes, home repairs, medical, shoes, etc.). Once the registrant specifies an industry, the system identifies related keywords, which may include products or services typically offered by companies within the specified industry. By way of illustration, if the registrant specified “restaurants” as the industry, the system may identify, access and present a list of related keywords, such as those that identify food cuisine or restaurant type (e.g., Asian, burger, café, carryout, Chinese, deli, etc.). The registrant can select one or more of the keywords (e.g., Asian, carryout, Chinese) that accurately reflect the registrant's offerings. By way of further example, if the registrant specified “shoes” as the industry, the system may identify, access and present a list of related keywords, such as those that identify shoe categories or shoe types (e.g., sports, golf, tennis, basketball, men's, women's, etc.).

The registration user interface may include fields for collecting additional business information, such as: an indication as to whether the registrant is a retail business, a manufacturer, or a service provider; whether the registrant is a franchise; whether the registrant has more than one business location; an indication as to whether the registrant sells products and/or services; an indication as to whether the registrant has only a physical location (e.g., a bricks and mortar store), only an online store, or both a physical location and an online store; an indication as to whether the registrant travels to customer locations in order to provide products or services (e.g., such as a plumber or caterer), etc. Once the registrant has completed the form the registrant can activate a submit control, and the TASS will receive and store the information. The TASS may then use some or all of the collected information as discussed elsewhere herein (e.g., to provide domains with specific TLD recommendations, to provide keyword directory recommendations, to identify and provide appropriate business/TLD specific website templates, Internet marketing programs to increase a brands exposure, etc.).

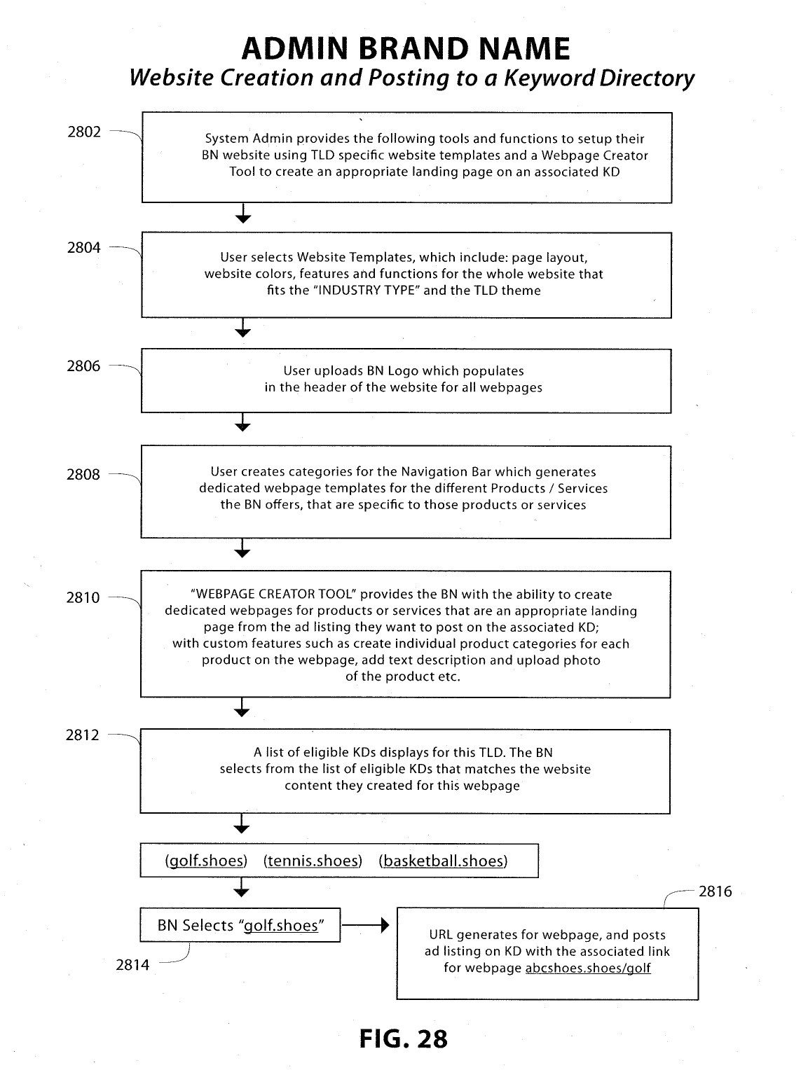

FIG. 28 illustrates an example website creation process using TLD specific website templates. At block 2802, an entity, such as that discussed with respect to FIGS. 26 and 27, is provided with access to a website creation tool (which may or may not be hosed on the search system) configured to enable the entity to setup its website using TLD specific website templates and to create an appropriate landing page on an associated keyword directory.

At block 2804, the entity (a user associated with the entity) selects a website templates, which may specify page layout (e.g., including the placement and size of various controls), website colors, features, and functions for the website that are suitable for the industry type specified by the entity and for the TLD of the website. Optionally, the process suggests which templates to use based at least in part on the industry type specified by the entity and/or on the TLD of the website. Optionally, the process requires that the entity utilize at least one of the suggested templates for the website.

At block 2806, the website creation tool receives various items of content uploaded by the entity, which are used to populate portions of the webpages. For example, the website creation tool may receive a brand name logo and may populate the header of the webpages of the website with the logo. At block 2808, the website creation tool receives categories specified by the entity for a website navigation control (e.g., a navigation bar), and the website creation tool generates or provides dedicated webpage templates for the categories listed in the navigation bar.

At block 2810, a webpage creator tool (which may be part of the website creation tool) enables the entity to create dedicated webpages for those products or services. For example, the webpage tool enables the creation of individual product categories for respective products on the webpage, the addition of text descriptions, and the uploading and insertion of photographs or videos of products.

At block 2812, a keyword directory list for the website in this TLD is populated with eligible keyword directories and presented to the entity via a user interface. The entity is prompted to select keyword directories from the presented keyword directory list that are suitable/match the created webpage. For example, if the website industry is sports and the website TLD is .shoes, the webpage creation tool may present a list including sports.shoes, golf.shoes, tennis.shoes, and basketball.shoes. At block 2814, the website tool receives a keyword selection from the entity (e.g., golf.shoes).

At block 2816, a URL is generated for the webpage, and an ad listing is posted on the selected keyword directory with an associated link to webpage (e.g., abcshoes.shoes/golf).

Thus, industry types and keywords of categories related to the products and services an entity offers are associated with existing keyword directories, and associated ad listings for the brand names are posted to TLD specific and product category specific keyword directories.

Generic Name Sites

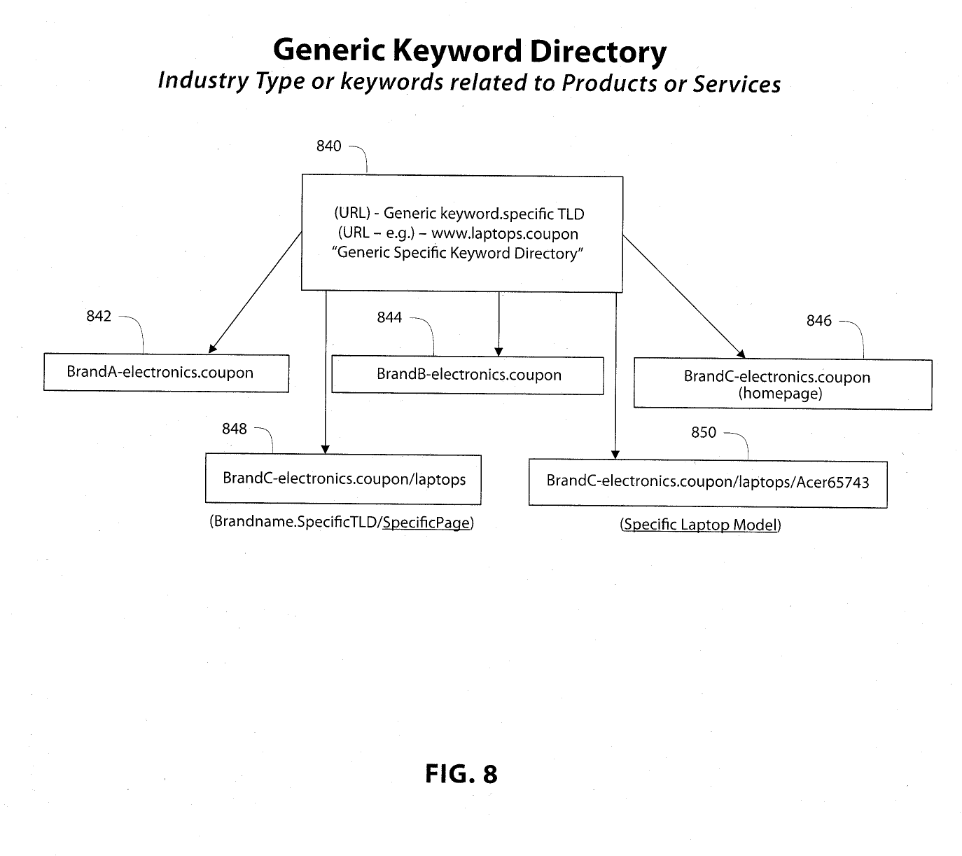

FIG. 8 depicts an example flow chart of the selection and use of a generic keyword (e.g., laptop) as a second level domain (the label to the left of the period character in the URL) and exemplifies an example structure of a resulting directory website at a product-category.TLD (e.g., Laptops.coupon) that includes links to brandname.TLD websites (such as BrandA.coupon or BrandC.coupon/laptops). For example, if the system detects that the user has selected laptops.coupon at block 840, the system may generate a keyword directory configured to lead the user to the individual home web pages of companies selling laptops, such as the illustrated brand names, namely, .TLDs for BrandA.coupon (e.g., BrandA-electronics.coupon) at block 842, BrandB.coupon (e.g., BrandB-electronics.coupon) at block 844 and BrandC.coupon (e.g., BrandC-electronics.coupon) at block 846. In this example, the second level domain (the label positioned on the left side of the period character) specifies a product, service or location which references the right side of the period character for the specific TLD, such as “.coupon”.

By clicking on a brand name ad at block 840 the user may bypass the brand name home page and land on a specific category page such as Brandname2.Qpon/laptops as shown at block 848. Further, at block 850, a user may bypass both the home page and the category page, going directly to a specific product such as a particular model of laptop (e.g. Brandname2.Qpon/laptops/Toshiba46385) and be presented with that product's associated coupons.

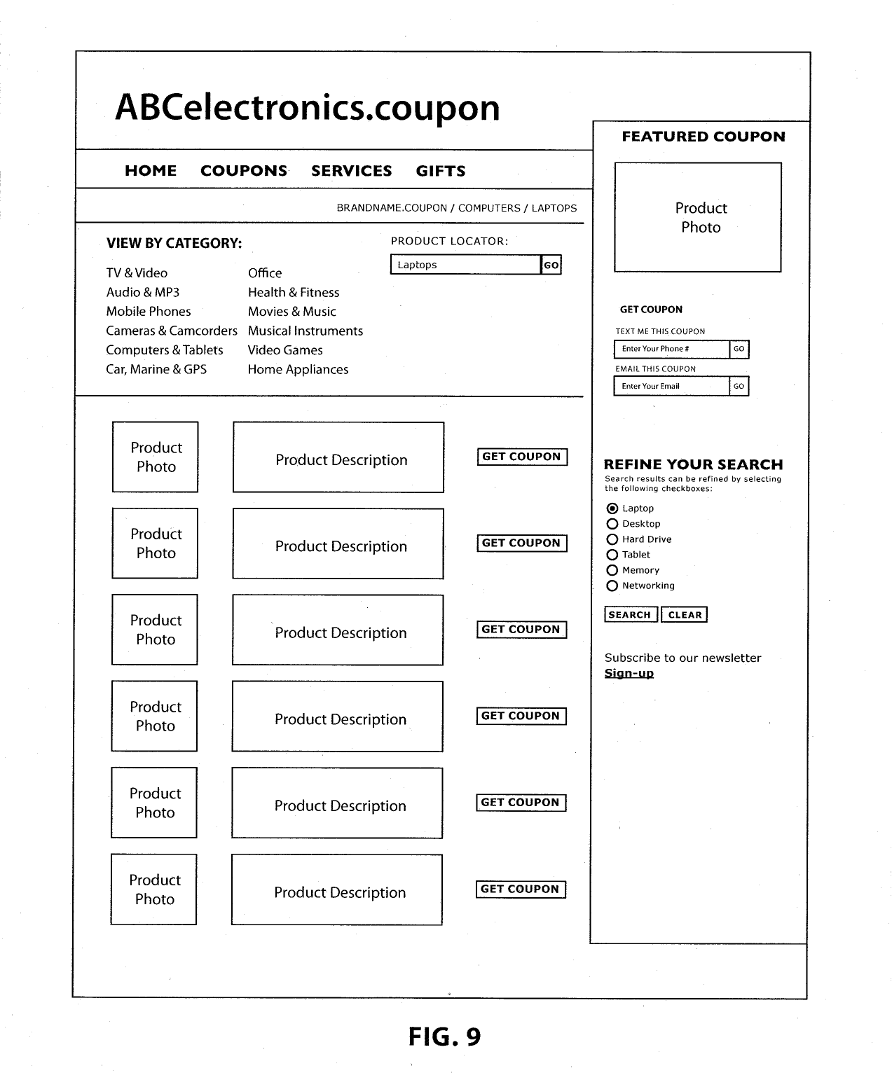

FIG. 9 illustrates an example of a .Coupon website including offers and coupon links for laptop computers that may be found at the directory link Brandname. Coupon/laptops (e.g., ABCelectronics.Coupon/laptops).

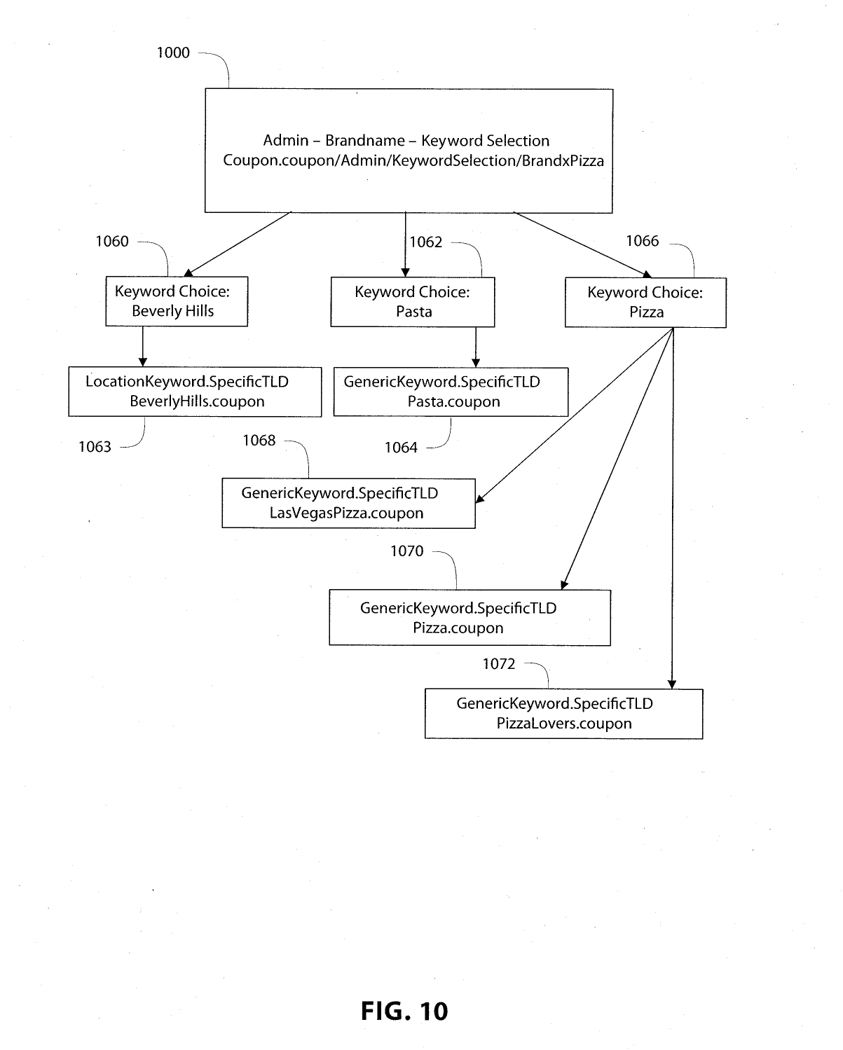

FIG. 10 illustrates an example registration process in which a third party registrant brand may request inclusion and/or premier (featured) display of their .Coupon website(s) or links thereto in directories for generic location and/or generic product/service second level domains within the subject TLD namespace. Brand name site owners may elect to pay for these featured listings, such as via an online administrative interface 1000 and the system will receive and process the payment. A listing may be featured by emphasizing the listing, such by location (e.g., at the top of the listing), using graphics (e.g., placing a box around the listing), using color, using font type of size, and/or otherwise. As shown in FIG. 10, a merchant may select one or more keywords, such as “Beverly Hills”, at block 1060, Pasta at block 1062, and/or Pizza at block 1066, that will enable the merchant's coupon ads to be displayed on the corresponding Location and Generic keywords directories. For example, if the merchant selects “Beverly Hills” at block 1060 the merchant's coupon ads will be displayed on BeverlyHills coupon (1063). Similarly, if the merchant registrant selects “Pasta” at block 1062, the merchant′ coupons ads will be displayed on Pasta.coupon (1064). When the merchant selects a keyword, that keyword can encompass a number of generic keyword sites. For example, when the merchant selects “Pizza” as a keyword, the merchant can elect to have their coupon ads displayed on multiple pizza-related generic keyword sites such as LasVegasPizza.coupon at block 1068, Pizza.coupon at block 1070, and PizzaLovers.coupon at block 1072. The merchant selections may be stored in memory for later access and utilization by the system as described herein.

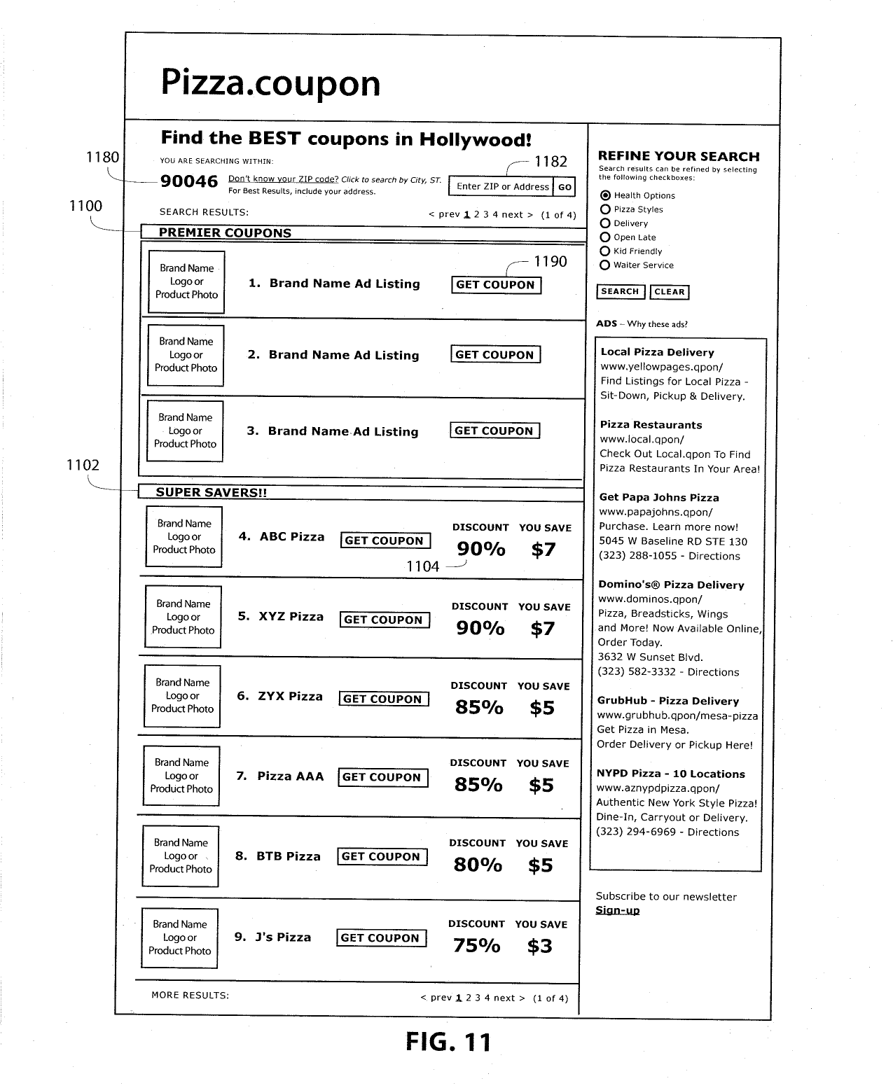

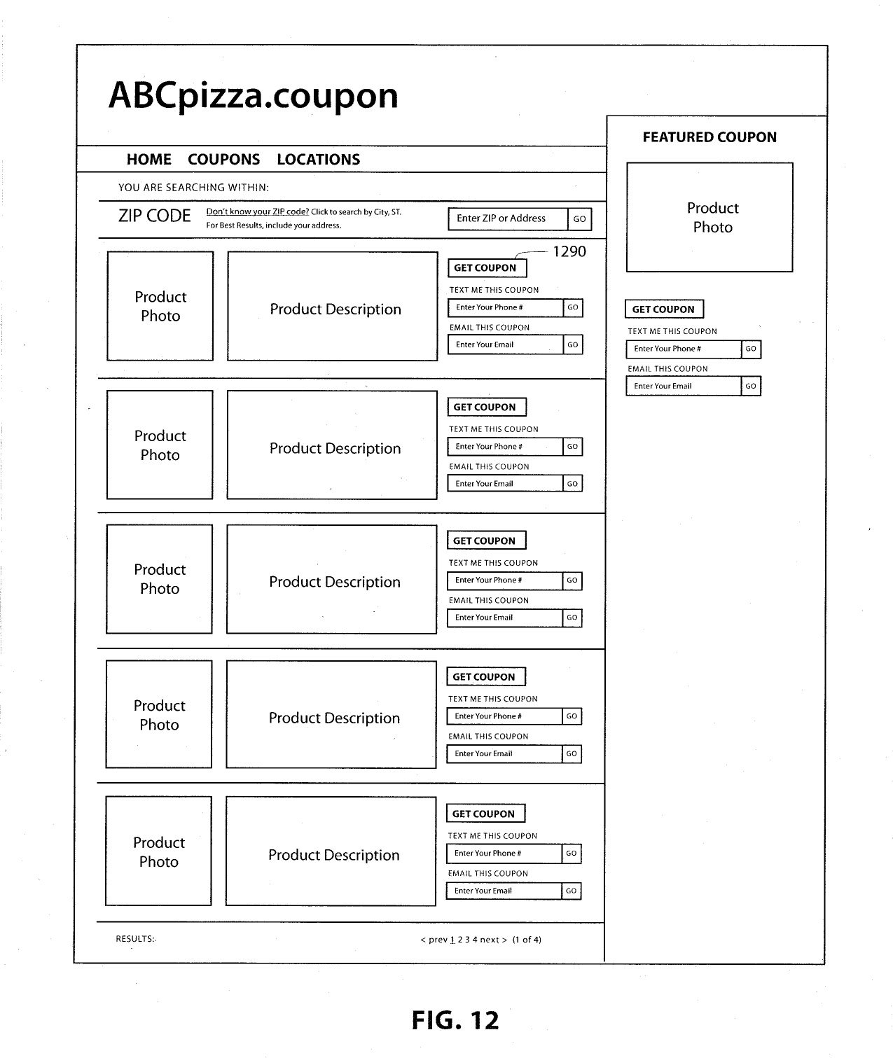

FIG. 11 illustrates an example directory of listings at a generic product.coupon website, Pizza.coupon, with premier listings prominently featured at the top of the web page. The system will respond to user selection and inputs provided via the directory. In this example, a given listing user interface (e.g., a webpage) contains a zip code 1180 depicting the present geographic location of the user. A search field 1182 is provided on the screen for inputting a different zip code. This enables the user to cause the system to narrow the coupon search for the particular keyword to a specific geographic area closer to the user's present location (or other location specified by the user). Selection of any of the merchants listed in FIG. 11 will direct the user to a particular display (e.g., a webpage) of that merchant's current coupons as shown in FIG. 12.

A “Get Coupon” selection control 1290 is provided via the user interface to enable a user to download or print the coupon for the indicated product or service, and to enable the user to either print the coupon or to forward the coupon to the user's mobile device for use at the merchant. The user may also email the coupon or access the coupon through a mobile device app, enabling the user to redeem the coupon at the merchant, where the merchant can scan the coupon code from the user mobile device or otherwise enable the user to apply the coupon. The system may optionally include an electronic communication server (e.g., email, MMS, or other server) to transmit or otherwise provide access to such coupons.

A similarly discussed above, a GenericName.coupon website will help the consumer search for coupons or discounts on generic keyword terms such as sodapop.coupon or pizza.coupon. The system for a GenericName.coupon website provides for display a user-friendly page that lists coupons and offers from participating merchants that link back to each merchant's corresponding BrandName.coupon website. When the user selects the merchant's keyword term, an ad to the merchant's .coupon website will be displayed by the GenericName.coupon website that describes the merchant's coupon or special offer.

Optionally, for a generic name (e.g., of a product or service) second level domain website, a user may select multiple merchants displayed by the system and the system will display the merchants' current coupons side-by-side for a quick comparison, for example, by opening each merchant's .coupon webpage in a separate window. A comparison tool is optionally provided, enabling the browser windows to display multiple merchants' webpages within one browser window for easy comparison.

Location Name Sites

Location websites (e.g., Location.coupon) websites are similar to the previously described GenericName.coupon websites, except they use location-name domain such as Vegas.coupon or BeverlyHills.coupon, etc. These sites may also provide for display a user-friendly page that lists coupons and offers from participating merchants (e.g., those who have selected the corresponding location keyword) that optionally link back to each merchant's corresponding BrandName.coupon website. For example, a Chicago-based BrandName.coupon site may be listed under CHICAGO.coupon, ILLINOIS.coupon, NORTHSIDE.coupon, TAKEOUT.coupon, ITALIANFOOD.coupon, PEPPERONI.coupon, DELIVERY.coupon, and many more, depending on the keywords supplied by the business owners, and their preference and budget for PPC and directory keyword memberships.

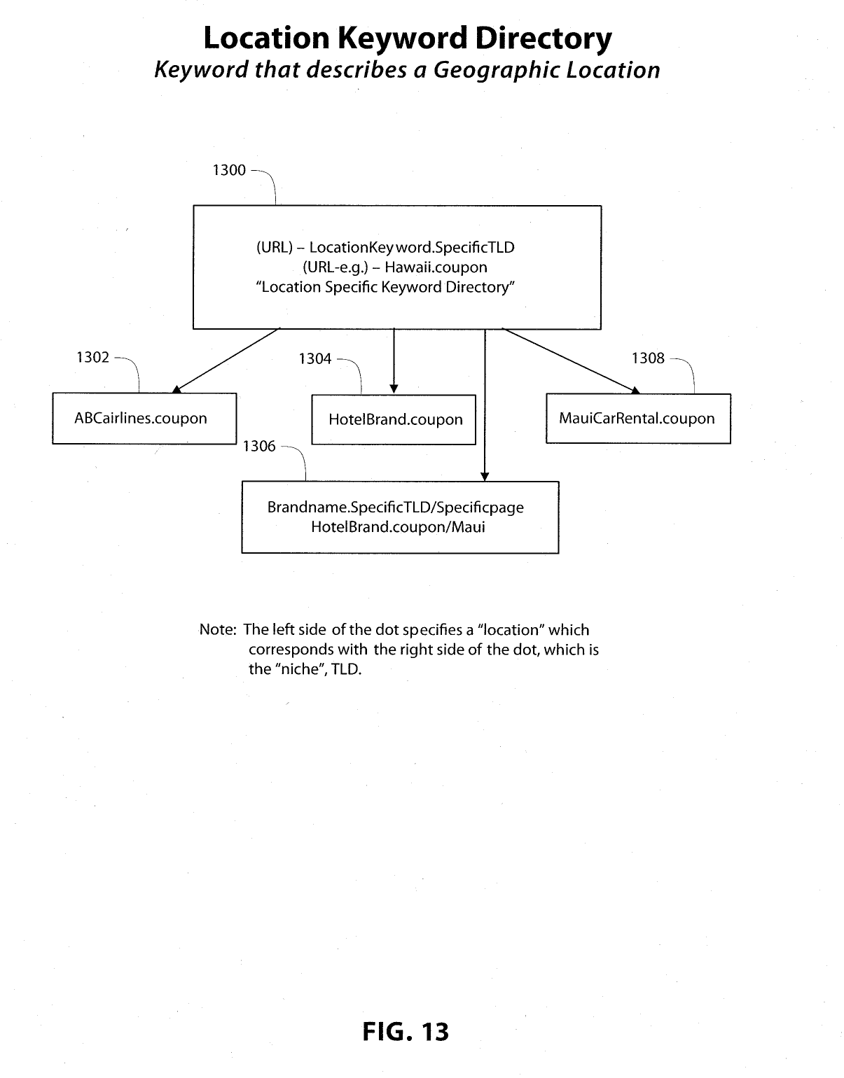

FIG. 13 illustrates an example system generated directory website at location-subcategory.TLD (e.g., Hawaii.coupon) that includes links to related brandname.TLD websites (such as ABCairlines.coupon, MauiCarRental.coupon, HotelBrand.coupon and HotelBrand.coupon/Maui). Viewing FIG. 13 as a related process chart, at block 1300 a user (member of the public, consumer, etc.) may enter a particular location keyword within a specific TLD (such as Hawaii.coupon) into a web browser, and be directed to a location-specific brand name directory at that URL. Participating brand name sites may have their ads displayed by the system on the page. By clicking on one of the merchant listings, the user is then directed to the corresponding brand name's website, such as ABCAirlines.coupon at block 1302, HotelBrand.coupon at block 1304, or MauiCarRental.coupon at block 1308. The coupon ad clicked on (selected) by the user may also bypass the merchant's home page and go directly to a specific coupon page on the merchant's site such as Hyatt.coupon/Maui at block 1306.

Revenue Streams

Optionally, the TLD registry operator, or registrar, or the TASS operator, or the TASS system may generate revenue in a variety of ways. For example, the TLD registry operator may decide to reserve for itself and directly control the most popular “generic” and “location” second level domains within the subject .TLD domain space it handles. Generic sites will be representative of almost every conceivable product and service. A TLD registry will be open to third-parties (parties other than the TLD registry) wishing to register a generic or location site that has not been reserved by the registry operator and to businesses wishing to register a brand name domain to promote their brand names best deals, coupons, and offers.

Revenue may also be obtained by charging third-party second level domain registrants an initial registration fee for a term and for renewal terms (e.g., as is known in the art).

Still another source of revenue may be obtained by charging at least some second level domain registrants a pay-per-click fee for user click-throughs to their sites.

A further source of revenue for the TLD registry operator, or registrar, or the TASS operator may be fees charged to registrants for featured (prominent) listing of their second level domain websites in the generic name and/or location directory websites in the subject TLD namespace.

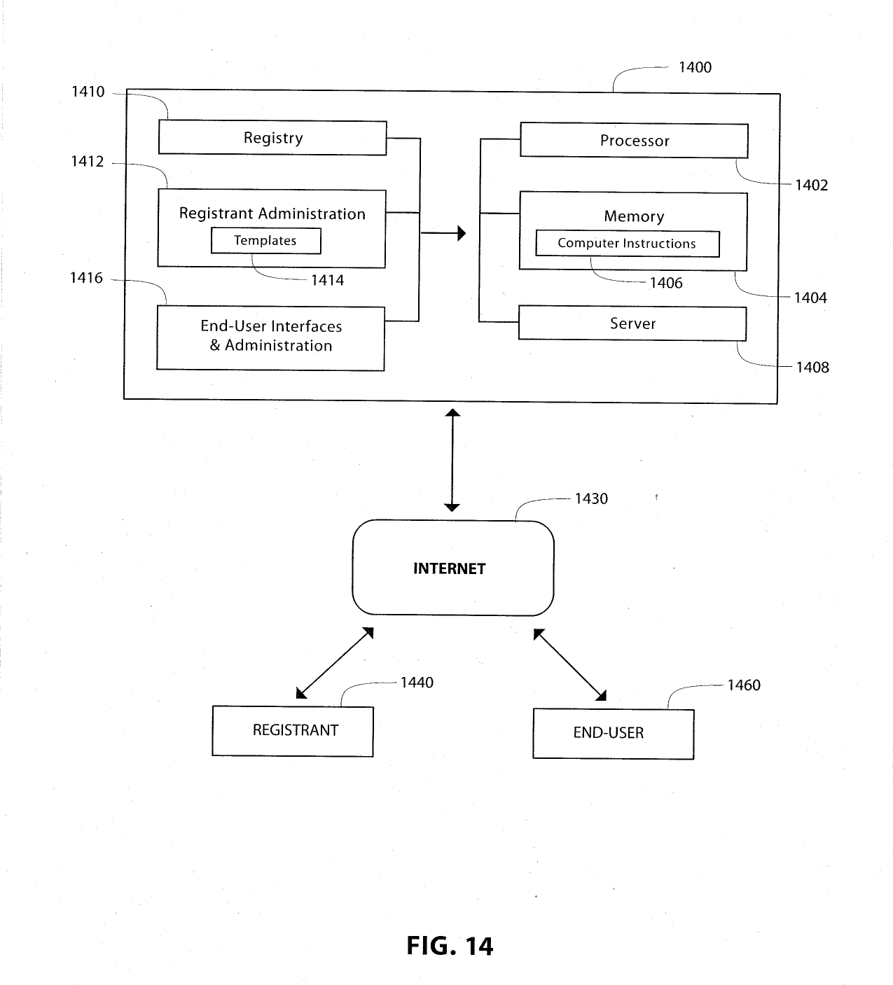

FIG. 14 illustrates an example of a network-connected computer system 1400, which may be configured to implement methods described herein. Computer system 1400 includes at least one processor 1402 (e.g., a computer processor), processor-accessible memory 1404 (tangible computer memory), processor-executable computer instructions 1406 stored in memory 1404 configured to instruct the processor to carry put the various steps and functions described herein, a network server 1408 under control of the processor, such as a web server, that enables data to be sent to and received from client computing devices, for example, via the Internet 1430, or a cellular telephone network. Provided at least in part by the aforementioned components of system 1400 operating in conjunction with one another, the system further includes and provides some or all of the following modules:

(1) a registry module that receives and processes requests for registration, from third-party registrants 1440, of second level domains (e.g., second-level domains) within TLD domain space controlled (optionally exclusively controlled) by the operator of the system and effectuates the registrations;

(2) a registrant administration module configured to permit a registrant to set up a web page or website using for the URL of their registered second level domain using one or more approved preselected templates 1414. Optionally the system does not permit sites that do not use said one or more templates to setup such a webpage or website; and

(3) an end-user interface and administration module 1416 configured to provide the web pages associated with the registered second level domains (e.g., second-level domains) to end-users 1460, such as consumers or those seeking information on the web generally (searchers), and which may provide optional or mandatory end-user registration with the system. Thus, in conjunction with server 1408 (as a web server), end-user interface and administration module 1416 may provide the web hosting functions for the second level domains registered by in the system.

Affiliated Website Links Embodiment

An example directory system may also tie in a multitude of associated TLD extensions from the same brand owner. For example, although BrandX.sports may be the flagship website within the system, the company may also have affiliated sites for BrandX.basketball, BrandX.baseball, BrandX.football, etc. Such affiliated sites may be thematically related. The various TLDs may or may not be handled by (registered with) the TASS or the registry operator executing processes, or portions of processes, described herein. Pages for a BrandX.TLD site, such as BrandX.baseball, for which the TASS or the registry operator controls content (by means of a template or otherwise), may include in the page a directory listing of the other BrandX.TLD websites, such as BrandX.sports, BrandX.basketball, BrandX.football and BrandX.com. Optionally, the registrant of a site handled by the system may request that various, such as all or some, of their brand affiliate sites be listed on the web pages for .TLDs handled by the system, such as template web pages handled by the system. Co-ownership or control of the affiliated .TLD websites may optionally be established or confirmed by the system to maintain the integrity and reliability of the groupings of .TLD websites for inclusion as a grouping in a directory so that unauthorized sites, such as third-party criticism sites, are not automatically included in the listing of links.

Optionally, the system may require or request that, in order for a BrandX.TLD1 site to be listed in the directory grouping (as presented on a BrandX.TLD2 page of a TLD handled by the system), the site of the BrandX.TLD1 uses a template provided by the system or otherwise complies with content requirements imposed by the TLD2 registry operator or the TASS operator. Content compliance of a BrandX.TLD1 may be checked automatically by the system and/or by human system administrators with failure to comply having the result of excluding the noncompliant BrandX.TLD site from an affiliate TLD site group listing within BrandX.TLD sites that appears on pages of the system.

Optionally, requirements that must be adhered to may be promulgated by the registry operator or the TASS operator in order to protect the relation of content either by brand or by niche theme of TLD. Optionally, the requirements may not allow other link sites, domain forwards or domains for sale, unless for example the TLD was .SALE and the niche theme of the TLD was being addressed appropriately such as domains.sale.

Brand names listed in a keyword directory such as sports.sports may optionally have a flagship website listing and may further list (in association with the flagship website listing) the affiliate sites owned by the same owner such as BrandX to have associated links to open a separate window for all or individual affiliate sites. For example, if the user was at the Sports.sports keyword directory and BrandX had a registered ad listing for this keyword directory, the brand owner may have links presented inside that one ad listing that enable the user to interconnect to other affiliated BrandX sites within one directory listing by selecting a given link.

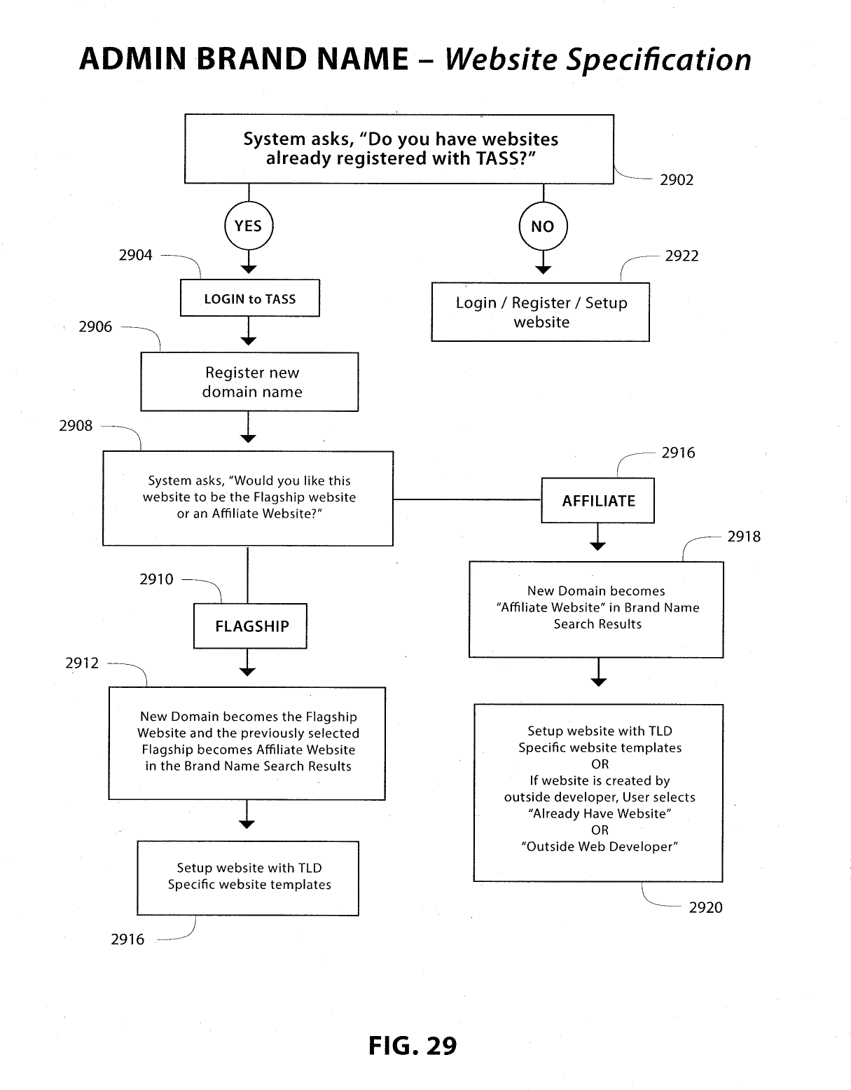

FIG. 29 illustrates an example website specification process. At block 2902, the entity is prompted to indicate whether it has already registered with the TLD search system (e.g., TASS). If the system receives an indication that the entity is registered with the search system, at block 2904 the entity logs into the search system. At block 2906, the system registers a new domain name for the entity. At block 2908, the system prompts the entity to indicate whether the new domain name is to be designated as a flagship website (the principal/main website of the entity) or an affiliated website of the entity. If the entity indicates that the domain name is for the flagship website at block 2910, then at block 2912 the system records a designation of the domain name as the flagship domain name. If system determines that the entity had previously designated another domain name as the flagship domain name, then optionally the system automatically changes the designation of that domain name to an affiliate domain name. Optionally, the system prompts the entity to confirm that change is designation. At block 2914, the system may optionally prompt the entity to indicate whether the website has already been developed or is being developed by an outside developer. If the entity indicates that the entity does not have an existing website and is not using an outside developer, the system provides the entity with TLD website specific templates corresponding to the website TLD.

If the entity indicates that the domain name is for an affiliate website at block 2916, then the domain name is designated as an affiliate domain name for the affiliate website. Thus, the domain name will be listed by the search system as an affiliate website in brand name search results for a search for the entity's brand name. At block 2920, the system may optionally prompt the entity to indicate whether the website has already been developed or is being developed by an outside developer. If the entity indicates that the entity does not have an existing website and is not using an outside developer, the system provides the entity with TLD website specific templates corresponding to the website TLD.

Arbitrary .TLD Directory System Embodiment

A TLD such as .XYZ is an un-themed, plain TLD (that does not define a specific theme using a word or name in the TLD). However, this plain TLD may become a niche theme if the owner of the TLD markets the plan TLD for a particular niche. Thus, in another example of the use of the directory search system, a TLD registry operator, such as .XYZ, may provide a keyword directory specifically as an “affiliated site directory” and search system enabling website owners to be found for selected or all of their affiliated sites in one keyword directory ad listing which may have “affiliate site” icon links in a single ad listing.

For example, BrandX.xyz may create an ad listing to be posted on the keyword directory sports.xyz and in that single ad listing, selected or all affiliated sites such as BrandX.com, BrandX.basketball, BrandX.Qpon, etc. Optionally, the BrandX.xyz keyword directory ad listing may include “affiliate site” icons for each affiliated site which when clicked on optionally opens a separate browser window or tab for each individual affiliated website of BrandX. Optionally, if a brand name ad listing for BrandX.basketball is posted at the directory located at sports.basketball, it may then have an affiliate link for their BrandX.sports site in that ad listing if the participating brand name chose BrandX.basketball as the flagship site for this directory listing. When an ad is placed in a TLD directory, the poster may optionally choose a flagship site when including affiliate sites to be included in their ad listing. Optionally, the flagship and/or the affiliate sites must be in accordance with the guidelines and approved by the TLD registry operator, or registrar, or the TASS operator where the system optionally inspects the affiliate sites to ensure they are in accordance with the guidelines. If the system determines that website for the flagship and the affiliate sites all use the provided TLD website templates and are verified as belonging to the same owner, the system may determine the flagship and the affiliate sites are in accordance with the guidelines. Optionally, the system may ensure that domain forwarding does not occur by enforcing the use the TLD website templates. If an entity, such as the brand name owner, wants to use a website template other than what it is provided by the system, they may submit their website for approval by the TLD registry operator, or registrar, or the TASS operator to ensure compliance with the guidelines (e.g., to ensure that the website does not violate the theme the keyword directory search system represents, does not perform domain forwarding, does not offer domains for sale, etc.).

Thus, the systems and methods described herein enable brand name owners to consolidate multiple websites within one ad listing, branding many aspects of their brand and affiliated websites together, while also benefiting the consumer by offering a single website for a multitude of related products and services from the brand of their interest. Optionally, the parent brand name ad listing containing the affiliate icons is associated with the specific TLD of the TLD specific keyword directory.

Additionally, the search system allows enables a user to search a keyword search term, such as sports, in a .xyz search environment, which is dedicated to including selected or all pre-approved website affiliation icons inside the single .xyz ad listing. This technique also helps the end user know what sites a brand name may have available. Further, the system enables an owner of a brand to further expose and clarify the subject matter of their new site, reducing user confusion and assisting marketing within an associated field. Currently, conventional search providers have not yet determined an adequate approach to address the addition of the large number of new TLDs. Many companies will be structuring the way they advertise and place their products based on the TLD specific webpages they secure for their company. Many people in the industry think the large increase in the number of new TLDs is not beneficial to the end user and will result in user confusion. However, by structuring the TLD specific search system as described herein, additional exposure across many TLD themes is enabled and an organization of the websites for each individual TLD theme is created.

TLD Alliance Search System with Reciprocal TLD Search Results

An optional TLD Alliance search system embodiment will now be described that provides Reciprocal Search Results (RSR) across a multiple of TLDs, while keeping them organized into their respective TLD, and that provides processes for locating subject specific information within top level domain namespace(s). Advantageously, the embodiment optionally enables TLD registries, or registrars, or the TASS operator to interact to maximize or enhance user-efficiency and user-experience and brand name exposure for the brand name websites within their TLD namespace.

Conventional search engines currently provide disorganized search results as well as large numbers of unwanted search results. These drawbacks will become further exacerbated with the introduction of thousands of new TLDs. Conventional search engines cannot adequately address the addition of these new TLDs.

TLD Alliance Search System:

There are 1,400+ new TLDs in the root zone and many of these TLD registries may greatly benefit from registering with the TLD Alliance Search System. The TLD Alliance Search System can accommodate all of the new TLDs and maximize or enhance user-efficiency by offering better organized search results to the end-user. Many niche TLDs being introduced are now going to relate to a specific theme folder of a product or service or niche focus rather than all lumped into one flagship website (such as .COM). To properly take advantage of the addition of thousands of new TLDs entering into the marketplace, the embodiment provides a common thread that ties them together into an alliance for optimized end-user convenience and capitalizing on the opportunities this creates for all websites across all TLD namespaces.

An example process will now be described.

Optionally, a TLD Alliance Board of Directors (managing/governing entity) manages the “TLD Alliance Search System” and creates the guidelines in which the participating TLDs must or should adhere to preserve the reliability and uniformity of the TLD Alliance Search System.

The TLD Alliance Board or other entity may supply a list of beneficial “keyword directories” for the participating TLD registries to choose from, such as Restaurants, Catering, Pizza, etc. The listing of available keyword directories may be presented to TLD registries via a user interface, where the TLD registries may make selections which are recorded for later use as described herein. Keyword directories are comprised of generic keywords or terms registered with the TLD Alliance to address a product, service or category, not a brand name website. “Brand name” websites are the company websites listed in the keyword directories. The TLD Registries select which keyword directories they find beneficial to their TLD business model and may add that Keyword into their own “TLD keyword directory Database” such as the keyword directory for “Footwear”. For example, the keyword “Footwear” may be selected by the TLD registries for .Qpon, .kids, and .sports, but may not be chosen by the TLD for .wine since footwear does not meaningfully apply to the niche of the .wine TLD.

TLD Alliance Registration:

At the time of registration, owners of domains/websites are presented with an interface which enables the owners to register as a member of a TLD alliance. For example, after domain registration, the system may transmit a communication via a webpage or an email including an invitation link directing the owner to register their domain name in the TLD Alliance for the participating TLD registry of their purchase.

If the TASS system or the TLD registry provides the keyword directory for “Footwear” to benefit the “brand name” websites that exist within that TLD domain database, the TASS or the TLD registry may transmit the invitation to the brand name websites that carry footwear, shoes or the like within the TLD Alliance System Administration user interace provided to registered websites.

When registering a domain/website with the TLD Alliance, information will be gathered from the domain/website registrant that helps categorize the purpose of their website. For example, some of the information gathered may be via responses from the registrant to questions such as “What kind of website will this be?” The list of choices might be: Brand name website, Personal website, Blog website, etc. If the registrant chose Brand name, the system might ask, “Do you offer a Product, Service, or Both?”, and if the registrant indicates that the registrant sells products or both, the system any ask: “What kind of products do you carry?”, and may display another list of product choices that currently have TLD keyword directories for those generic term products from which the registrant may select, and a choice for “Other” where the registrant can enter a product/service category that is not in the list. Gathering and storing this information will help the TASS and/or the TLD registry administration analyze and sort the website's focus and the website's purpose, and to determine what features of the TLD Alliance Search System and other services each website may be interested in participating. TLD registry Admin may accordingly provide feature and service recommendations to the website owner.

If a domain/website is not registered with the TLD Alliance Search System, the TASS or the TLD registry may send an invitation (e.g., via email, voice call, SMS message, or otherwise) to brand name websites with that TLD extension which carry footwear or have appropriate relevancy to the footwear keyword, advising them of the benefits of creating an ad listing for this keyword directory. The TLD registry may decide to sell PPC advertisements to the brand name owners to list their website on that keyword directory or they may decide to just offer the service to them for free. If the brand name website is not already registered with the TLD Alliance for that TLD registry, optionally they need to do so to participate in the keyword directories. Additionally, optionally they need to meet the requirements of the guidelines to ensure relevancy within the search system. Some of these guideline requirements may include, but are not limited to: use of the controlled content website templates provided by the TLD registry, or if they provide outside web development on their website, they may need to adhere to the website content guidelines of their website on at least one dedicated webpage associated with that keyword directory to ensure website relevancy on the keyword directory for that keyword.

How to Search:

For the end-user to access the “TLD Alliance Search System”, they may simply enter into a web browser address/URL field, the search.TLD of their choice, such as Search.Qpon, Search.sports, Search.kids or any TLD registries participating in the TLD Alliance. Optionally, a conventional search engine or ISP may not be required for this process. The system will locate appropriate matches and provide the user with search results as described herein.

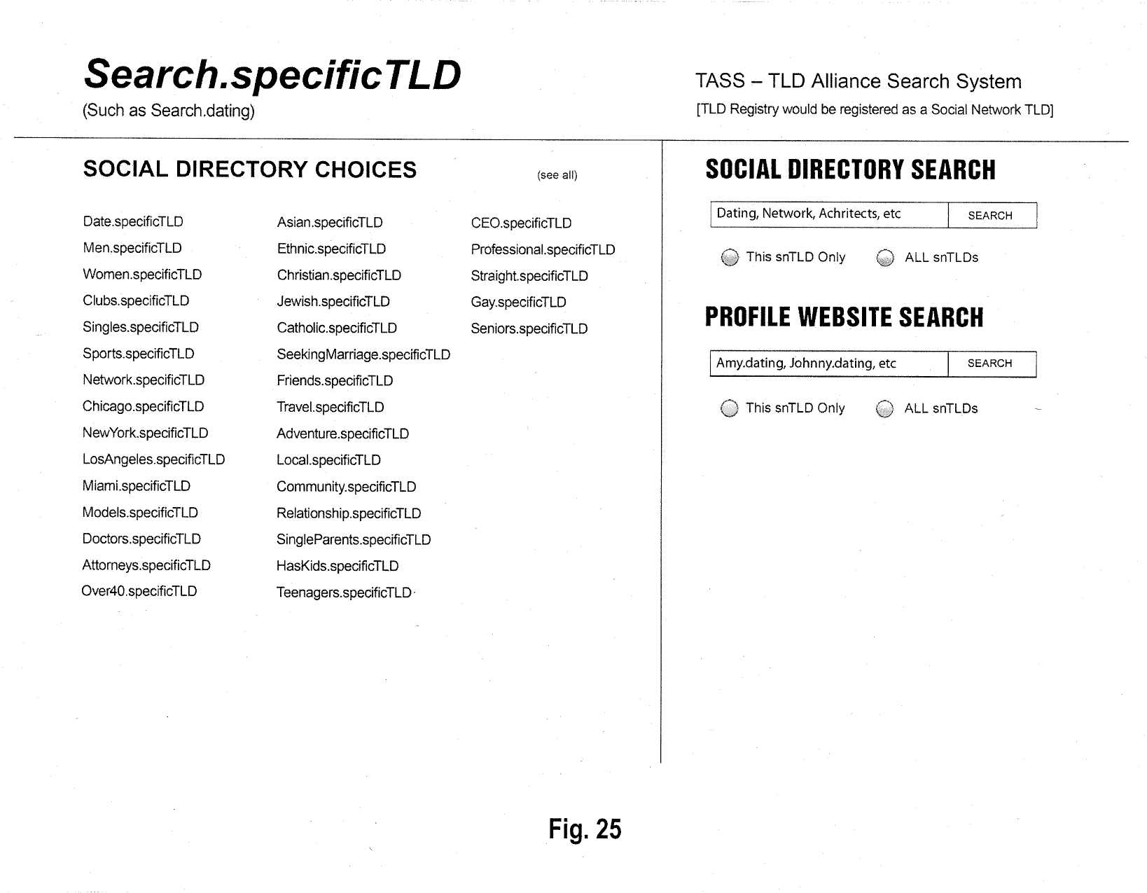

FIG. 25 illustrates an example TASS TLD specific search user interface. In the illustrated example, the search user interface is located at the domain Search.dating, which is registered as a social network TLD (“sn TLD”).

TLD Alliance Search System Search User Interface:

Search.TLDs, such as search.Qpon, search.sports, etc., that participate in the TLD Alliance may optionally have a “dedicated” Search webpage for the TLD Alliance Search System to ensure uniformity and reliability of the system for the end-user. Optionally, if the TLD registry were to have a different webpage which displayed at the URL Search.sports or other TLD, they may be allowed to do this. The TLD Alliance guidelines may optionally require the TLD registry to have a prominent control (e.g., a button) on the webpage, such as in a navigation bar, which may direct the end-user to search.sports/tld, displaying the “TLD Alliance Search System” uniform webpage content for the end-user, to start their TLD Alliance search.

The search.TLD webpage may have multiple search categories for the end-user to select from. For example, the categories may include the following example categories and/or other categories:

1. Keyword Directory Search

2. Brand Name Search

Keyword Directory Search:

If the end-user's browser had navigated to search.Qpon and the end-user entered a generic keyword in the search field of the Keyword Directory Search such as “footwear”, the system may receive the search query and identify and return results for footwear.Qpon, but in addition, the system may identify and include in the search results suggestions of other participating TLDs that have a registered keyword directory for footwear, such as footwear.sports, footwear.shoes, footwear.basketball, footwear.save, footwear.deal, footwear.club, etc. With the TLD cross-referencing capabilities of the TLD Alliance Search System, an end-user may start their search at any search.TLD and be offered the choices of select or all TLDs in that alliance that have a keyword directory website for the keyword entered into the search field.

Although the end-user may be offered a multiple of keyword directories associated with the specific queried keyword, each specific keyword directory may only have brand name site ad listings with that specific TLD in each keyword directory. For example, in this case, on the keyword directory footwear.sports, there may not be brand name sites displayed for BrandX.shoes, BrandX.basketball, or BrandX.Qpon. Thus, there may be only one dedicated TLD in each individual keyword directory, not multiple TLD brand name sites mixed into one keyword directory. The end-user may only be provided with results for BrandX.sports, BrandY.sports, RetailerZ.sports, etc., when viewing the keyword directory for footwear.sports.

The Search System queries the generic keyword entered into the search box and the participating TLDs that have a keyword directory related to that keyword. For example, if the TLD registry for .wine did not have a keyword directory for footwear in their keyword directory database, the system may not identify and may not offer a choice for footwear.wine in the search results.

The end-user may also choose to disable other TLD choices via a user interface control provided by the system if the end-user does not want search results outside the TLD the end-user is searching within. If the end-user does indicate that the user wants to restrict the search to the TLD the end-user is searching within, the system will limit the search results accordingly to websites within the TLD the end-user is searching within.

Location Keyword Directory:

The keyword directories optionally will also have location-based keyword directories for TLD registries. If the end-user entered “Vegas” in the search field, the system will receive the search query, and identify corresponding keyword directories for each participating TLD, which might be Vegas.Qpon, Vegas.shows, Vegas.tickets, Vegas.club etc.

Third Party Keyword Directory:

In the event a third party domain name owner wanted to participate as a keyword directory website, the third party domain name owner may set up a relationship with the TASS or a TLD registry to allow the use of their domain name and create a revenue sharing structure for the PPC ad revenue from that directory. This provides an additional search avenue.

Since the TLD registries can choose to register for a keyword directory without having the exact domain match of that keyword, this should also minimize the domain squatting epidemic that currently exists. Domain squatters typically buy many generic keyword terms and boost the sale prices for those domain names to unreasonable prices. Since the exact match of a domain name is not necessary to participate on a relevant keyword directory, the domain squatting business model becomes irrelevant except for type-in traffic. Thus, unlike conventional search engines, the disclosed search engine optionally overcomes the challenges posed by the practice of domain squatting.

Keyword Associations:

Additionally, if the end-user were to enter a keyword into the search field that was not an exact match to certain domains but may be similar to such domains, the system may identify similar domains to include in the search results provided to the end-user. For example, some end-users might enter the search term “Vegas”, while others might search “las vegas” or “las vegas shows”, or “las vegas hotels”. The search system may be configured to recognize the first keywords entered as the most important search criteria, and the later entered keywords as being of declining importance as search criteria. Thus, for example, Las Vegas and Vegas may be recognized as the same search results category association for that keyword directory. If the end-user entered lasvegas hotels, the search process may be performed as follows: the search process queries the TLDs with keyword directories associated with the first keyword entered by the end-user, and then queries the next keyword to find TLD registries with the first word and the second word combined (e.g., keyword directory for lasvegashotels.Qpon), and queries keyword directories with URLs that have category relevance such as Vegas.Qpon/hotels. The controlled content website templates provided for the keyword directories may have category sorting for the end-user to refine their search, which creates another webpage folder in the URL such as /hotels which will have uniformity for all participating TLDs so they are recognized in the search query. For example, if the end-user navigated to Vegas.Qpon and selected “hotels” via the user interface to refine their search, the system may load the webpage located at the URL Vegas.Qpon/hotels to return more specific search results. For more popular search items, the TASS or the TLD registry may elect to have a dedicated website such as the example of lasvegashotels.Qpon mentioned above. The TLD Alliance Search System may also use metatags and the like to recognize the cross-relevance of keyword directories.

Brand Name Search:

If the user enters BrandX in the brand name search field, the TLD Alliance Search System may query the TLD Alliance Search System Database for other registered and affiliated TLD webpages for BrandX. The search return to the end-user might include BrandX.Qpon, BrandX.sports, BrandX.basketball, BrandX.BrandX, etc. The end-user may then click the “Select” button for the TLD specific websites they are interested in viewing, and the selected websites may be opened in separate browser windows and/or tabs.

Optionally, each of the registered affiliate websites for that brand name will return as a priority listing in the search return with link-embedded screenshot templates of each affiliate brand name website for the end-user to easily individually choose. Additionally, there may be a “Certified websites” link-embedded template in the search return specifically for that brand.

Brand Name—Certified Websites:

A brand, such as BrandX, may want to include in their listing (e.g., in search results for BrandX returned to end-users) websites that sell their products at third party retailer websites, such as Footlocker.com. The retailer may be registered in the TLD Alliance Search System in order to send the certification request via their TLD Alliance Admin to BrandX.

In order for any website to request certification from a brand name in the TLD Alliance, optionally they need to also be registered with the TLD Alliance. Each registered website in the alliance is optionally provided with access to an Admin Control Center. Within the Admin Control Center, the owner of the website that wants to request certification by that specific brand name owner may submit a certification request via the TLD Alliance Admin, which may forward that request to the desired brand name with their TLD Alliance registered website link for review by the brand name, such as BrandX. If BrandX approves of the website, they may provide a certification approval (e.g., by clicking on a “Certify” control) which may certify that website. The certification of the website may be stored in memory by the system for later access. The certified website may be reflected in the “certified websites” search results for that brand name.

Additionally, if the third party retailer were registered with the TLD Alliance, the third party retailer may be recognized in the TLD Alliance System Database for BrandX to search for the third party retailer and add the third party retailer website to a certified website list for BrandX. Optionally, BrandX may add any other desired websites to BrandX's certification list, such as other third party seller sites, or any other website they found beneficial to certify. Optionally, it is not necessary for certified websites to be TLD specific since their search returns are not offered on the keyword directories. Since the certified websites search results are outside of the keyword directories, it is not necessary for the certified websites to adhere to the same TLD Alliance guidelines or have a dedicated webpage. Optionally, the only requirement for inclusion in BrandX's certification list is that the websites are registered with the TLD Alliance and are certified by the brand name owner.

Certified website Sort:

Optionally, a sort/filter feature for the certified websites search is provided that enables the user to specify a certified website category for the search. Examples of the sort/filter choices may include “Retailer”, “Wholesaler”, “Press & Media”, “Blogs”, etc. The sort feature will refine the end-user's search results to the category the end-user selects and wishes to view. The category assigned to the certified websites may optionally be chosen by the brand name owner upon certification of the website.

TLD Sort:

Optionally, a TLD sort/filter feature for the keyword directories, affiliate websites and certified websites is provided, enabling the end-user to further refine search results when searching the TLD Alliance Search System. For example, an end-user may want to choose only .Qpon, .Save, .Discount, .Coupon, and .Cheap TLD websites for their search return if the end-user is looking for discounted prices. Additionally, a “Sort Groups” for TLDs may be created, where the included TLDs have a similar theme. Thus, with one click/selection, an end-user may select via a user interface the “Sort Group” for “Deals”, and the system may automatically group the TLDs that are registered and approved by the Alliance which are relevant to Deals, such as the above listed TLDs, and present some or all of them to the end-user. This process enables convenient, fast price comparison when a user is searching for a deal.

Brand Name—Search Return Prioritization Control:

Optionally, the brand name owners may also specify where each certified website exists (is positioned) on the search return/certified website list for their brand name by providing each certified website a priority indication, such as a priority number. Optionally, a brand name owner can edit and adjust the position on a certified website list to change priorities (e.g., using a drag-n-drop list feature or by entering a priority number in a priority field next to a given certified website domain name). This enables a brand name owner to specify which websites they want to include, represent, and certify for their brand while also providing the brand name with the ability to organize the search return for their own brand, rather than just having to rely on whatever third party search engines provide users.

Conventional search engines often search a keyword that exists on any website they have crawled, using algorithms that rank the importance of where that keyword exists on certain webpages to determine where they should rank in the search results, along with back links and other algorithms that can be manipulated by someone adept in SEO. Optionally, the TLD Alliance Search System prevents or inhibits such SEO manipulation, thereby enhancing the relevancy of search results provided to users.

Brand Name—Affiliate Icons:

Another optional feature of the TLD Alliance is the utilization of an affiliate icon (“Affiliate Icon”), which may optionally be conveniently positioned at the top in the header webpages of each affiliated website (or elsewhere) for the end-user to easily reference. The Affiliate Icons may be link-embedded to open a separate browser window or tab for each of the Affiliate Icons selected by the end-user. When a brand name owner registers with the TLD Alliance and verifies their affiliate websites, optionally the Affiliate Icon(s) will automatically be placed on the other correlating affiliate websites. This may be beneficial if an end-user was searching at first website of the brand owner (e.g., BrandX.sports) and was considering buying a product via the first website. The end-user may simply click on (or otherwise select) the Affiliate Icon for a second website of the brand owner (e.g., BrandX.Qpon) (where the Affiliate Icon is located on a webpage of the first website), and the end-user will be provided with a display of deals/discounts the end-user may take advantage of. There are many scenarios in which the utilization of the affiliate icon may be helpful to the user. Such a feature is not offered by conventional search engines amongst multiple TLDs.

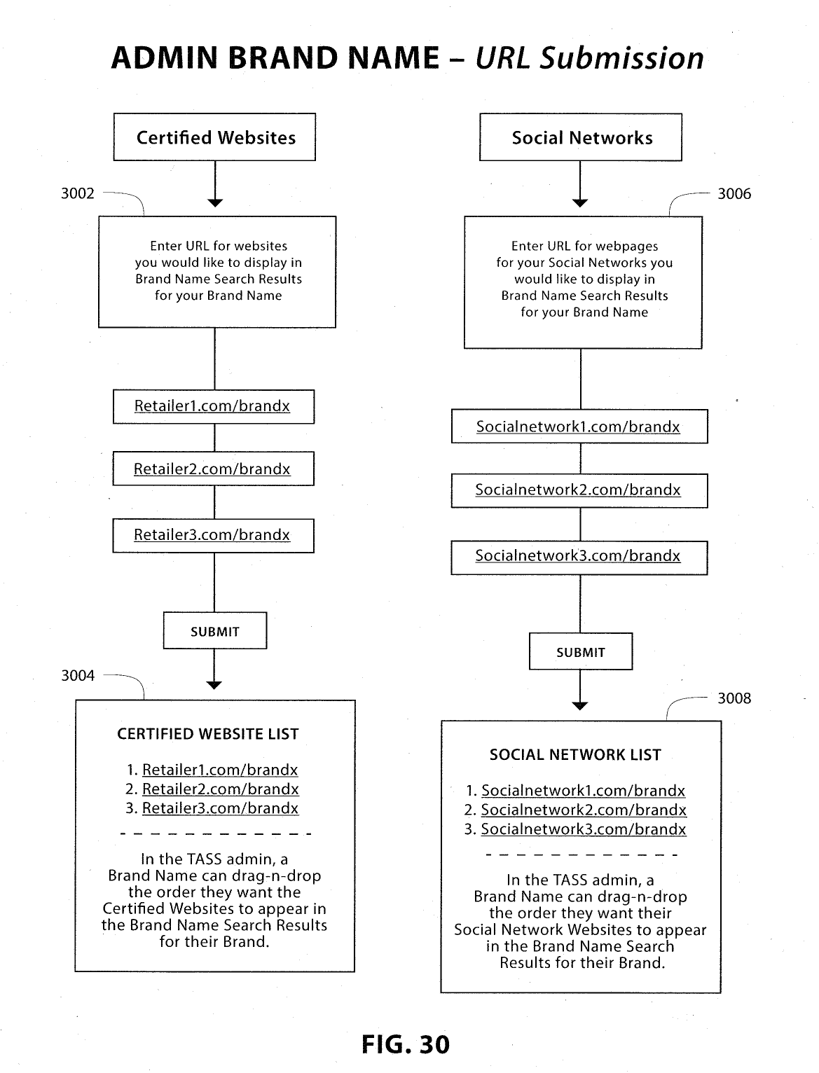

FIG. 30 illustrates an example process for designating certified websites and social network pages. At block 3002, an entity (e.g., a business with a brand name) is presented with a form (e.g., via a TLD search system, such as TASS) via which the entity can enter the domain names for one or more websites that are being designated as affiliate website. Websites designated as an affiliate website will be listed by the search system as an affiliate website in brand name search results for a search for the entity's brand name. If the system detects that the entity activated a submit control, the system will record the designation of the entered domain names as being affiliate domain names. Optionally, the entity can change the order the domain names will be presented in when displayed in a list of affiliate domain names provided in brand name search results for the entities brand. For example, the system may enable the entity to change the order via a drag-n-drop feature or by entering a priority number in a priority field next to a given affiliate domain name. The change in order will then be stored by the system for later use is displaying the affiliate domain names in brand name search results for the entity. This enables a brand name owner to specify which websites they want to include, represent, and certify for their brand while also providing the brand name with the ability to organize the search return for their own brand, rather than just having to rely on whatever third party search engines provide users.

At block 3006, an entity (e.g., a business with a brand name) is presented with a form via which the entity can enter the URLs for one or more webpages that are being designated as social network pages of the entity. Webpages designated as a brand name social network page will be listed by the search system as a social network webpage in brand name search results for a search for the entity's brand name. If the system detects that the entity activated a submit control, the system will record the designation of the entered URLs as being brand name social network pages. Optionally, the entity can change the order the URLs will be presented in when displayed in a list of social network pages in brand name search results for the entity's brand. For example, the system may enable the entity to change the order via a drag-n-drop feature or by entering a priority number in a priority field next to a given social network page URL. The change in order will then be stored by the system for later use is displaying the social network domain names in brand name search results for the entity.

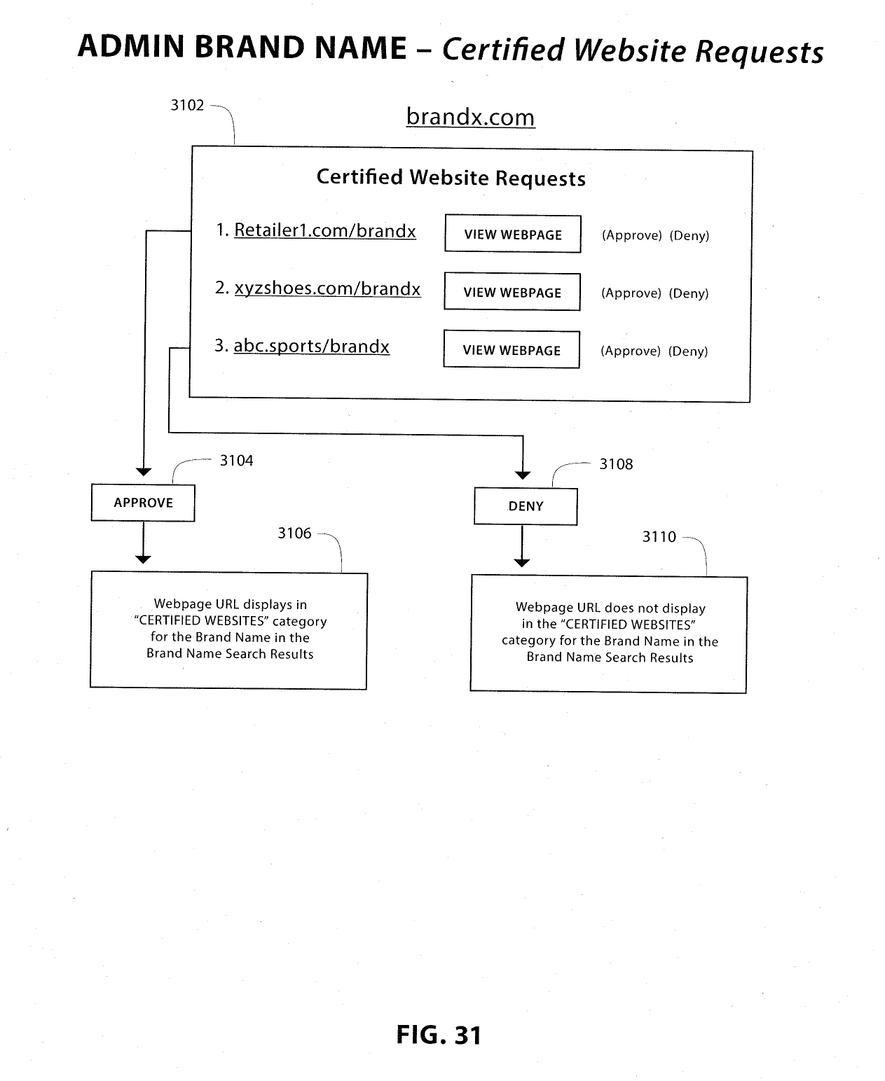

FIG. 31 illustrates an example process for processing certified website requests. At block 3102, the TLD search system (e.g., the TASS), receives a request from one or more registered websites or webpages to be listed as a certified website with respect to an identified website. For example, if the identified website is a shoe manufacturer, one or more certified website requests may be received from shoe retailers that sell the shoe manufacturer shoes. For example, the request may include the URL of the webpage which the requester wants listed on a brand name search results page provided in response to a user search for the brand name of the shoe manufacturer. By way of illustration, if the brand name of the shoe manufacturer is AcmeShoes, and the requester is a shoe retailer BetaRetailer that sells AcmeShoes footwear, the URL of the page may be BetaRetailer.com/AcmeShoes. The requests may be presented to the identified website owner via an email with a link to a requests received webpage, via an application, or otherwise.

If, at block 3104, the identified website owner approves the request, than at block 3106 the webpage URL submitted by the requester will be displayed in the certified websites category for the brand name in the brand name search results, when such brand name search results are provided to a user (e.g., in response to a search for the brand name associated with the identified website). If, at block 3108, the identified website owner denies the request, than, at block 3110, the webpage URL submitted by the requester will be prevented from being displayed in the certified websites category for the brand name in the brand name search results. Additionally, the brand/website owner can add a third party website URL of its choosing and its at own initiative as a certified website without receiving a request from the third party.

Keyword Directory—Add Request:

A TLD registry can request the addition of a new keyword directory choice from the TASS. Such an addition may be beneficial to a TLD that does not currently exist in the TLD Alliance keyword directory database list. Optionally, such requests may need to be approved by the TLD Alliance Board or other designated entity as a keyword directory that would be useful to include in the TLD Alliance Search System. If approved, the keyword directory may be added to the TLD Alliance keyword directory database, and an alert may be transmitted to the systems of the TLDs in the alliance regarding the new TLD Alliance keyword directory. A given TLD entity may then select “Join” or “Decline” via a control provided by their TLD Alliance Administrative interface, and the selection is received by the system. If they chose to join, they may then submit a domain name with that keyword.TheirTLD for approval from the TLD Alliance Board, or if they were unable to secure the domain name with the exact keyword, they may submit an alternate domain name choice to the TLD Alliance Board. For example, if they do not own the domain footwear.TheirTLD, they may still join the directory for the keyword “footwear” by owning a domain that is similar, such as myfootwear.theirTLD. They may submit a request to the TLD Alliance Board to register that domain name under the keyword directory for “footwear”. If the Board approves of the relevancy of the submitted domain name, that TLD may be returned as a relevant keyword directory website for “footwear” and they may appear when the end-user enters footwear as the search keyword in the priority field. Additionally, the optional TLD Alliance Guidelines may optionally have a minimum number requirement of brand name websites that participate on the keyword directory website for the directory to appear as a choice to the end-user.

Social Networking Theme:

A TLD theme may also be set up to act as a social network. For example, the TLD registry for .network or .business may create keyword directories that act as a social networking system. This may be achieved by replacing the example of “Brand Name” websites that exist on a keyword directory for pizza.Coupon, with personal “Profile Websites” that exist on sportsfans.network. Controlled content websites structured according to the theme of social networking may also be provided.

For example, if the end-user were logged into their profile account for this participating TLD registry in the TLD Alliance, a user interface and system backend may be provided enabling the end-user to send a Friend Request or Connection Request to a Profile Website in the keyword directory. By way of illustration, the keyword directory may be located at sportsfans.network or architects.network. In this example, the Profile Websites may be an individual person's website for that specific TLD, such as Johnny.network. At Johnny.network, the end-user (Johnny in this example) may have his personal webpage, designed using controlled content website templates that include a communication center interface to connect with other people in the keyword directory groups for that TLD. Johnny might be interested in interacting with people that are sports fans, architects, etc. When logged into his profile at Johnny.network, Johnny may add or communicate with people located in the sportsfans.network keyword directory and the architects.network keyword directory.

With the TLD Alliance Search System and the subject specific website content guidelines, this social networking theme may accommodate the communication of more than one TLD environment (e.g., if the Alliance board had approved the cross-relevance of the TLD themes and the TLD registries agreed to reciprocate their services). For example, the social networking theme may include the .dating TLD registry, or another TLD of a social networking theme with similar website content templates which had the same or similar features of Send Message, Friend Requests, etc. Optionally, a certain level of uniformity of functions within the website content templates or guidelines may be required or provided to perform these functions across a multiple of TLDs. In this scenario, Johnny.network may also “Add a Friend”, from the URL Jennifer.dating, which may put Jennifer in a Friends list for Johnny.

Optionally, if someone were searching the TLD Alliance Search System at search.dating, for the keyword “singles”, the system may identify a keyword directory for singles.dating to be included in the search results, but the search results may further include other relevant domains, such as singles.singles, singles.club, singles.online, if these participating TLDs agreed they wanted to be a part of the same alliance with each other. Optionally, the TLD Alliance board or other authorized entity needs to approve the inclusion of the TLDs being in the same environment to ensure such inclusion is appropriate and that the focus of the TLDs are related. If the system determines that the approval has not been provided and recorded, optionally the system will not include such TLDs in search results for a query for a different TLD. For example, singles.horse may not be a helpful TLD environment to offer to the end-user in this example, because the theme of “horse” is not relevant to dating, so even if singles.horse had a keyword directory and it matched as an existing keyword directory, it may not be offered to the end-user searching the keyword “singles” at Search.dating.

The compatibility of TLDs may be approved/disapproved manually by authorized personnel, (e.g., of the operator/alliance, by indicating so to the system) and/or may be done semi-automatically or automatically optionally using a table of compatible and/or incompatible labels stored in the computer accessible memory of the system. The site in which the end-user is starting their search may determine or infer what the end-user may want to see in their search results and so may exclude non-relevant TLDs. The end-user may also have a checkbox or other control for “all TLDs” with associated keyword directories, to bypass the subject matter relevancy consideration.

Example Search-Related User Interfaces

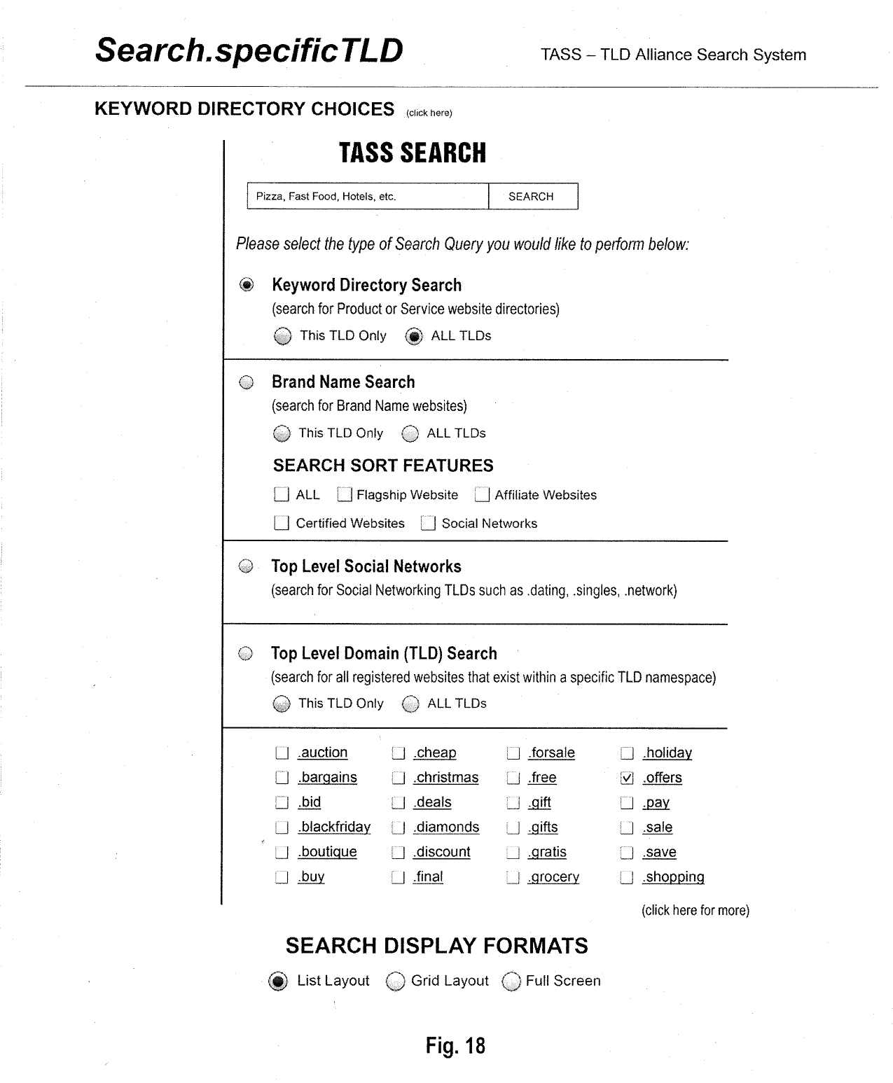

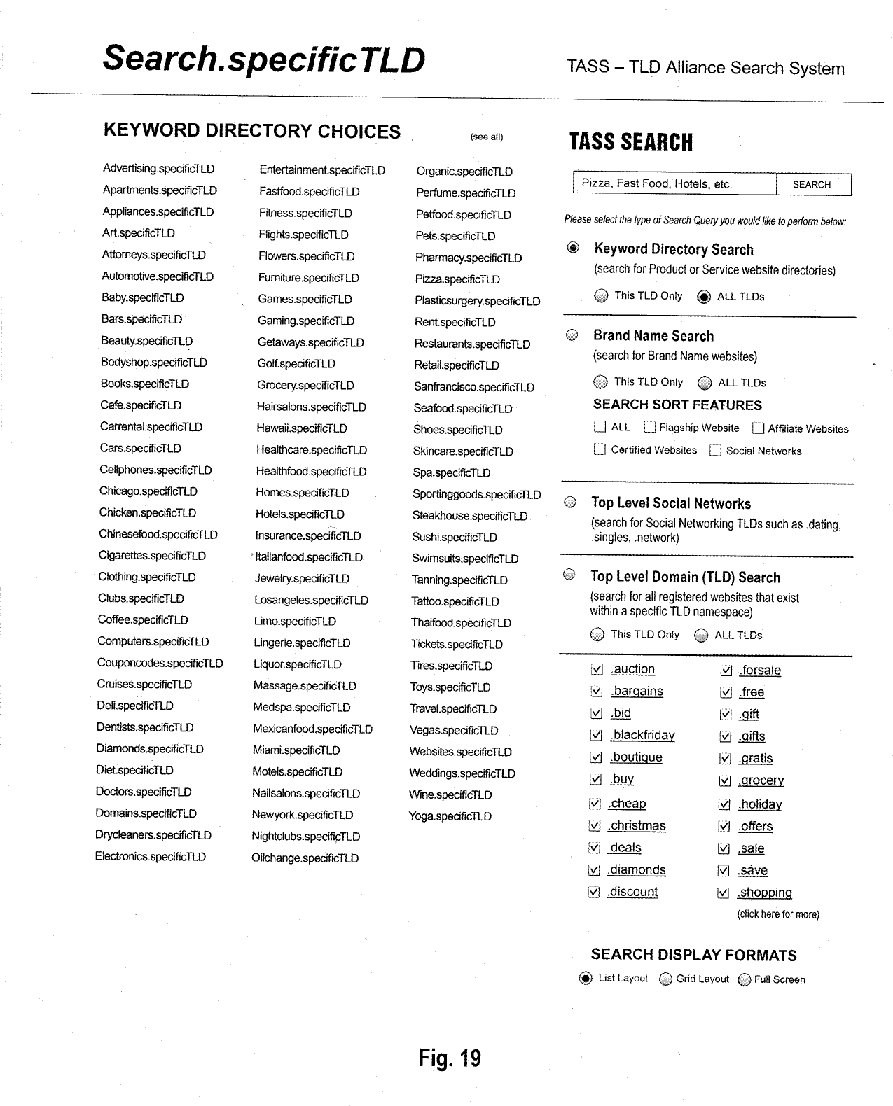

FIG. 18 illustrates an example TASS search user interface. Optionally, the search user interface may be presented as a starting search page at a URL having a search-specific second level domain (e.g., search.TLD, such as search.offers) and a subject specific TLD (e.g., .offers). The user interface may include a search field configured to receive one or more search terms. Controls are provided via which the user can specify if the user wants to perform a keyword directory search or a brand name search, and whether the search should be limited to the current TLD (e.g., .offers) or whether the search may extend to other TLDs. The user can also specify one or more sort options for a brand name search (e.g., sort the results by flagship website, affiliate websites, certified websites, social network, etc.). The user interface may also enable the user to specify whether top level social networks (e.g., having social network specific TLDs such as .dating, .singles, etc.) are to be included. The user interface may enable the user to specify whether the search is to be extended to all TASS registered websites that exist within a specific TLD name space. A list of TLDs is presented from which the user can specify which TLD name spaces are to be searched. The user can activate a link to have keyword directory choices displayed for user selection, such as is illustrated in FIG. 19. The user interface illustrated in FIG. 19 also includes the TASS search user interface positioned to one side of the keyword directory listing. The TASS receives the search query provided via the TASS search user interface, performs a corresponding search, and provides the search results, optionally sorted as specified by the user.

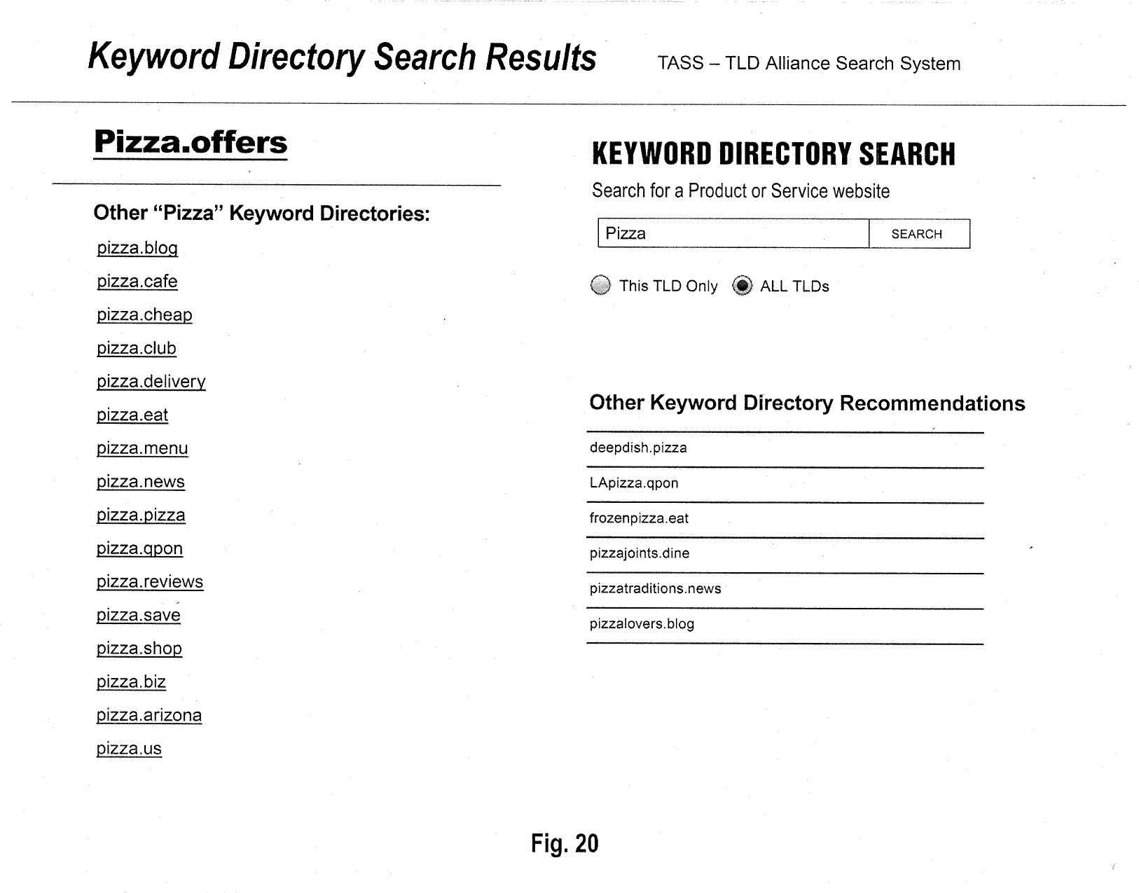

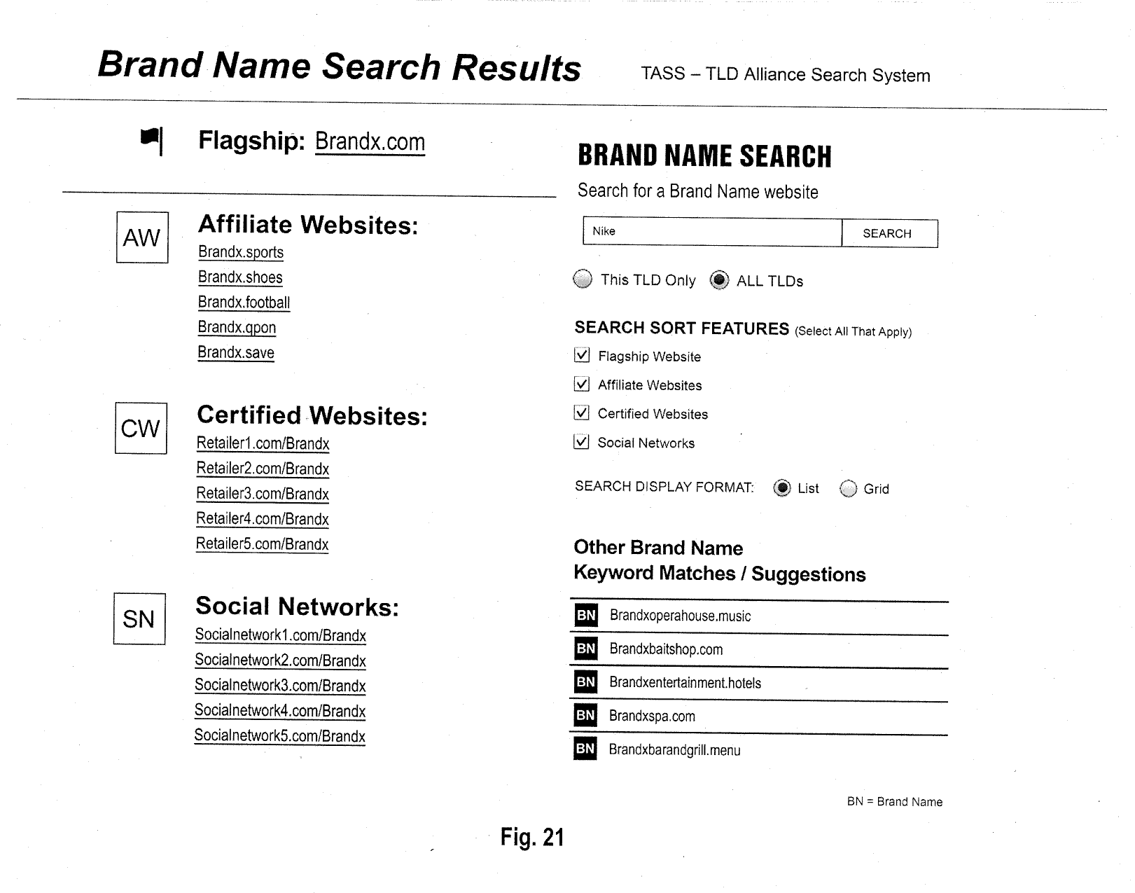

FIG. 20 illustrates an example user interface presenting keyword directory search results returned by the search system (e.g., the TASS) and displayed on a user device. In this example, the search query term was “pizza” and the query was submitted at a webpage presented at the domain search.offers. The most prominent displayed result is a domain name, which comprises a link to the pizza.offers directory (where “pizza.offers” includes the starting TLD of “offers”, which is the same as the search page TLD, and the user's query term “pizza” is included as the second level domain label). In addition, the user interface displays, in a less prominent location, other domain names that the search system determined where potentially relevant to the user query.

In particular, the user interface illustrated in FIG. 20 displays links to other keyword directories that match and contain the user query term as a second level domain label, and that include a TLD that the search system determined is relevant to the query (e.g., pizza.menu, pizza.delivery, etc.). The user interface further displays, in a still less prominent location, other potential keyword directories that the search system deemed relevant to the user query, but whose second level domain labels do not exactly match (or do not textually match at all) the user query term, and whose TLD may or may not match that of the webpage via which the user entered the query (e.g., deepdish.pizza, lapizza.coupon, etc.). Optionally, the search system will only include keyword directories in this last grouping if the keyword directories include the user query term somewhere in the domain name (e.g., as part of the second level domain or as part of the TLD). The user interface illustrated in FIG. 20 also includes a keyword directory search user interface enabling the user to submit a more refined search (e.g., pizza AND menu) or a new search. The user can specify to the search system that the search is to be limited to the TLD of the search page or that the search may be extended to other TLDs. The search system will receive the submitted new/revised search query, perform the corresponding search, and return the results to the user device.

FIG. 21 illustrates an example brand name search results user interface. In this example, the user had entered a brand name as a search query term, and had indicated via a search user interface (such as the example user interface illustrated in FIG. 18 or via the brand name search user interface illustrated in FIG. 21) that the results are to be sorted in the categories: flagship websites, affiliated websites, certified websites, and social networks. The search system received the query, identified the corresponding flagship website, affiliated websites, certified websites, and social networks associated with the user specified brand name, and returned the search results via the illustrated brand name search results user interface.

Referring to FIG. 21, the brand name search results user interface displays the flagship domain name/link in the most prominent, primary position, in a flagship area in association with the flagship icon (e.g., a flag) and a flagship title. The user interface displays, in the next most prominent position, the domain names (which also act as links) of affiliate websites. The user interface displays in the next most prominent position the domain names (which also act as links) of certified websites, a given domain name optionally including a directory pointing to a webpage that is directly relevant to the brand name. For example, if the brand name is AcmeShoes, and a certified website is a shoe retailer BetaRetailer that sells AcmeShoes footwear, the certified website domain name and directory may be BetaRetailer.com/AcmeShoes, which links to a BetaRetailer.com webpage displaying AcmeShoes footwear. Domain names/links of social networks associated with the brand name may be displayed in a still less prominent position. The domain names may include the domains of various social networks, with a directory pointing to a webpage that is directly relevant to the brand name (e.g., GammaSocialNetwork/AcmeShoes), such as a social network page controlled by the brand name. The search system may identify and include in the search results other brand name keyword matches/suggestions in a still less prominent position. For example, the search system may identify domain names that have the brand name somewhere in the domain name, but that includes other text before or after the brand name (e.g., BestAcmeShoes.com, DiscountAcmeShoes.deals, etc.). It is understood that the various categories may be displayed in a different order and with different levels of prominence.

As discussed elsewhere herein, optionally a brand name owner may control the location on the page of the various categories (e.g., flagship, affiliated websites, certified websites, social networks, other brand name keyword matches, etc.) of the brand name search results, and can control the ranks of domain names within a category (e.g., the brand name owner can specify the order affiliated websites are presented in the affiliated websites category, the order certified websites in the certified websites category are presented, and/or the order social network websites are presented in the social network websites category). The affiliated websites, certified websites, and social networks may be registered with the search system.

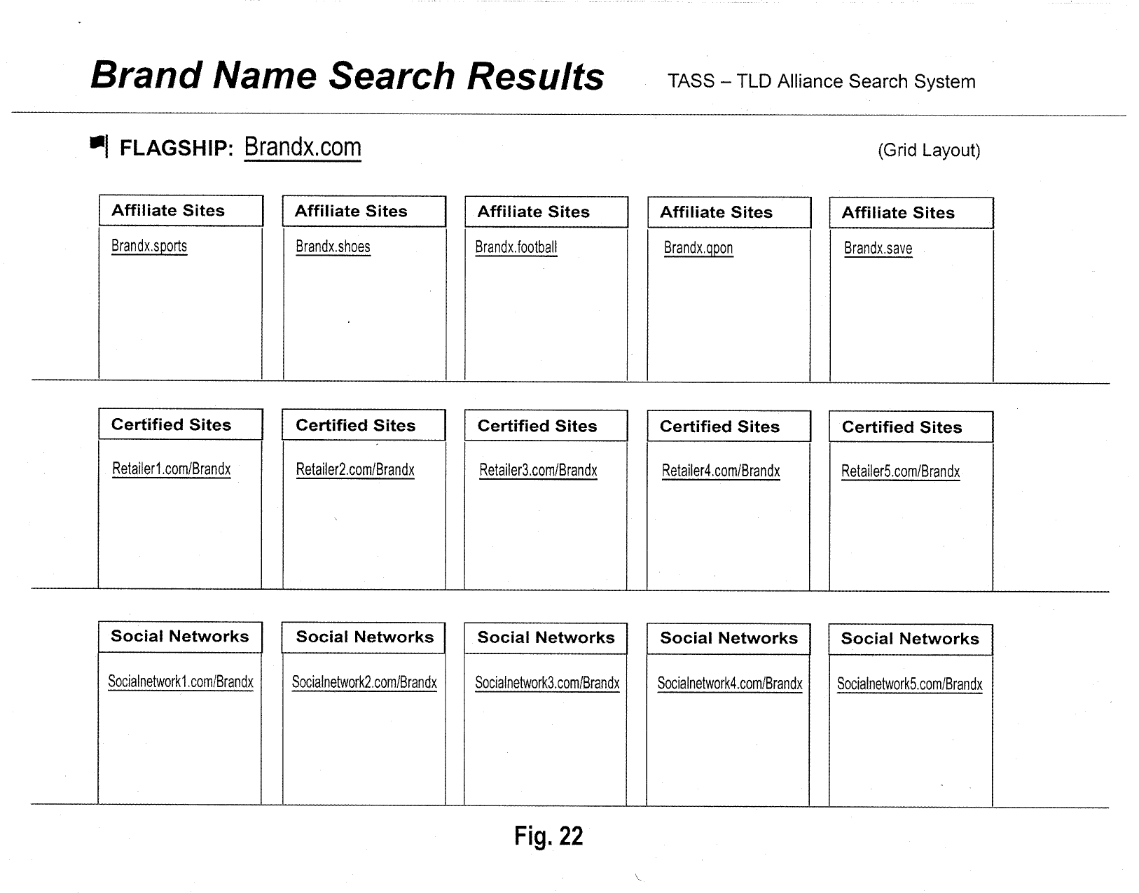

FIG. 22 illustrates an example brand name search results user interface similar to that illustrated in FIG. 21, except the categories are organized as rows, and the domain names are presented as tiles within the rows. The user interface is scrollable horizontally in order to present additional domain names in a given category, and is scrollable vertically in order to present additional categories.

Reciprocal Search Results (RSR):

Optionally, TLD registries are provided the option to enable “Reciprocal Search Results” (RSR) to be provided when end-users are searching in other TLD environments. For example, a user interface may be provided via which the TLD registries can enable or disable RSR. For example, if there is no theme relationship between TLDs, there may be no benefit to provide reciprocal search results for those TLDs, and so RSR may be disabled for such TLDS. Optionally, this reciprocal relationship may be agreed upon between each TLD registry per keyword directory or for the entire TLD environment. This enables each TLD registry in the Alliance to inhibit an alliance with a TLD they feel is too direct of a competitor and therefore do not wish to promote the competitor's TLD through the search results of end-users searching within their TLD space. In turn, the TLD registry will not receive the reciprocal search results from the other TLDs. TLD registries can choose with whom to reciprocate within the TLD Alliance. TLD reciprocal search results may benefit the end-user, the TLD registry, and/or the websites in each TLD environment.

Optional TLD Alliance Uniformity:

Optionally, a uniformity of functions is provided for functions offered in the keyword directory environment, as well as for the provided TLD controlled content website templates, so end-users do not have to educate themselves on the website functions of each website individually as they do with conventional approaches. Although each TLD search system may have a different theme with different options, many functions, features, and navigation bar selections may be uniform, enabling the end-user to become familiar with the system and not experience a learning curve every time a website is visited. Ensuring such uniformity amongst thousands or millions of websites will save the end-user time while viewing, searching and executing what they are looking for. By contrast, conventionally it may take a user a significant amount of time to find a feature on a given website or to otherwise utilize the given website.

Custom URL Brand Color Recognition Function:

Another optional benefit of the TLD Alliance Search System that may be provided is the feature of custom URL brand color recognition. Optionally, a given registered TLD owner may be able to choose a company/brand color for their TLD to display in the browser address/URL field. This feature may be provided via API (application programming interface) integration with a browser, such as Safari® or Internet Explorer®, enabling this helpful feature to be provided for some or all participating TLDs in the TLD Alliance.

There are many new TLDs entering the root zone with and without the plural signifier “S”, such as .coupon and .coupons. This causes confusion for the end-user in many cases. If two TLDs, differing only with respect to the “s”, were registered within the TLD Alliance Search System, each TLD owner could specify their TLD brand color within the TLD Alliance Search System to avoid confusion (e.g., the .coupon TLD owner may choose to be red and the .coupons owner may choose to be green) and to help the end-user recognize which TLD they are at. This is helpful to the TLD registry as well as the consumer. Colors will help with brand recognition for the TLDs, and also assist consumers in recognizing and easily confirming at a glance they are at the correct TLD namespace of their query.

For example, the following websites with similar TLD extensions may be confusing to the end-user. By assigning and programming the TLD part of the URL to recognize a TLD brand color, the end-user will be less likely to be confused if they are at the desired website.

Example websites with similar TLD extensions:
BrandX.Qpon
BrandX.coupon
BrandX.coupons
BrandX.com
BrandX.co

An auto-brand color TLD namespace identifier module may be configured to recognize when a series of .characters are submitted in the address/URL field of a browser via a link that opened the browser window or when the end-user enters a registered series of characters in a URL followed by a space or the enter key. The associated tab in that browser may also turn the TLD brand color that the registered TLD chose for its brand, thereby providing a helpful brand association of that TLD and their niche. The API may be programmed to recognize at least one character or word connected, without an intervening space, by a period (.) and then referencing the TLD typed thereafter. Optionally recognition of a space or an enter key command may complete the sequence and initiate the referencing of the associated TLD brand color. If the registered TLD is recognized, the characters of the TLD will be caused to be colored in the TLD brand color. For example, if the user entered BrandX.Qpon, and the TLD brand color chosen was red, just the .Qpon part of the URL may become red.

Similar API integration may also be provided with email software programs, word processing programs, and/or other programs to achieve the same or similar TLD color brand recognition. For example, if an email address is entered into an email address line or in the body of the word processing document, the example below may display “.sports” in orange if that was the color of that TLD brand.

Jeff @ BrandX.sports

### Optional Benefits:

By creating a search system and alliance at the TLD registry level, the end-user, the TLD registries and the brand name websites within each TLD may benefit. Some of these optional benefits are listed below.

Optional End-User Benefits:

Increased choice and awareness of new affiliated TLDs for brands;

Minimizes/reduces end-user confusion with respect to similar TLD strings;

More relevant search results;

Targeted organized search results; and/or

Saves time and frustration of “weeding through” unwanted search results.

Optional TLD Registry Benefits:

An organized namespace with relevant search results.

Brand recognition for the TLD registries;

A given TLD registry manages searching throughout their namespace and controls their search engine keyword directory choices;

Additional revenue streams for the TLD registry;

PPC advertising;

Cross-referencing of websites within their TLD namespace that address a specific generic keyword directory representing an industry, product/service or location that have brands participating within that TLD, and reduction in the amount of conventional searching an end-user must do to find out if a certain TLD does have websites that address a specific industry, product/service, or location relevant to the end-user's specificity; and/or

Forming an alliance with other TLD registries that drive traffic and awareness to their TLD.

Brand Name Benefits:

Increased purpose for a brand registering and setting up websites for many TLD niche domain names, rather than just a single .com site;

Increased awareness of newly affiliated TLDs for brands;

Brand names can certify websites that sell or represent their product or service; and/or

Brands can organize their own certified website search results based on what priority listing the brands assign to entries in the certified website search results. Brands can also organize their affiliate websites and social networks sites in the brand name search results based on the priority listings the brands assign to the affiliate websites and social networks.

Advertising and Affiliate Ads:

The institution of affiliated TLDs enables advertising companies to sell ads to a brand name owner across a multiple of keyword directories for affiliated TLDs. Optionally, advertisements can be customized for different consumer audiences that may be associated with different TLDs in the affiliated TLDs or to reflect different purposes associated with different TLDs in the affiliated TLDs. Conventional advertising on conventional search engines do not adequately achieve such benefits.

By creating a verified affiliate relationship of many TLDs owned by a brand name when registering these affiliate sites in the TLD Alliance, an advertising agency may sell a third party ad on any website, such as a banner ad or a 300×250 pixel ad, where the ad reflects the verified affiliation of these websites (e.g., includes links to some or all of the affiliated websites). When the end-user clicked on the ad, some or all of the affiliate websites may open in separate browser windows or tabs, which may consolidate and reduce the cost of advertising as opposed to advertising many individual websites. Because the brands have already verified the affiliation and relevance of these ads with the TLD Alliance, it is more likely the end-user will receive results helpful to them.

These “Affiliate Ads” may be structured in groups that may be helpful to the end-user. For example, if the ad were for a pizzeria, “Tony's Pizza”, when the end-user clicked on the ad, affiliated websites, such as TonysPizza.Qpon, Tonyspizza.menu, and Tonyspizza.review, may all open in separate browser windows or tabs. The end-user may view many aspects of Tony's Pizza as reflected by the various affiliated websites before going to Tony's Pizza. These “Ad Groups” may optionally be limited to a maximum number of ads (e.g., 3, 4, or 6 ads) so the end-user is not overwhelmed with choices. Guidelines may be generated for determining TLD cross-relevancy (e.g., to determine whether “.Qpon, .menu, .review have a related theme from the end-user perspective). Such guidelines may be approved by the TLD Alliance or other authorized entity, such as an accredited advertising agency registered with the TLD Alliance.

Cross-Advertising:

The TLD registry operators of respective affiliated TLDs may benefit from selling more keyword directory advertising as a result of cross-advertising suggestions transmitted to the brand names in the system. For example, when BrandX.sports places an ad on the keyword directory for shoes.sports, the TLD Alliance system may determine that BrandX also owns BrandX.Qpon and so may infer that the sites are affiliated. The TLD Alliance system and may transmit a suggestion to BrandX.sports recommending or asking if BrandX.sports wants to include BrandX.Qpon in the keyword directory for shoes.Qpon. Optionally, the TASS or the TLD registries may have to approve to participate in this reciprocation of cross-advertising. Optionally, compensation may be provided to the TLD of the originating ad sale providing the TLD owner with another revenue stream.

The system may also prompt BrandX.sports via the TLD Alliance Administrative system when BrandX is posting an item on BrandX.sports, asking if BrandX if it wants to create a coupon to be offered via the website BrandX.Qpon for this product. If the system determines the websites are verified affiliate websites with the capabilities of an interactive administration of the affiliated TLDs, a user interface may be presented to BrandX.sports, prompting an authorized entity to upload a coupon or create a coupon with a coupon creator tool. The coupon creator tool may be hosted by the TASS, the brand name's system, or other system.

TASS Search:

A TLD registry participating in TASS may also offer a search interface (e.g., a universal search bar at the top of each website that is registered with TASS) which may enable the end-user to execute a keyword directory search (KDS) and/or a brand name search (BNS), in addition to providing a search.TLD search page.

TASS Master Search:

In the event that TASS is managed by an organization outside of a TLD registry, such as a registrar like Godaddy, a master search interface may be provided which may be accessed by the end-user at a specific URL location that did not have a competing bias to a particular TLD environment such as search.godaddy. The master search function may be configured to offer some or all available search results to the end-user. Because the end-user may not be starting their search at a search.specificTLD, there may be limitations as to which other TLDs have reciprocal search results (described elsewhere herein) with the TLD where the end-user initiated their TASS search. For example, if the .sports TLD registry was not in a reciprocal relationship with the .basketball TLD registry, the .basketball keyword directory may not appear in the end-user search results.

Because the master search function optionally is not biased with respect to a particular TLD, the search results may optionally include all of the relevant participating websites in the TASS registered TLD database, which relate to the keyword entered into the keyword directory search (KDS) and the brand name search (BNS).

Registrar Administration of TASS:

It may be efficient for a registrar to implement the TASS method and search system, as they may already have many of the necessary elements needed to create and execute the TASS and to provide a more organized TLD specific search system, and to optionally implement one or more of the business models described herein. Registrars typically already have relationships with TLD registries, and they can manage the DNS, hosting, and website template creation enabling TLDs to participate in the TASS (TLD Alliance Search System).

Conventionally, registrars do not offer the services of a TLD specific search system. However, registrars may efficiently offer TASS services to domain name owners, encouraging domain name owners to participate in TASS as another upsell to the registrar's current products and services. The PPC ad revenue from the ads sold to brand names on TASS may potentially exceed all of their current revenue streams combined. In this scenario, the registrar, TLD registry and the domain owners can cooperate and interface to implement the TASS system. There may be revenue share relationships set up between the TLD registries and the registrar(s) and optionally the owner of a keyword directory domain name owner to share PPC ad revenue generated from the keyword directories.

A registrar such may optionally create a “Master Search” URL location webpage which may be a common starting point for the consumers to search TASS, wherein the master search may return the entire database of relevant TLD specific keyword directories and brand names participating in TASS and receive the relevant TLD specific search results that are associated with that keyword within the TASS database.

Because a registery typically owns its own TLD (e.g., .RegistryName), the registry may create the URL location “Search.RegistryName”. Such a URL location and associated webpage may be programmed as the master search starting point location for end-users wanting to search through the entire TASS database for a keyword directory search or a brand name search. If the end-user started their search at search.RegistryName or RegistryName.com/tass or the like, there may be no conflict of competing TLDs and it may be beneficial to return search results of all TASS participating TLDs related to the keyword directory search and/or the brand name search.

As similarly discussed elsewhere herein, the end-user may also be able to initiate a TASS search by entering a keyword via a search webpage at the URL search.AnyTld. In response, TASS may return TLD specific relevant search results corresponding to the entered keyword, and in addition, reciprocal search results for the TLDs that have agreed to the posting of reciprocal search results.

Thus, for example, the .sports TLD registry and the .basketball TLD registry may choose to create a reciprocal relationship for a brand name search, but may choose not to enable the provision of reciprocal search results to cross-promote the keyword directories. By way of illustration, two TLD registries may consider each other as too much of a competitor to enable cross-promotion of keyword directories. However, the TLD registries may decide that it is advantageous to enable the provision of reciprocal search results for brand name search queries to receive some or all of the corresponding benefits of the TASS system. The brand name websites may be able to offer the end-user search results of their other affiliate TLD brand name websites in the search results of a TASS brand name search as it may not affect the PPC ad revenue business model of the keyword directories and the provision of reciprocal search results may benefit both the end-user and the brand names within each TLD.

Increased Value of Premium Domain Names:

Thus, the search system may increase demand and increase value for premium generic domain names. Registrars can sell such generic domain names at a premium because of the added value of having the domain name pre-approved for inclusion in the TLD Alliance Search System as a keyword directory which will generate revenue for the domain owner. For example revenue may be generated for the domain owner as a result of a revenue share with the TLD registry, the registrar where the domain name was registered or the managing body of the search system, or the revenue share may be split between all previously mentioned entities.

Review Services—TASS Participation Benefits:

User review aggregation systems, such as Yelp®, may also benefit from participating with the TASS. User review aggregation services or the like typically already have many business relationships with brand names and can create an additional revenue stream and revenue share using the TASS in a variety of ways. Conventionally, user review aggregation systems present paid listings and free listings on their review websites. User review aggregation systems may offer an upgraded service of adding a TLD specific website icon on the user review aggregation system review ad listing for that brand name. The TLD specific website icon (e.g., a “user review aggregation system icon”), when selected, may direct the user browser to different TLD webpages the brand name owns. The TASS operator or a registrar may upsell this service and a revenue share agreement may be created between the TASS operator, or a registrar, and the user review aggregation service for the sale of the upgraded service. The user review aggregation system may also contact the current businesses listed on the user review aggregation system and sell such business ad listings on the correlating TASS keyword directories.

The user review aggregation system may receive a referral commission from the registrar for the sale of the TLD specific domain name, which may optionally be required to participate within a given TLD keyword directory, as well as a revenue share of the PPC ad revenue if they were the referring source of the TLD specific domain name sale, and ultimately the keyword directory PPC ad revenue generated from that brand name.

User Review Aggregation System Administration of TASS:

A user review aggregation system may also effectively implement the TASS method and search system. A user review aggregation service may have the same or similar relationships with the TLD registries, registrars and domain owners as described previously with respect to the Registrar Administration of TASS example, except the user review aggregation service may manage the TASS and the revenue share may be appropriated differently since the user review aggregation service the managing body of TASS. The user review aggregation system may already have a large database of business relationships and creating a TASS may enable the user review aggregation service to better compete with other user review aggregation services. For example, the user review aggregation service may provide end-users with more organized and accurate search results than competitors.

For example, the user review aggregation service may deliver TLD specific search results via the TLD specific keyword directories or in response to a user activation TLD specific brand name icons that may be displayed on their current review ad listings. The end-user may access the master search for the TASS at the user review aggregation service's second level domain for various TLDs (e.g., the URL AcmeRecommendationService.search or AcmeRecommendationService.review) or at AcmeRecommendationService.com/search or AcmeRecommendationService.com/tass or programmed as a TASS search interface (e.g., a search bar with a search field) displaying on some or all of the recommendation service's webpages. In response to receiving a user query including a generic category keyword (e.g., “pizza”), which the end-user may have entered into the search field or sort, the recommendation service may additionally make an available link to each TASS keyword directory associated with a generic category keyword. The end-user may be provided with the matching reviews and optionally additionally be provided user-selectable links or icons directing the user browser to the TASS keyword directory located at pizza.deal or pizza.pizza, which may then display ads that may generate PPC ad revenue for the recommendation service when selected by the end-user. Another business model relationship could be formed that enables the recommendation service to post a link to a keyword directory and the keyword directory to post a link to the recommendation service. The system analytics module may record how much traffic was generated from the recommendation service and to the recommendation service. Optionally; the entity that generated the least traffic of the two would be responsible for paying a pre-negotiated amount of the difference. Thus, optionally, rather than utilizing a straight PPC revenue, the PPC difference may be calculated and the revenue appropriated accordingly.

.com TLD—TASS Integration

Optionally, the TASS integrates the websites which compile some or all of the purposes of a brand name into one website, as is common with conventional .com website. However, as discussed above, the TLD “.com” will not be very effective as an identifier or a theme folder for the end-user to reference.

A given brand name flagship, such as AcmeShoeBrand.com for Acme Shoe Brand.com is a .com TLD and optionally can only exist on a TASS keyword directory (KD) for the .com TLD. For example, optionally, AcmeShoeBrand.com is prevented from being included in the keyword directory for shoes.basketball or sports.basketball, since the ad listings allowed on those keyword directories are TLD specific to “basketball”. With the organized TLD specific search system of TASS, brand names with .com websites may greatly benefit from obtaining additional brand name domain names with more specific TLD extensions which represent some of the products, services or categories they offer at their .com website.

By registering additional domain names with other TLDs, which represent the specific category theme of each TLD, such as AcmeBrandRestaurant.menu for their menu information, and AcmeBrandRestaurant.deal for deals and offers, their Internet exposure may be increased in each TLD environment on TASS. This will help organize their Internet presence to benefit the end-user while also creating greater Internet exposure and traffic for their brand. In other words, the brand names may be filing categories of their .com website into convenient TLD domain name “folders” which help the end-user find specifically what they are looking for quicker.

For example, if AcmeShoeBrand.com currently had a webpage located at AcmeShoeBrand.com/basketball within their .com website, they may register the domain name AcmeShoeBrand.basketball and create a webpage containing that same or similar content as AcmeShoeBrand.com/basketball in order to be included in keyword directories for the TLD .basketball which may increase their exposure in a whole new TLD environment enabled by the TASS. They may quickly and efficiently input the same webpage content from AcmeShoeBrand.com/basketball into the TASS provided website templates for their AcmeShoeBrand.basketball website. This example may be applicable to many categories of new TLDs entering the root zone and TASS can provide that extra Internet exposure to end-users searching many TLD environments. Similarly, if AcmeShoeBrand has a webpage for AcmeShoeBrand.com/shoes, AcmeShoeBrand may register the domain name AcmeShoeBrand.shoes and create a webpage containing that same or similar content allowing them to exist on the keyword directories for the TLD “.shoes”. AcmeShoeBrand may own the domain AcmeShoeBrand.shoes and may be enabled to provide a prominent control (e.g., an icon, button and/or link) directing the end-user to their flagship .com website webpage located at AcmeShoeBrand.com/shoes, if the brand wishes to do so. The control may be referred to as a “flagship website” (FW) icon. Thus, a brand name is provided the ability to offer navigation from a given affiliated non-.com website to their .com website or any other website or webpage they own.

TASS Will Increase Domain Name Distribution:

Owners of a .com brand name website may be encouraged to buy or otherwise obtain additional domain names with specific TLDs identifying the purpose or theme of the corresponding website, and enabling the specific TLDs to be included in the keyword directories of many TLDs within the TASS, which may also provide further exposure for the .com website.

Thus, utilization of the TASS will likely result in increased domain name sales benefiting the TLD registries and the registrars while enabling the use of the Internet to further benefit end-users and merchants.

Automated TLD Specific Keyword Directory Posting:

As discussed above, for a given website, the TASS gathers the website type (e.g., at registration with the TASS or the registrar where the domain name is registered) enabling the TASS to determine that it corresponds to a brand and may appropriately belong on a directory website representing a product or service. Optionally, a location is received and used for location based keyword directories. Optionally, an “Industry Type” specification and keywords that relate to the Industry Type, or products and services the website offers are received, enabling the TASS to determine which keyword domains may be appropriate for the brand name website to be posted on. The TASS may be configured to automatically post the brand to the appropriate keyword directories or suggest to the website owner which keyword directories it may benefit from. If the domain name is registered as a directory website type, the system may determine: which website templates to offer the domain name owner that may be appropriate to the TLD specific keyword directory; whether the keyword directory is eligible to be a TASS keyword directory; and/or whether there are other associated keyword directories in other TLDs that may generate reciprocal search results for this keyword directory, as discussed elsewhere herein.

Thus, the combination of the information gathered by the system, categorized and organized as discussed herein, creates a new improved search method and system, and creates a new Internet advertising method for brand name websites.

Memorial TLD:

A further example application of the TASS and methods described herein will now be discussed with respect to obituaries.

The TLD Specific Search System, optionally controlled and managed by the TLD registry operator (e.g., for .memorial or other memorial focused TLD), searches and interconnects a specific TLD namespace (related to memorials in this example) comprised of participating subject specific directory websites. The specific directory websites may include associated participating subject specific controlled webpage content websites which are in the same TLD (Top Level Domain) niche.

Throughout the following descriptions, the TLD .Memorial may be referred to as a specific TLD for the purpose of posting online obituaries, funeral homes, personal memorial sites for loved ones, or other subjects someone wishes to memorialize. It will be understood that the TLD using the present method and apparatus can also be other than “.Memorial”, such as “.Love”, “.Remembered”, etc.

Conventionally, methods for the distribution and publication of obituaries suffer from many drawbacks. Many newspapers have gone out of business reducing the channels for the distribution and publication of obituaries. Additionally, if a person has lived in many geographic locations, the surviving family or friends may have to post obituaries in many newspapers to address all locations. Further, many conventional online obituaries do not stay online for very long, and all obituaries may be placed into the same .com website.

In order to address some or all of the foregoing drawbacks, a TLD specific online obituary community may be created, enabling end-users to create obituary listings that do not rely on the dwindling industry of newspapers or the primitive conventional online obituary listings.

The provision of a TLD specific community provides enhanced reliability within a corresponding dedicated TLD namespace (e.g., .memorial, .obituary, etc.). The TLD specific online obituary community enables a family to create an obituary and memorial listing for the whole family that can be passed down from generation to generation. For example, via the techniques described herein, a TLD database of registered websites may be cross referenced and searched using TLD-centric searches.

The cross referencing capabilities and the search capabilities enables new techniques for the posting and searching obituaries. By using the TLD as a dedicated TLD obituary specific “filing folder,” which creates a community of focus that is dedicated to a specific purpose, coupled with the TLD specific search methods of locating websites within websites registered within that TLD community and gathering information from the registration of those websites in that TLD community, and optionally providing a turnkey solution of TLD specific website templates to ensure relativity of that TLD environment, organization and specificity are provided, which results in a posting system that is more efficient, organized and reliable than conventional systems.

Because the TLD “filing folder” (e.g., .Memorial, .Obit, .Beloved, or .RIP), is used to create a dedicated and specific obituary focus of the search query, the end-user receives search results that are specific to the dedicated focus of the obituary/memorial industry. In this scenario, the end-user is searching for obituaries or memorials of humans, pets, museums, or other things that are memorialized. By gathering information when registering with the system, the system can further organize the focus into another filing folder (e.g. pets.memorial for memorials for pets).

For example, the pets.memorial site, which is focused on memorials for pets, may be included in a “pet” keyword directory. The information gathered at registration creates an organization tool for the search results category that achieves a more specific and reliable list of search results. By way of another example, obituary.memorial may be a keyword directory for obituaries that are TLD specific to that dedicated TLD namespace or existing registered websites. This creates the aforementioned organization and further creates a system of relations in that TLD namespace that enables a family to create a family tree of memorials utilizing the network of affiliated websites registered in this dedicated TLD specific community.

For example, a family may decide to set up a family memorial at the website jones.memorial, and a given individual person can register and set up a website for themselves (e.g., robjones.memorial, emilyjones.memorial, kathyjones.memorial), to provide both for individual recognition and affiliated recognition of their family or interest. Additionally, websites may have an organized association within that TLD database for other items that are associated with their website type, or other affiliation which has a keyword directory in which the system may reflect such association. The system may enable domain /website owners to take part in the specific benefits and organization tools that are addressed for a specific dedicated focus.

This obituary solution also addresses scenarios where someone is trying to select geographical locations to be associated with an obituary they are posting. For example, a deceased may be from Chicago, was last living in Florida, and at some time lived in New York. The person posting the obituary may include in a single listing reference to all states, cities and/or postal codes the person lived in, which may enable the listing to be returned in the TLD specific obituary search for each location. Thus, this technique enables a single obituary to cover all locations in which the deceased lived, rather than having to post a notice in a newspaper at each location, which may be costly and less effective.

Further, a printed newspaper is typically discarded daily. By contrast, the online posting may optionally be posted for an extended amount of time and can be searched for online. In addition, funeral homes may be provided a turnkey solution of website templates that provides functions typically needed by funeral homes. The website templates of the TLD specific memorial websites may have a link that connects the memorial website to a separate obituary listing (e.g., at a .memorial website, such as Forever.Memorial). Additionally, some or all of the memorial websites may be configured to enable a user to start a family tree of memorials for a specific family. For example, a family-specific domain, such as jones.memorial, may be a domain name registered by someone in the family (e.g., the Jones family), and as time goes by, other family members that pass away can be added to the jones.memorial website and/or a link may be added if the person preferred their own website. For example, a person, John, who is a member of the Jones family, may have a separate dedicated domain, such as johnjones.memorial, but also may be included along with his wife (and later, his children) on the jones.memorial website. The interconnecting of these sites and the relation between the website owners may be performed using the TLD specific system to create a TLD specific community of websites controlled and operated by the system.

As similarly discussed above, website templates may be provided to ensure consistency of appearance and for the user-friendly convenience of a turnkey solution website. Further, the TLD Specific Search System administration interface may be configured to prompt the domain owner to select a “Website Type” for their .Memorial website which will ensure the desired uniformity for the delegation into the corresponding website type(s) directory website listing. By matching a website type that has the uniformity of the controlled website templates for that website type, with a website type directory search category which is also provided by the TLD registry operator, reliable and relevant search results within a specific TLD niche are provided to the end user.

The TLD registry operator optionally provides the domain owner some or all of the following (e.g., via the administration interface):

A user interface via which the domain owner may select or otherwise specify the website type for the website corresponding to the domain

Category specific uniform website templates for the specified website type, which matches a directory listing website for that Website Type to automatically delegate that Website Type to list on the associated directory listing. Thus, category specific uniform website templates for the specified website type, which matches or corresponds to a directory listing website for that website type, where websites of the specified type are automatically included in the listing of the associated directory listing. For example, if the website type was a “Person Profile” (referred to as a brand name type website discussed above), the industry type choices presented by the system may include obituary website or memorial website. The system would then automatically post the obituary or memorial website to the keyword directory for obituaries.memorial or memorial.memorial accordingly in this example. The website would then be returned in search results across this TLD namespace for “Person Search” or “Obituary Search”, or “Memorial Search”, also referred to as a keyword directory search. One or more postal codes may be included for posting the Obituaries or Memorials to cause the posting to be displayed at websites or web pages associated with each of the places that person may have lived. As this TLD has a different theme than those discussed above with respect to other examples, the website type categories are different, nonetheless the system may operate similarly, except where the foregoing examples referred to “brand name,” in this example, the “brand name” is a Person Profile. Optionally, if the website type was specified as “Funeral Home,” the system may provide a website template configured for use by funeral homes, and the website link would be posted on a keyword directory, such as, for example, funeralhomes.memorial. Thus, keyword directories may be generated based on website type instead of, or in addition to industry type, and the system will recognize that the funeral home website link is to be posted on the associated keyword directory (e.g., funeralhomes.memorial).

Optionally, the TLD Specific Search System does not require or utilize a human to review the websites for relevancy with respect to a directory listing or TLD, because such relevancy may be ensured via the use of the controlled content website templates provided by the TLD Specific Search System, which delivers reliable and relevant search results for each category search.

If a user were to navigate a browser to the Search.Memorial website, the TLD registry operator will provide website-type search categories within the network interface of the TLD Specific Search System, which correlate with the website type specified by respective participating domain owners. When a domain owner sets up its .Memorial website (e.g., using the templates), if the owner selects a website type of “Funeral Homes,” the listing for its .Memorial website will be included on, and displayed via a FuneralHomes.Memorial directory in their zip code or otherwise in the close proximity. By way of further example, if the domain owner were to select a website type of “Flowers”, the listing for its .Memorial website will be included on, and displayed via a Flowers.Memorial directory listing website, and so on.

By way of yet further example, if a funeral home operator purchased the domain xyzfuneralhome.memorial, and chose to register its domain name with the TLD registry operator, the funeral home operator may first select a specific website type that fits its website purpose (e.g., the promotion of the funeral home and its funeral home services). If the user selected “Funeral Home” as the website type (e.g., by selecting a radio button or menu selection for “Funeral Home”), the system may provide the funeral home operator with website templates that were created by (or for) the TLD registry operator containing the appropriate subject specific information (or identified webpage locations for such information) a funeral home may offer on its website. Since the webpage content is controlled by the TASS or TLD registry operator, the website content on that funeral home's webpage(s) becomes a reliable, subject specific, TLD specific website, for which a listing is displayed in the directory listing website search results for a user query for “funeral home, where the directory listing website may have the URL www.FuneralHomes.Memorial. Optionally, the directory listing may only display participating controlled webpage content websites within a specific niche TLD on the directory listings. Thus, optionally, no websites with a different TLD extension, such as a .com website, will be allowed to participate in the TLD Specific Search System to ensure reliable, relevant and uniform search results to the end user. Additionally, optionally no .Memorial websites created by an outside web developer will be included in the directory listings. Optionally, a TLD registry operator may choose to approve a website created by an outside developer to be included in the directory listings (e.g., if they met specified criteria of the website type).

Optionally, more than one TLD may be included in a TLD directory listing if the TLDs were directed to a similar theme, and a relationship including the two (or more) TLD registry operators was formed for this purpose. For example, the TLDs .Memorial and .RIP are directed to a similar theme (memorializing the deceased), and optionally both may use the same or similar software interfaces, directory pages and controlled webpage content for funeral homes or other website types. In such a scenario, the website for xyzfuneralhome.memorial may also be included in the directory listings located at Funeralhomes.RIP. Optionally, the TLD registry operator for .RIP may have to adhere to the same requirements as the TLD registry operator for .Memorial, with respect to the controlled webpage content for the funeral homes provided by the TLD registry operator, in order to ensure reliable search results for a specific search.

The foregoing techniques may similarly be used if the domain owner of abcFlowers.Memorial selected the website type “Flowers”, and the TLD registry may supply a website template containing the appropriate and subject specific information a florist may offer on a website. In this example, abcFlowers.Memorial may be included in the Flowers.Memorial directory listing website along with other participating florists who registered a .Memorial website. If the TLD registry operator chooses, optionally it may require websites of a given website type (e.g., Flowers or other website types) to purchase a membership or a participate in a PPC business relationship in order to be included in the corresponding directory listing website.

If the domain owner is creating an obituary/memorial site for a loved one, they may select “Obituary/Memorial” as the website type, and be offered the website template containing the appropriate and subject specific information for creating an obituary or a memorial website. In this scenario, the listing for the created website may be included in an Obituary search result (e.g., at Obituary.Memorial or Memorial.Memorial) to assist family members and friends in finding their loved ones memorial website. The foregoing process may be similarly applied if the domain owner selected a website type of Pets, wherein the website listing may be included in a TLD specific directory listing website at Pets.Memorial or the like

By way of further example, “Location based” may be another website type (e.g., Beverlyhills.memorial). The website (e.g., Beverlyhills.memorial) may be a directory listing website with a sort function for obituaries, mortuary, funeral homes, memorial sites, pets, etc. The website may return search results based on the user-specified sort category which correlates with the location of the obituary, funeral homes, memorial sites, etc. The website may also return search results based on a keyword search, recognizing names and other important keywords. Thus, the directory listing website may have a field via which the user enter keywords and initiate a search. By way of illustration, if the user browser was at Beverlyhills.memorial, the default directory page may be of memorials in the beverlyhills area. If the user selected the sort feature “flowers,” a different keyword directory for beverlyhills.memorial/flowers would be displayed, which would bring up ad listings for flowers shops in Beverly Hills

The TLD registry operator may optionally own some or all of the directory listing websites. If the TLD registry operator is not the owner of the directory listing website, optionally the owner of the domain name for the participating directory listing website may also have to adhere to and utilize the directory listing website templates provided by the TASS or TLD registry operator in order to participate in the TLD Specific Search System.

TLD Specific SMS Website Search:

Optionally, the search system described above may be configured to additionally process queries received via a short message service, such as SMS or MMS. Thus, for example, if the search system receives a short text message that includes a domain keyword, top level domain, and/or a second level domain. In response, the search system identifies and returns a website link or links via the short text service that associate website(s) within TLD specific namespaces. As similarly discussed above, the search system may also organize “Brand Name” website types and “keyword directory” website types for generic keyword terms. This process may be executed by querying registered websites that exist within a specific TLD database. For example, the end-user can enter the keywords “plumbers” and “Qpon” in the SMS message via an SMS interface presented via a user mobile device. The system receives the text message, including the keywords, and identifies and returns to the user device links to websites that match the keywords within that TLD environment. In this example, the system may identify and transmit to the end-user device links for “plumbers.Qpon”, ‘plumbing.Qpon”, “Joesplumbing.Qpon”, “LAplumbing.Qpon” and/or other websites that are in the .Qpon TLD namespace that are relevant to the second level domain keyword, or are registered as an associated second level domain group of that domain keyword, such as “plumbers” and “plumbing”.

If the website is a “Brand Name” website, then the search system may respond to the SMS search query by additionally identifying website addresses for brands that meet the search criteria within the closest zip code first or within specified zip code/location settings the user has specified in their settings. If the website is a “keyword directory” website type, then the link returned by the search system may be zip code specific, such as “plumbers.Qpon/90046”, which, when activated causes the user's browser to load the webpage with a directory listing of the brand name websites for plumbers in that zip code and, if the user specified a range around the zip code or the user's current location, may include plumbers in that range. Optionally, the search system may provide a link to a mapping system which the user may activate to obtain directions to a selected plumber listing.

By way of further example, if the user selects a TLD specific brand name listing from that keyword directory, the user's browser may load the webpage for the coupon website for the brand name (e.g., BrandName.Qpon) website on the user's device (e.g., a mobile device, such as a phone, or a non-mobile browser-equipped device). Because the websites are registered with the search system, and have specified a website type, (e.g. “Brand Name” or “Keyword Directory”), this process for a TLD specific website search provides an efficient technique for locating specific websites within a specific TLD focus or TLD theme that can help the user quickly find what the user is searching for.

The foregoing techniques may be applied to any TLD. For example, if the user texted “sports” and “shoes”, the search system may receive the text, identify relevant links for one or more keyword directories (e.g., a keyword directory, such as “sports.shoes” and/or a brand name website(s), such as “SportsBrand.shoes”), and transmit the links via SMS (or other messaging service, such as MMS) to the user device. The website links may be transmitted with a user viewable indication (e.g., text or an icon) of the website type for each link (e.g., keyword directory or a brand name website(s)) in the message, to enable the user to better determine whether the user wishes to activate the link.

Optionally, the user may be able to perform a more refined search by specifying the desired website type(s) and/or whether the response such include links to affiliated or certified websites, as illustrated in the following examples, and the search system will accordingly identify provide search results that correspond to the user-specified website type.

By way of example, the user may enter the following query: “Brand Name”-“AcmeBrands”-“Affiliated”. The search system receives the query and identifies and returns affiliated websites for the brand name “AcmeBrands” such as “AcmeBrands.com”, “AcmeBrands.sports”, “AcmeBrands.football” and other affiliated websites for AcmeBrands. The search system may also be configured to automatically recognize “AcmeBrands” as a brand name so the end-user may just query the keywords “AcmeBrands”-“Affiliated”, without having to manually specify that AcmeBrands is a brand name.

By way of further example, the end-user may enter the following query: “Brand Name”-“AcmeBrands”-“certified websites”; the search system receives the query and identifies and returns website links for websites registered with the system as AcmeBrands's certified websites, optionally according to the order that the brand owner of AcmeBrands specified and recorded with the search system and optionally based on the proximity to the user or to a user specified location.

By way of further example, the user may enter the following query: “Brand Name”-“AcmeBrands”-“Social Networks”; the search system receives the query and identifies and returns website links for the TLDs that are registered with the search system as AcmeBrands's Social Networks, optionally according to the order that the brand owner of AcmeBrands specified and recorded with the search system.

By way of additional example, the end-user may enter the following query: “keyword directory”-“Sports”-“Save”; the search system receives the query and identifies and returns website links for keyword directories within the .Save TLD namespace, such as “sports.save” and/or “LAsports.save” and “golfsports.save”. Optionally, the user device may provide user location information to the search system (e.g., via GPS, tower, or WiFi location services), and the search system utilizes such user location information to identify and return search results in a specified range of the user's location (e.g., “sports.save/90210”).

By way of yet further example, the user may enter the following query: “keyword directory”-“Sports”-“Coupon sites”; the search system receives the query and identifies and returns website links for keyword directories within a TLD “Keyword Group Association” or “KGA” for sports coupon-related TLDs, such as “sports.save”, “sports.deal”, “sports.Qpon”, “sports.bargains,” etc. Choosing specific keyword group associations may enable the user end-user to efficiently refine their search criteria for TLDs that are registered in the same group of a TLD theme.

By way of yet further example, the user may enter the following query: “Brand Name”-“AcmeBrands”-“Coupon sites”; the search system receives the query and identifies and returns website links for all of AcmeBrands's TLD specific websites within the Keyword Group Associations for its coupon related TLDs such as “AcmeBrands.save”, “AcmeBrands.deal”, “AcmeBrands.Qpon” and “AcmeBrands.bargains”, etc. Choosing specific Keyword Group Associations may enable the user to efficiently refine the user's search criteria for the brand names as organized into their TLD folders, which are in the same group of a TLD theme. In addition, because, in this example, the AcmeBrands.com website was registered with the “Industry Type” of a “coupon website” when registering with the search system, the search system may also optionally provide the search result for AcmeBrands in the search results as a website that was registered in the system as a coupon site even though the .com TLD was not part of the Keyword Group Association for the coupon site TLD group. The search system may have performed a website certification process to ensure the appropriate Industry Type was chosen by AcmeBrands (and other websites).

By way of still further example, the user may enter the following query: “keyword directory”-“Sports”-“All TLDs”; the search system receives the query and identifies and returns website links for keyword directories having sports as a second level domain for all the registered TLDs, such as “sports.save”, “sports.shoes”, golfsports.shoes”, “sports.football”, etc. Although choosing specific TLDs or TLD groups may provide leaner and more focused search results, searching for All TLDs will result in a greater number of entries in the search results, providing the user with more options to pick from.

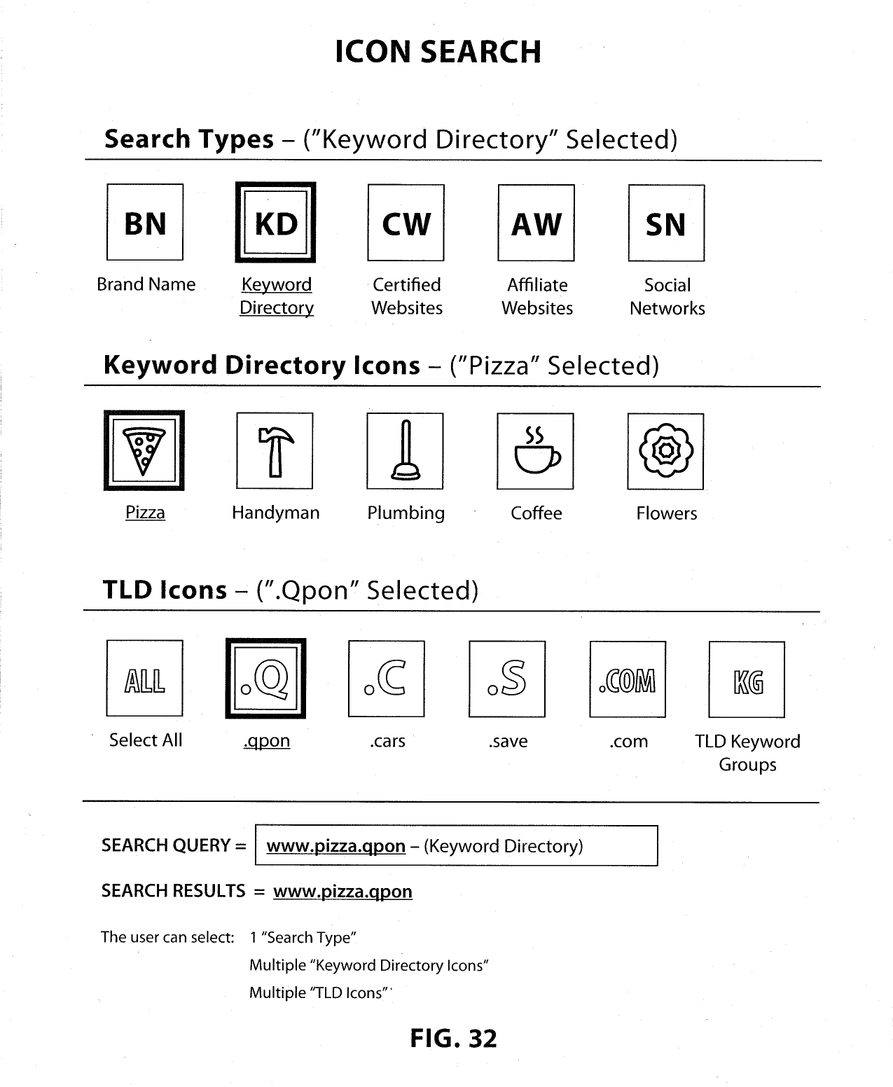

By way of further example and with reference to the example user interface illustrated in FIG. 32, the user may be provided an “Icon Search” user interface (e.g., via a search webpage, app interface, an SMS keyboard, or otherwise) in which the user would be provided icons similar to emoji icons, but instead of an emoji, there may be icons that represent the keyword specification of a keyword directory, a brand name, affiliated websites, social networks, keyword group association, etc., to enable the user to input the keyword specification without having to type in the full word in the field. Thus, a search query may optionally include a combination of icons and text, or just icons, or just text. The user terminal and/or a search engine may translate the icons into corresponding text to generate a textual search query. The search query would be received from a user terminal by a search engine (which may be included in the system or which may be a third party search engine), which optionally translates the icons to corresponding text or otherwise interpret the icons (if such translation was not performed on the user terminal), identify matches, and return the matches in search results to the user terminal. As illustrated in FIG. 32, the icons may optionally be categorized according to search type icons (e.g., brand name, keyword directory, affiliate websites, social networks, certified websites, etc.), keyword directory icons (e.g., pizza, handyman, plumbing, coffee, flowers, memorials, clothing, restaurants, etc.), TLD icons (e.g., select all, .qpon, .coupon, .cars, .save, .com, .shoes, .travel, .clothing, TLD keyword groups, etc.). For example, the user may select the keyword directory icon and then type “pizza”, and the search engine would locate and return in the search results links to keyword directories for pizza registered in the system. By way of further example, the user may select the TLD icon(s), and the search engine will identify and return to the user terminal search results specific to the selected TLDs.

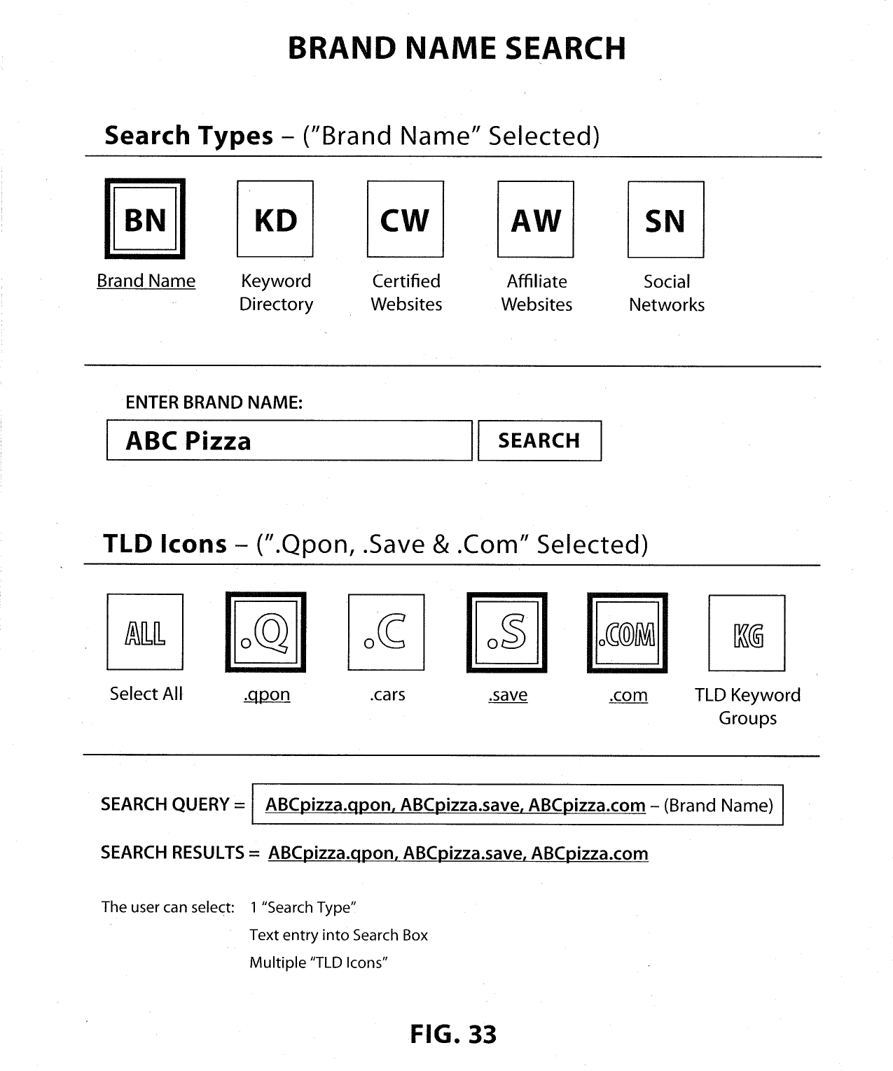

By way of further example and as illustrated in FIG. 33, the user may select a brand name icon and the user interface may prompt the user to enter the brand name into a brand name field. The user may then manually enter the brand name into the brand name field (e.g., ABC Pizza). The user may select one or more of the TLD icons, such as the icon “.Q” for the .Qpon TLD, the icon “.S” for the .Save TLD, and the icon “.Com” for the .Com TLD. The user terminal translates the icons into a text search query, and the text search query is displayed via the user interface (e.g., in a search query field). The system receives the text query and returns the ABCPizza.Qpon, ABCPizza.Save, and ABCPizza.com links. Optionally, there may be an icon of a pizza slice, which would represent the pizza keyword, and so the user could enter the keyword directory icon, the pizza icon, the Qpon TLD icon and receive the link for the keyword directory Pizza.Qpon. The user may be permitted to use all icons or a combination of both icons and typing in text.

Because registering websites will specify their “website types” in the search system, even social networks may benefit from, as an internal search within their system may reference a profile in their social network as a Brand Name or a keyword directory which may be helpful sort features when the website owners are promoting their brand name or keyword directory. For example, if the owner of the domain “pizza.deal” had a social network page for their keyword directory at AcmeSocialNetworkSite.com/pizzadeal, the social network site may, via an API, enable the TASS to initiate brand name and keyword directory searches across the social network environment. Because third party domain owners may own many of the keyword directories in the system, the third party domain owners may also be promoting their website to generate traffic to it as it can be a very profitable business.

Industry Types & Keywords:

As similarly discussed above, when brand name websites are registering with the search system, a registrar, a TLD registry, or the system operator, certain information may be collected and stored. Examples of such information may include industry type and associated keywords. This information is used by the search system to determine the purpose or focus of the website, and the products and services offered by the website, enabling the system to accurately post a brand name website, automatically or manually, to a keyword directory website associated with the selected industry type or keywords that are relevant to their products, services or brand. This information can also be used for the system to create and suggest online marketing plans across a plurality of keyword directory websites that exist in a specified TLD or other TLD namespaces. Additionally, the system may suggest domain names or TLDs to the brand owner that may be beneficial for the brand name to register to thereby enable posting to those TLD specific keyword directory websites. Posting to multiple associated keyword directory websites may be beneficial for the brand name as it may increase the online exposure and brand awareness for the brand name.

The search system may optionally identify and suggest to the brand name owner a possible keyword directory website based on an analysis of the keywords selected by the brand name owner. In addition, the search system may optionally identify a keyword directory website group that relates to the second level domain (the label on the left side of the period character in the domain name) or top level domain (the label on the right side of the period character in the domain name). For example, if the brand name owner selected “Restaurant” as an industry type, and “delivery” as a keyword associated with the brand owner's website services, the search system may suggest a domain registration in those TLDs, including the keyword directory website for restaurant.delivery and/or delivery.restaurant. An example registration user interface is illustrated in FIG. 23.

Non-limiting examples of keywords are as follows:

Accountant:
Business
Personal
Book keeping
Tax

Advertising:
Billboards
Direct mail
Flyers
Email
Print
Online
Newspapers
Radio
Signage
Social Media
TV

Apartments:
For Sale
For Rent
Sublease

Appliances:
Bathroom
Home
Kitchen
Laundry
Sola

Art:
Abstract
Botanical
Clay
Collectibles
Craft
Contemporary
Decorative
Digital
Drawings
Fine
Framing
Landscape
Paintings
Performing
Photography
Prints
Sculpture
Vintage
Web Design

Attorneys:
Adoption
Asset protection
Business
Bankruptcy
Commercial
Contract
Corporate
Criminal
Domestic
DUI
Drugs
Entertainment
Estate Planning
Divorce
Family
General
Litigation
Tax
Traffic
Other

Automotive:
Body shop
Brakes
Cars—New
Cars—Used
Cars—Lease
Car rental
Car wash
Detailing
Junkyard
Maintenance
Muffler shop
Oil change
Painting
Parts—New
Parts—Used
Restoration
Smog Check
Storage
Transport
Tires
Tune up
Upholstery

Baby:
Beds
Books
Clothing
Diapers
Food
Furniture
Monitors
Pictures
Safety
Showers
Shoes
Sitters
Strollers
Toys

Beauty:
Bath & Body
Beauty Products
Fragrance
Hair Care
Hair Salons
Make up
Nail Salons

Books:
Downloadable
e-books
Paperback
Hard cover

Clubs:
Afterhours
Bars
Billiards
Bottle Service
Comedy
Elite
Nightclub

Cigarettes:
Accessories
Cigars
Discount
E-cigs
Herbal
Hookahs
Pipes
Smoke shop
Tobacco
Vaporizers

Coffee:
Coffee beans
Coffee shops
Gourmet
Ground Coffee

Coupon Codes:

Cruises:

Diet:
Books
Cookbooks
Foods
Pills
Plans
Tips
Videos

Doctors:
Dentist
Dermatologist
Family
Foot Doctor
General Practitioner
Gynecologist
Optometrist
Orthopedic
Pediatrician
Plastic Surgeon
Psychologist
Psychiatrist

Domains:

Drycleaners:

Electronics:
Accessories
Cameras
Camcorders
Car stereo
Cell phones
Computers
DVDs
GPS
Headphones
Home theater
Laptops
Smartphones
Smart TVs
Stereo
Surround sound
Tablets
TVs
Video

Entertainment:
Amusement Park
Bowling
Cinema
Comedy
Concerts
Dance
Go Carts
Golf
Miniature Golf
Movie Theatre
Music
Sports
Theatre
Water Park

Fitness:
Food
Health clubs
Supplements
Woman's Health clubs
Training

Flights:
Booking
Travel Agency

Flowers:
Anniversary
Birthday
Gift Baskets
Plants
Romance
Roses
Sympathy
Valentine's Day
Wedding

Furniture:
Antique
Bedroom
Couches
Dining Room
Indoor
Living Room
Outdoor
Patio
Recliners
Tables
Waterbeds

Games:
Bingo
Board
Card
Gambling
Video

Gaming:

Grocery:
Butcher
General Store
Health food
Mini mart
Pharmacy
Local
Late night
Superstore
Vegan
Wholesale

Healthcare:

Homes:
Escrow Services
For Sale
For Rent
Home supply
Mortgage
Remodeling
Security
Time share

Hotels:

Insurance:

Internet:
Broadband
Domains
ISP
Retail
VOIP
Other

Jewelry:
Anniversary
Bracelets
Costume
Custom
Diamonds
Engagement
Gems
Gold
Stones
Silver
Wedding
Rings

Limo:

Lingerie:

Liquor:

Massage:
Acupressure
Acupuncture
Chiropractic
Deep Tissue
On-location
Shiatsu
Sports
Swedish
Thai
Therapeutic

Med Spa:
Botox
Chemical Peel
Facial
Fillers
IPL
Juvederm
Laser Hair Removal
Massage
Photo Facial
Skin Tightening
Spray Tan
Teeth Whitening
Waxing

Motels:

Organic:
Food
Fruits/Vegetables
Lotions
Soap

Perfume:
Bath
Gift Sets
Lotions
Men's
Women's

Pets:
Adoption
Aquariums
Beds
Bird
Breeder
Cat food
Dog daycare
Dog hotel
Dog food
Exotics
Fish
Grooming
Meds
Organic products
Pet clothing
Pet costumes
Pet food
Reptiles
Supplies
Toys
Training
Treats
Veterinarian

Pharmacy:
Franchise
Hospital
Independent
Local
Online
24 hour

Plastic Surgery:
Arm Lift
Body lift
Body Contouring
Breast Augmentation
Breast Reduction
Buttock Augmentation
Chemical Peel
Cosmetic
Dermal Fillers
Facelift
Hair Replacement
Lipo
Med spa
Rhinoplasty
Reconstructive
Scar Revision
Skin Care
Tummy Tuck

Rentals:
Apartments
Boats
Cars
Electronics
Home
Jet skis
Motorcycles
Movies
Music
Tools
Water sports
Winter sports
Video games

Restaurants:
Asian
Burger joint
Café
Cajun
Chicken
Chinese
Deli
Diner
Fast food
Health
Italian
Mediterranean
Mexican
Organic
Pho
Pizza
Seafood
Steakhouse
Sushi
Thai
Vegan

Retail:
Boutique
Clothing
Department
On-line only
Men's
Men's suits
Shoes
Swimwear
Women's

Services:—Add to the Current Drop Down List
Air Conditioning & Heating
Air Duct Cleaning
Babysitter
Catering
Handyman
Landscaping
Maid
Pest Control
Water Delivery
Wedding Planner
Other

Shoes:
Athletic
Basketball
Cleats
Dress
Golf
Heels
Hiking
Loafers
Running
Sandals
Sneakers
Sports
Tennis
Men's
Women's

Sporting Goods:
Apparel
Athletic
Baseball
Basketball
Bowling
Football
Handball
Hockey
Racquetball
Shoes
Soccer
Tennis
Watersports
Winter Sports

Tanning:
Airbrush
Equipment
Red Light Therapy
Salon
Spray Tan
Sunless
Tanning beds
Tanning lotions
Tanning Products
UV
UV-free

Tattoo:
Artist
Artwork
Body Piercing
Dermal implants
Henna
Removal
Shop

Tickets:
Broadway
Concert
Events
Movie
Plays
Theatre
Shows
Vegas shows

Toys:
Adult
Baby
Boys
Educational
Girls
Kids
Pet

Travel:
Agency
Airfare
Attractions
Beach
Camping
Cottage
Entertainment
Exotic
Getaways
Hotels
Limo services
Shopping
Shuttle

Websites:
Development
Design
Hosting
Logo artwork
SEC)

Wedding:
Cakes
Catering
Ceremony
Chapel
Dresses
Gowns
Invitations
Photography
Planners
Tuxedos
Rentals
Shoes
Vendors

Wine:
Accessories
Beer
Champagnes
Wines
Wine coolers
Winery
Wine Tasting
Wholesale

Yoga:
Books
Class
Clothing
Instructional
Mats
Products

Smart Coupon Creator & Automatic Redemption Tool w/ POS Integration:

Conventionally, finding and redeeming coupons is often time consuming and inefficient, and often cause consumer frustration. Embodiments disclosed herein optionally enable coupons to be efficiently provided to users and/or to be automatically redeemed, optionally without any action by the consumer, and optionally without the user even knowing of the coupon prior to purchase of an item for which the coupon is applied.

Further, conventional point of sales (POS) systems are often limited, often isolated, and unable to adequately provide businesses with the technology needed to offer such a coupon solution to a multitude of non-affiliated businesses and their websites, and so cannot enable their consumers to benefit from the convenience of automatic coupon redemption.

A coupon creator and automatic redemption system with POS integration as described herein enables consumers to benefit from the convenience of automatic coupon redemption, optionally by communicating via a universal coupon language that can be translated for large numbers (e.g., for millions) of businesses' websites to integrate with participating POS systems, optionally utilizing only one custom API integration of each POS service as opposed to having to customize each individual business's internal POS system. For example, if the 10 most popular POS systems were used by 1 million non-affiliated businesses, only 10 API integrations may be needed as opposed to the tediousness and exorbitant cost of individual API integrations at each of the 1 million non-affiliated businesses.

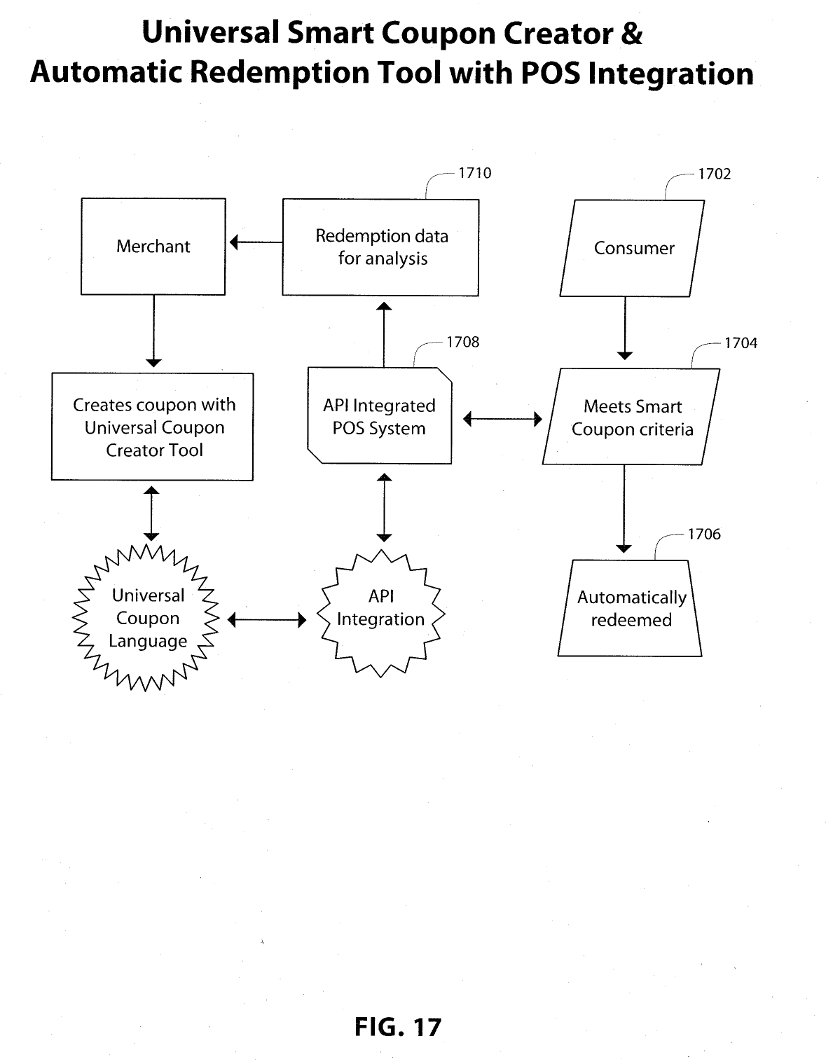

Optionally, the coupon creator and automatic redemption system (sometimes referred to herein as the “coupon system” or “coupon tool”) utilizes a universal coupon language to create customized smart digital coupons that adhere to specific coupon classes according to the universal coupon language. The coupon system may be configured to be integrated with and communicate through an API to the business's POS computer system, creating an automatic hands free redemption at the POS for a consumer who meets the smart coupon criteria. The foregoing process will be discussed in greater detail elsewhere herein with respect to FIG. 17.

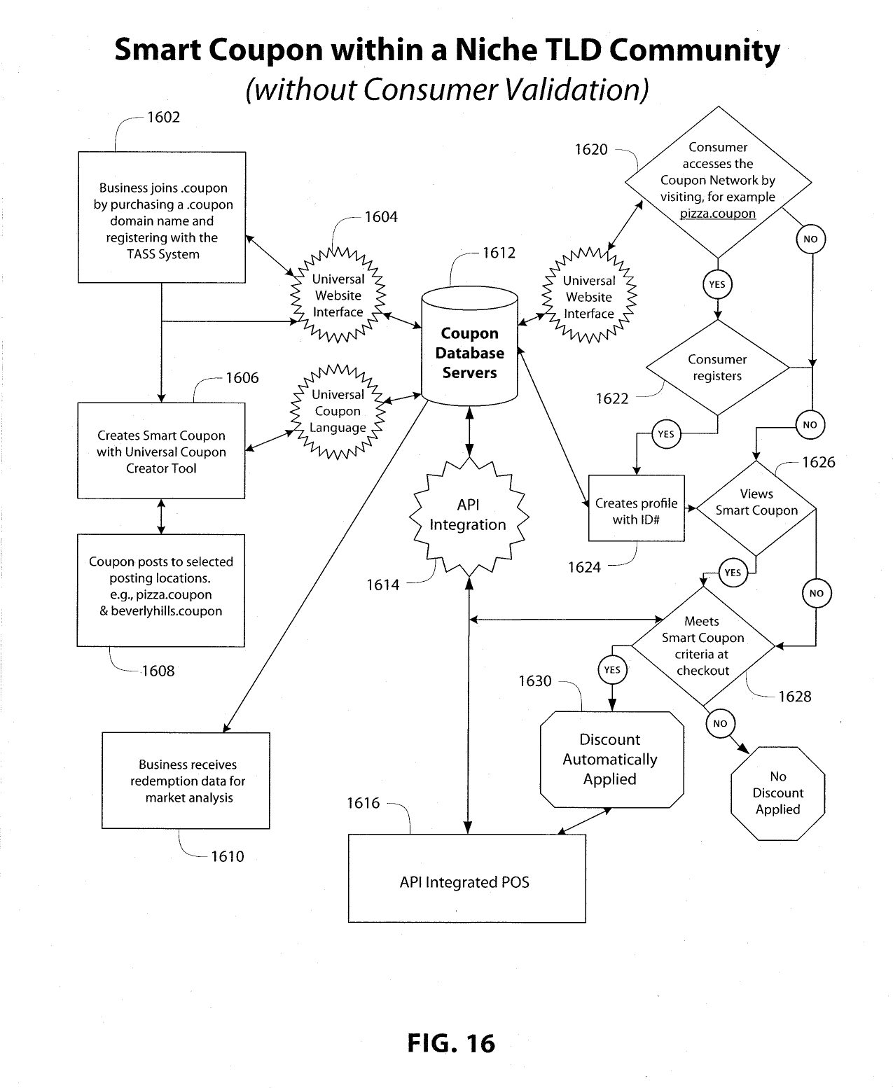

The digital coupons may be provided via website within a specific niche TLD environment such as .Qpon. This process is discussed in greater detail elsewhere herein with reference to FIG. 16.

The API can integrate with existing online POS systems, providing a seamless process for businesses to participate within a coupon community, optionally regardless whether they are exclusively online stores, “click-and-mortar” businesses, or exclusively physical retail locations.

The coupon system, hosting a coupon creator tool, may enable a coupon designer (e.g., an owner of a business, such as of a retail establishment or a product manufacturer) to design different types and classes of coupons via a user interface enabling the coupon designer to enter custom criteria. For example, the coupon system may enable the design to specify a coupon that specifies that if a consumer purchases Product A (e.g., a hamburger) and Product B (e.g., fries), then Product C (e.g., a large lemonade) is free. Such a coupon may fall within the Purchase Bonus (PB) coupon class as described below.

Several non-limiting example coupon classes will now be described.

(BO): BOGO Coupons=Buy one, get one free

(SD): Straight Discount=A particular product with a serial number identifier and a correlating Discount Amount

(PB): Purchase Bonus=If a consumer purchases a specified number of one type of product, this coupon entitles the user to receive another product for free or at a discounted price.

(SG): Spend Get=Spend a specified amount, receive a: discount of a specified amount or specified percent, or receive a free product, or a refund

(MPQ): Minimum Product Qualifier=Buy a specified number of the same product and receive a bulk price discount ($1.25 if purchase singly, $3 for 3).

When the coupon designer submits the coupon specification, the coupon is posted on online locations (e.g., the business's website(s) or multiple websites and/or directories, or on an advertising network) specified as posting locations via the coupon system (e.g., in order to reach as many targeted consumers as possible). In addition, the coupon system may also transmit the coupon specification information via a network (e.g., the Internet) via the API to the POS computer system. For example, the coupon information may indicate the coupon type and the coupon parameters (e.g., the benefit (e.g., fixed or percentage discount, fixed or percentage bulk discount, free product, etc.), provided to the consumer by the coupon, and the purchases the consumer needs to make in other to utilize the coupon). The POS computer system may utilize the information to configure and recognize the specified coupon criteria and automatically deduct the appropriate discount at the POS computer system, with redemption and customer data being stored for market analysis.

The business may have a website which is part of a niche TLD environment, such as at webpages associated with a coupon TLD (e.g., .Qpon), enabling consumers to easily find the business's coupons on a dedicated webpage. The coupon system may be integrated with a TLD community of businesses, enabling integration of the TLD registry-provided software and the POS computer systems that may work universally some or all of the namespace of that specific niche TLD or the namespaces of multiple participating TLDs sharing the same niche (e.g., .Qpon, .Offers, .Savings, .Deals, etc.).

Optionally, the coupon system may be configured to transmit coupon-related alerts to consumers who are registered with a corresponding business website or participating niche TLD environment, informing the consumer of various coupon terms and corresponding value discounts. The alerts may be transmitted in response to an instruction provided by the business, the alerts may automatically be transmitted upon creation of the coupon(s), or the alerts may be transmitted in batches at a predetermined time or pushed to consumers' mobile devices when they are in the proximity of the business offering the coupon using NFC (Near Field Communication) or other communication techniques.

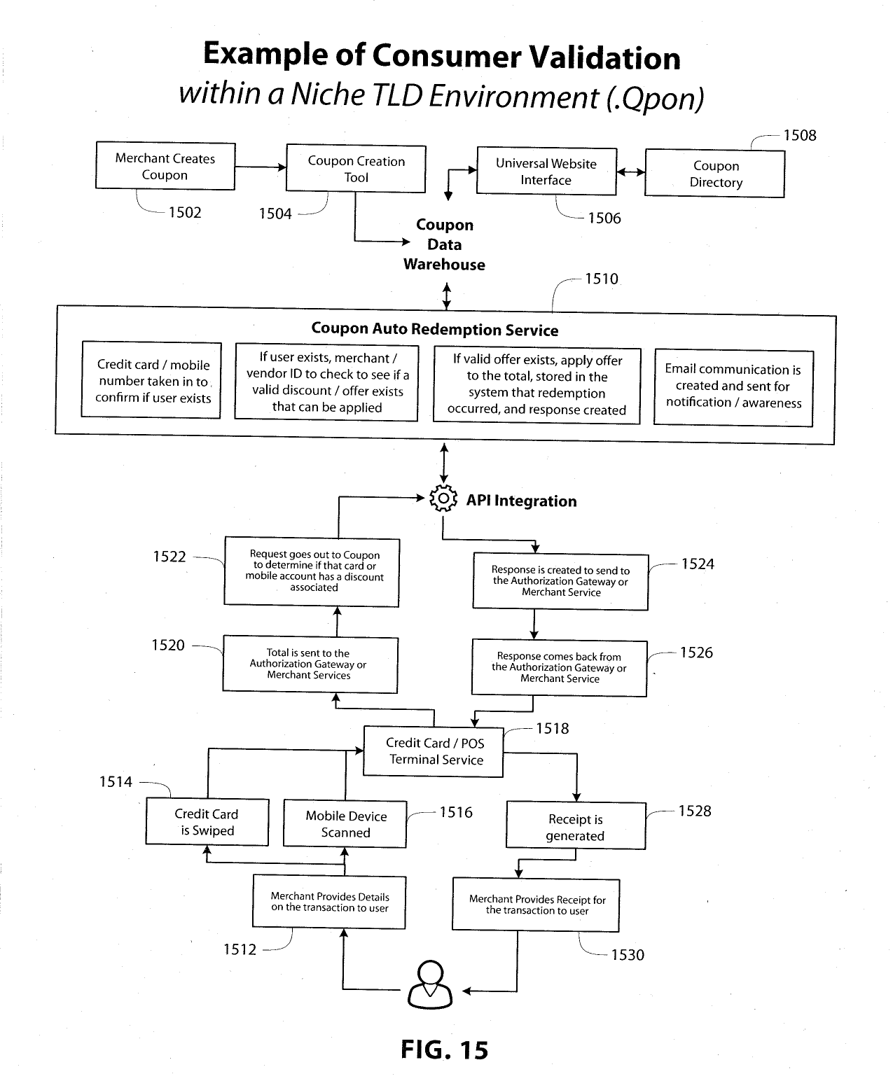

Optionally, a niche TLD registry operator may manage a coupon community, enabling the creation and distribution of coupons within a large network of non-affiliated businesses and registered consumers. Hands free redemption may be performed by registering the consumer's phone number or other identifier (e.g., a credit card number, reward card number, or QR code) to enable the customer to be a member of a coupon club or a participating niche TLD community. When the consumer enters their identifier via an interface of the API integrated POS computer system, the POS computer system recognizes the consumer's eligibility for specific coupon classes created by the business (e.g., via a coupon creator tool hosted by the coupon system). For example, the POS computer system may cross-reference and validate the registered consumer's eligibility to receive the specified offer such as a BOGO (Buy One Get One free) coupon. Upon validation of the consumer as being a registered member of a participating community, the appropriate coupon savings are automatically deducted by the POS computer system, eliminating the necessity for a consumer to present physical proof of a coupon. Thus, a user registered within the participating community may automatically be eligible for corresponding coupons, and the POS computer system may automatically deduct the appropriate amount. This process is discussed in greater detail herein with reference to FIG. 15.

If the consumer identifier discussed above is a credit card registered by the consumer, and the credit card is used by the consumer at the API integrated POS computer system (e.g., to pay for a purchase), the POS computer system validates the consumer as a registered member of the coupon community and applies the coupon savings or enables the savings to be refunded via a credit to the credit card at a later date.

If the consumer identifier discussed above is a QR code (e.g., generated for the consumer and stored in the consumer's account upon registration), and the QR code is presented by the consumer's mobile device (e.g., displayed on the mobile device's display) the API integrated POS optically scans the QR code using an optical scanner (e.g., a camera, dedicated barcode reader, etc.) to validate the consumer as a registered member of the coupon community. If the consumer is validated as a registered member of the coupon community, the POS system applies the coupon savings or enables the savings to be refunded via a credit to the credit card at a later date.

As noted above, the consumer identifier used for validation may be a credit card number or a rewards card number. The credit card or rewards card may optionally be issued by the coupon community (e.g., a .Qpon rewards card, a .Qpon branded Visa Card, etc.).

Optionally, the API integrated POS computer system may be configured to receive the consumer identifier and/or payment information from the user's mobile device (e.g., via NFC). Optionally, the coupon system provides businesses with the option of designating a given coupon as a coupon which will be integrated with the business's POS system and automatically redeemed by consumers or as a conventional coupon to be physically presented by consumers for redemption.

Thus, the foregoing system and process reduces the time-consuming conventional step of hunting for and manually selecting coupons.

Manufacturers may also be provided the capability of creating digital coupons as similarly discussed above (e.g., BOGO 6-pack of Lemonade) with the coupon system and electronically submitting the coupons to participating retailers for distribution via the retailer's website (e.g., AcmeRetailer.com, AcmeRetailer.QPON, etc.) or otherwise. The coupon system may add the coupon to an electronic folder of the manufacturer or a webpage dedicated to that particular manufacturer on the retailer's business website. The digital coupon may be transmitted using the universal coupon language to the retailer's API integrated POS, optionally including information such as an identifier identifying the coupon issuer (e.g., a manufacturer identifier), enabling the coupons to be redeemed at the retailer's POS system. The POS system may transmit redemption data and customer data for the customer for whom the coupon is being redeemed to the retailer and/or the manufacturer systems to enable the appropriate coupon reimbursement by the manufacturer to the retailer and/or for market analysis.

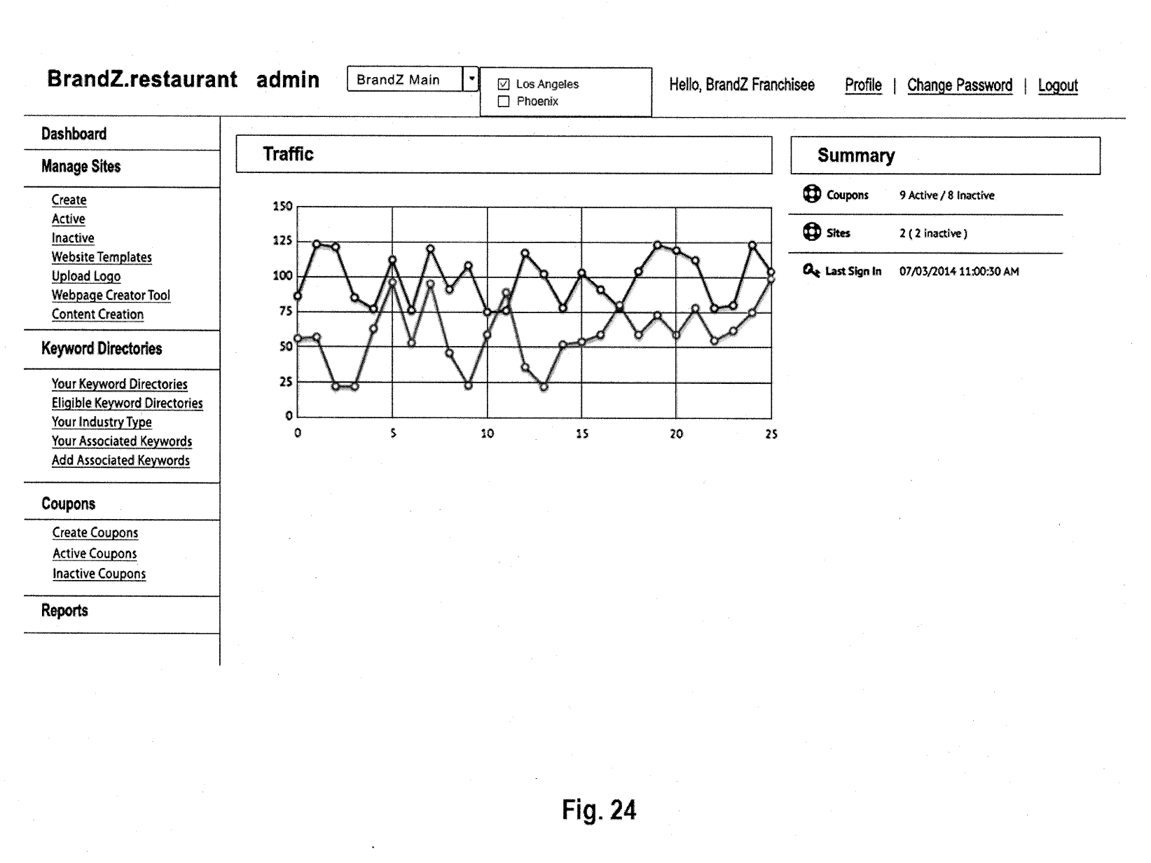

FIG. 24 illustrates an example analytics report which may be generated by an analytics system and provided as part of an administration user interface. The analytics report user interface may indicate how many active and inactive coupons a business has, how many physical sites and/or websites the business has, how much redemption traffic the business in experiencing for different coupon types over time, etc. If the business has more than one site, the analytics system may optionally provide separate reports for each site, and may optionally provide an aggregate report for multiple selected sites or for all sites.

This coupon system and the utilization of the universal coupon language provide a simpler, more efficient process for the redemption of manufacturers' coupons by smaller retailers. For example, the LemonadeBrand 6 pack BOGO smart coupon may be programmed to be redeemable at a participating convenience store or other smaller store that carries the LemonadeBrand product. A smart coupon request may be transmitted to a coupon website (e.g., XYZconveniencestore.Qpon), which has an interface for receiving such smart coupon requests. The XYZconveniencestore system receives and accepts the request, and creates a corresponding manufacturer's folder on the small retailer's website. The interface for receiving such smart coupon requests may be provided by the niche TLD registry managing the specific niche TLD (e.g., .Qpon) community. This process enables the hands free redemption of any manufacturer's smart coupon at a retailer that agrees to add that manufacturer to their network of manufacturers within the corresponding niche TLD community.

Optionally, the retailer may need or want to manually accept the initial manufacturer's request once for each particular product, with each product having a unique product identifier, and for subsequent requests the retailer system may automatically accept smart coupon requests with the product identifier from the manufacturer. Thus, the system may record an initial manual acceptance, and then based on the initial manual acceptance determine whether to accept smart coupon requests with the same product identifier from the manufacturer

While certain examples herein may refer to manufacturers and manufacturer coupons, it is understood that the foregoing processes may be utilized by other entities, such as product distributors by way of further example.

Optionally, the smart coupon issuer can instruct the coupon system or other system to provide a code to the consumer that is printed on the consumer's receipt at the API integrated POS. The generated code identifies that particular transaction and enables the consumer to access the transactional details and coupon-related savings from within their consumer account (where such transactional details and coupon-related savings information may be received and maintained on the coupon issuer system, the retailer system, participating niche TLD community system, or other system, and which may be accessed via a website). Thus, optionally instead of receiving the savings automatically at the POS system, the consumer may access their account from the appropriate system, and enter the provided code for smart coupon redemption, and the coupon may then be applied by the system to the consumer's purchase. Optionally, if the consumer is not yet registered and so does not yet have an account, the consumer may navigate to the smart coupon issuing business's webpage (whose URL is optionally printed on the receipt provided to the consumer), and enter the code to redeem their savings.

A consumer without a registered account may be encouraged to register and create his or her own consumer account, however, optionally a consumer account is required in order to redeem a coupon. The coupon system enables the business creating the smart coupon to specify various options for redemption by the consumer. For example, the coupon may entitle the consumer to a voucher towards a future purchase, an automatic credit to the credit card used in that particular transaction, a credit applied to the business's rewards program, and/or a universal rewards program reward for a rewards program of which several businesses are members, which may be particular convenient for small businesses who do not have their own private rewards program. Such a universal rewards program may be administered as an additional service provided by the corresponding niche TLD registry operator.

Further, such consumer registration encourages more consumer interaction within the participating coupon community, which may be beneficial for the community as a whole.

As similarly discuss above, conventional search engines often require consumer to hunt for relevant coupons. Embodiments described herein enable the coupon “to find” the consumer, which is much more convenient for the consumer, and does not suffer from the drawbacks of conventional coupons. For example, with conventional coupons a user may forget a coupon, lose a coupon, be unable to print a coupon (if the coupon is meant to be downloaded and printed), or the store may have difficulty scanning the coupon (e.g., if the coupon is an electronic coupon displayed on the consumer's phone). In addition, a consumer may be unwilling to use a coupon under certain situations (e.g., if the consumer is on a date and does not want to look cheap by using a coupon for dinner). Further, as noted above, the effort of locating a coupon may often not be worth the amount saved by using the coupon. The smart coupon may not suffer from any or one or more of the foregoing drawbacks, and may thus offer significant benefits to consumers.

In addition, businesses may benefit from the distribution to and redemption by consumers of smart coupons. For example, real-time data may be provided to businesses for market analysis and inventory management. Such real-time data may include the number and types of items purchased, when and where items were purchased, what coupons were used in the purchase, and/or information regarding the purchaser. Further, the user of smart coupons may drive additional consumer traffic to the business's physical and online stores and may enhance customer retention and loyalty. Further, manpower is reduced as cashiers may not need any or little training to redeem coupons and may not need to spend time and effort on redeeming coupons.

The utilization of the website interface and coupon language discussed elsewhere herein enables the translation of coupons and coupon related information into a common language which may be transmitted to, and used by businesses, enabling the businesses to access such coupons via their API integrated POS system. Further, participation within a “coupon community,” such as a niche TLD environment (e.g., .Qpon), which provides a consistent presentation of content through niche-specific templates and management of said community, provides the desirable uniformity and conformity to a coupon language that enables a wide variety of large and small businesses to create customizable coupons using the coupon system and to seamlessly communicate with their API integrated POS for purposes of coupon redemption data, consumer data, market analysis, etc.

Optionally, the API integrated POS recognizes a consumer's mobile device that has been registered (e.g., within the coupon community, such as a niche TLD environment, or registered directly with the business's participating website such as business.Qpon) and syncs with and transmits over a wireless interface smart coupons to the consumer's mobile device (e.g., at or within the proximity of the POS terminal). The coupons and related push notification may be transmitted for display on an application (an “app”) hosted on the consumer's mobile device while at a retail location (where the consumer's presence at the retail location may be determined using geo-fencing). Further, the wireless communication between the API integrated POS and the consumer's registered mobile device may be used to validate that the consumer is a registered member within the participating coupon community and to automatically apply the smart coupon discount when the smart coupon criteria has been met, without the need for the consumer to manually enter their identifier number.

FIG. 15 illustrates an example consumer validation process, where the user does not have to provide a coupon, and instead, the system determines whether there is a coupon/discount applicable to the user and the user purchase, and then automatically applies the coupon/discount without the user having to take any action and where the user may not even be aware of the coupon/discount prior to the application of the coupon/discount.

Referring to the example process illustrated in FIG. 15, at block 1502 a merchant initiates the creation of a coupon. At block 1504, the merchant accesses the coupon creation tool via the coupon system and creates a digital smart coupon, which may be stored in a data store. At block 1506, a website interface communications with a coupon directory 1508 and with the data store. A user may register to open an account with the coupon system. The user's account record may be stored in the data store. The user may select or be provided with an account identifier (e.g., the account identifier may be transmitted to a mobile device of the user and/or the user may be provided with a physical account card).

At block 1512, a user initiates a purchase, and the merchant may provide the user with transaction details (e.g., the amount of the purchase), which may be displayed on a point of sale terminal (POS) display to the user. At block 1514 and/or 1516, the user's payment instrument is input (e.g., the user's credit card is read or a payment instrument on the user's mobile device is scanned to obtain a user identifier). A credit card/POS terminal service 1518 transmits the purchase amount, merchant identifier, credit card information and/or other user identifier to an authorization gateway or merchant services system 1520. At block 1522, the purchase information, merchant identifier, credit card number and/or other user identifier is transmitted to the coupon system via an API to determine, via a coupon auto-redemption service 1510 if the user credit card or account is entitled to a discount (e.g., a smart coupon). The coupon auto-redemption service 1510 determines if the user has an account. If the user has an account, the coupon auto-redemption service 1510 determines, using the merchant identifier, whether there is a valid, non-expired discount/coupon for the merchant. If there is a valid discount/coupon to which the user is entitled, the discount is applied to the purchase, and a corresponding record is stored in the user and/or merchant account records. Optionally, a communication (e.g., an SMS, MMS, and/or email) is generated and transmitted to the user mobile device, informing the user of the discount and creating additional user awareness of the benefits of the coupon service. A confirmation communication may also be transmitted to the merchant.

At block 1524, a response is created and transmitted to the authorization gateway or merchant service. The response may include the regular response codes from the gateway, as well as a coupon discount response that indicates to the POS terminal that the discount was applied. At block 1526, the response is received from the authorization gateway or merchant system, and is provided to the credit card/POS terminal service 1518 which may be hosted by the POS terminal or a POS system. At block 1528, the POS terminal generates a receipt, indicating that the discount was applied and the amount of the discount. At block 1530, the receipt is provided to the user.

Referring to FIG. 16, another example coupon-related process is illustrated. In this example process, the user is aware of the coupon prior to application to a purchase, and the coupon the coupon criteria and details (e.g., the coupon benefit and the criteria that needs to be meet in order for the coupon to be applied to a purchase) may be provided for display to the user (e.g., on a user mobile device, such as a smart phone). At block 1602, a business joins a coupon system by purchasing a coupon domain within a coupon-specific TLD (e.g., a .Coupon domain) and by registering with a TLD registry operator. A record regarding the purchase may be transmitted over a website interface 1604 to the database server associated with the coupon-specific TLD. At block 1606, the business creates a smart coupon using the coupon creator tool. The coupon is implemented using a coupon language and transmitted to the coupon database server. At block 1608, the coupon is posted to various locations, such as a variety of appropriate keyword and location directories.

At block 1620, a user accesses the coupon network (e.g., by accessing one of the keyword or location directories). At block 1622, a determination is made as to whether the user wants to register with the coupon system. If the user does want to register, at block 1624, the coupon system receives user registration information (e.g., name, email address, SMS address, physical address, etc.), generates and/or stores an identifier for the user, and creates and stores a user account record. At block 1626, coupons are provided to the user device for display to the user. At block 1628, the user makes a purchase and attempts to apply the coupon. A determination is made as to whether the purchase is qualified for application of the coupon. If the purchase is qualified, at block 1630, the discount is automatically applied, and the discounted total is displayed via the POS terminal and optionally a receipt indicating the discount is printed and provided to the user. If the purchase is not qualified, no discount is applied. Redemption data may be transmitted to the business's system for analysis.

FIG. 17 illustrates an example process of creating and redeeming a smart coupon using automatic redemption. As illustrated in FIG. 17, at block 1700, a merchant (or other entity) creates a coupon using the coupon creation tool (e.g., hosted by the coupon system). The coupon may be defined using a universal coupon language (or other language), and may be made available to the API integrated POS system 1708 via the API.

When a consumer 1702 wishes to make a purchase, the consumer provides a coupon obtained by the consumer (e.g., via a website, download, app, or otherwise) to the API integrated POS system 1708 which may read information from the coupon (e.g., by optically scanning a code on the coupon or otherwise). A determination is made at block 1704 as to whether the purchase meets the coupon criteria for utilization of the coupon (e.g., whether the user is purchasing an eligible product, a sufficient amount of eligible products, whether the purchase is being made prior to expiration of the coupon, etc.). The coupon eligibility determination may be made by the API integrated POS system 1708 using information read from the coupon and optionally information provided by the coupon system or merchant system (which may be the same system or which may be separate systems operated by different entities). Optionally, the API integrated POS system 1708 transmits the information obtained from the coupon to the coupon system or merchant system for validation. If the purchase meets the coupon criteria, at block 1706 the coupon is automatically applied to the purchase and the user is provided with the coupon benefit (e.g., a discount, etc.). At block 1710, coupon redemption information (e.g., which coupon was applied, the dollar amount of the discount, what item purchase was the coupon applied to, at what store was the coupon presented, the date and time of the purchase, etc.), is transmitted to the merchant system for analysis.

Thus, the systems and methods described herein may offer some or all of the benefits described herein and may provide useful solutions for the end-user, the TLD registries, and the brand name websites.

Each of the patents, patent applications and other documents cited herein is hereby expressly incorporated by reference in its entirety.

Depending on the embodiment, certain acts, events, or functions of any of the processes or algorithms described herein can be performed in a different sequence, can be added, merged, or left out altogether (e.g., not all described operations or events are necessary for the practice of the algorithm). Moreover, in certain embodiments, operations or events can be performed concurrently, e.g., through multi-threaded processing, interrupt processing, or multiple processors or processor cores or on other parallel architectures, rather than sequentially.

The various illustrative logical blocks, modules, routines, and algorithm steps described in connection with the embodiments disclosed herein can be implemented as electronic hardware, computer software, or combinations of both. To clearly illustrate this interchangeability of hardware and software, various illustrative components, blocks, modules, and steps have been described above generally in terms of their functionality. Whether such functionality is implemented as hardware or software depends upon the particular application and design constraints imposed on the overall system. The described functionality can be implemented in varying ways for each particular application, but such implementation decisions should not be interpreted as causing a departure from the scope of the disclosure.

Moreover, the various illustrative logical blocks and modules described in connection with the embodiments disclosed herein can be implemented or performed by a machine, such as a general purpose processor device, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor device can be a microprocessor, but in the alternative, the processor device can be a controller, microcontroller, or state machine, combinations of the same, or the like. A processor device can include electrical circuitry configured to process computer-executable instructions. In another embodiment, a processor device includes an FPGA or other programmable device that performs logic operations without processing computer-executable instructions. A processor device can also be implemented as a combination of computing devices, e.g., a combination of a DSP and a microprocessor, a plurality of microprocessors, one or more microprocessors in conjunction with a DSP core, or any other such configuration. Although described herein primarily with respect to digital technology, a processor device may also include primarily analog components. A computing environment can include any type of computer system, including, but not limited to, a computer system based on a microprocessor, a mainframe computer, a digital signal processor, a portable computing device, a device controller, or a computational engine within an appliance, to name a few.

The elements of a method, process, routine, or algorithm described in connection with the embodiments disclosed herein can be embodied directly in hardware, in a software module executed by a processor device, or in a combination of the two. A software module can reside in RAM memory, flash memory, ROM memory, EPROM memory, EEPROM memory, registers, hard disk, a removable disk, a CD-ROM, or any other form of a non-transitory computer-readable storage medium. An exemplary storage medium can be coupled to the processor device such that the processor device can read information from, and write information to, the storage medium. In the alternative, the storage medium can be integral to the processor device. The processor device and the storage medium can reside in an ASIC. The ASIC can reside in a user terminal. In the alternative, the processor device and the storage medium can reside as discrete components in a user terminal.

Conditional language used herein, such as, among others, “can,” “may,” “might,” “may,” “e.g.,” and the like, unless specifically stated otherwise, or otherwise understood within the context as used, is generally intended to convey that certain embodiments include, while other embodiments do not include, certain features, elements and/or steps. Thus, such conditional language is not generally intended to imply that features, elements and/or steps are in any way required for one or more embodiments or that one or more embodiments necessarily include logic for deciding, with or without other input or prompting, whether these features, elements and/or steps are included or are to be performed in any particular embodiment. The terms “comprising,” “including,” “having,” and the like are synonymous and are used inclusively, in an open-ended fashion, and do not exclude additional elements, features, acts, operations, and so forth. Also, the term “or” is used in its inclusive sense (and not in its exclusive sense) so that when used, for example, to connect a list of elements, the term “or” means one, some, or all of the elements in the list.

Disjunctive language such as the phrase “at least one of X, Y, Z,” unless specifically stated otherwise, is otherwise understood with the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present.

While the above detailed description has shown, described, and pointed out novel features as applied to various embodiments, it can be understood that various omissions, substitutions, and changes in the form and details of the devices or algorithms illustrated can be made without departing from the spirit of the disclosure. As can be recognized, certain embodiments described herein can be embodied within a form that does not provide all of the features and benefits set forth herein, as some features can be used or practiced separately from others. The scope of certain embodiments disclosed herein is indicated by the appended claims rather than by the foregoing description. All changes which come within the meaning and range of equivalency of the claims are to be embraced within their scope.

1. (canceled)

2. A computer-implemented method of online searching, the method comprising:
providing, by a computer system comprising computer hardware configured with specific executable instructions, over a network to a user terminal, a first user interface, the first user interface comprising a search field configured to receive keyword directory queries;
receiving, by the computer system, a search term from the user via the search field;
searching, using a search engine comprising hardware, for and identifying top level domain specific keyword directories that include the search term in domain names of the respective keyword directories,
wherein a given keyword directory has a top level domain, and the given directory comprises a first listing of website links, comprising domain names, of websites that offer products or services corresponding to one or more words in the domain name of the given keyword directory, and wherein the domain names included in the first listing have the same top level domain as the top level domain of the given keyword directory;
providing, by the computer system, search results to the user terminal, the search results including links to the identified keyword directories that include the search term in the domain names of the identified keyword directories;
receiving, by the computer system, a user activation of a link included in the search results, the activated link corresponding to a domain name describing a product or service;
generating, by the computer system, a second listing, the second listing corresponding to the activated link, wherein a given listing entry in the second listing corresponds to a website that offers the product or service described by the domain name corresponding to the activated link,
wherein activation of a second listing entry by the user causes a corresponding webpage to be presented.

3. The method as defined in claim 2, wherein identifying keyword directories that include the search term in domain names of the respective keyword directories further comprises:
identifying keyword directories that include only the search term in second level domain labels of the respective keyword directories;
identifying keyword directories that include the search term and other text in second level domain labels of the respective keyword directories;
causing the identified keyword directories that include only the search term in second level domain labels of the respective keyword directories to be positioned at a first location in the search results; and
causing the identified keyword directories that include the search term and other text in second level domain labels of the respective keyword directories to be positioned at a second location in the search results.

4. The method as defined in claim 2, wherein identifying keyword directories that include the search term in domain names of the respective keyword directories further comprises:
identifying keyword directories that include only the search term in second level domain labels of the respective keyword directories;
identifying keyword directories that include the search term in top level domains of the respective keyword directories;
causing the identified keyword directories that include only the search term in second level domain labels of the respective keyword directories to be positioned at a first location in the search results; and
causing the identified keyword directories that include the search term in top level domains of the respective keyword directories to be positioned at a second location in the search results.

5. The method as defined in claim 2, wherein identifying keyword directories that include the search term in domain names of the respective keyword directories further comprises identifying keyword directories that include the search term in second level domain labels of the respective keyword directories.

6. The method as defined in claim 2, wherein a domain name of a first keyword directory included in the identified keyword directories comprises a name of a geographic location.

7. The method as defined in claim 2, wherein the first user interface is provided via a webpage, the method further comprising enabling the user to limit the search to keyword directories having the same top level domain as the first user interface webpage.

8. The method as defined in claim 2, wherein the first user interface is provided via a webpage.

9. The method as defined in claim 2, wherein the first user interface enables the user to limit the search to keyword directories having user selected top level domains.

10. The method as defined in claim 2, wherein the search results are provided via a user interface that comprises a keyword directory search field.

11. The method as defined in claim 2, the method further comprising:
providing a plurality of user-selectable icons for display on the user terminal, the plurality of user-selectable icons comprising at least a keyword directory icon and a top level domain icon,
wherein the user can select one or more of the user-selectable icons, and
wherein the search term is composed of at least one keyword directory icon and at least one top level domain icon.

12. The method as defined in claim 2, the method further comprising:
providing a plurality of user-selectable icons for display on the user terminal, the plurality of user-selectable icons comprising at least a keyword directory icon,
wherein the user can select one or more of the user-selectable icons, and
wherein the search term is composed of at least the keyword directory icon and user entered text.

13. The method as defined in claim 2, the method further comprising:
providing a plurality of user-selectable icons for display on the user terminal, the plurality of user-selectable icons comprising at least a keyword directory icon,
wherein the user can select one or more of the user-selectable icons, and
wherein the search term is composed of at least the keyword directory icon.

14. The method as defined in claim 2, the method further comprising:
providing a plurality of user-selectable icons for display on the user terminal, the plurality of user-selectable icons comprising at least a top level domain icon,
wherein the user can select one or more of the user-selectable icons, and
wherein the search term is composed of at least the top level domain icon and user entered text.

15. A system, comprising:
a network interface configured to communicate over a network;
a computing system comprising one or more computing devices; and
a computer storage system comprising a non-transitory storage device, said computer storage system having stored thereon executable program instructions that direct the computer system to at least:
provide over a network, via the network interface, to a user terminal, a first user interface, the first user interface comprising a search field configured to receive keyword directory queries;
receive a search term from the user via the search field;
use a search engine to identify top level domain specific keyword directories that include the search term in domain names of the respective keyword directories,
wherein a given keyword directory has a top level domain, and the given directory comprises a first listing of website links, comprising domain names, of websites that offer products or services corresponding to one or more words in the domain name of the given keyword directory, and wherein the domain names included in the first listing have the same top level domain as the top level domain of the given keyword directory;
provide search results to the user terminal, the search results including links to the identified keyword directories that include the search term in the domain names of the identified keyword directories;
receive a user activation of a link included in the search results, the activated link corresponding to a domain name describing a product or service;
provide a second listing, the second listing corresponding to the activated link, wherein a given listing entry in the second listing corresponds to a website that offers the product or service described by the domain name corresponding to the activated link,
wherein activation of a second listing entry by the user causes a corresponding webpage to be presented.

16. The system as defined in claim 15, wherein the identification of keyword directories that include the search term in domain names of the respective keyword directories further comprises:
identification of keyword directories that include only the search term in second level domain labels of the respective keyword directories;
identification of keyword directories that include the search term and other text in second level domain labels of the respective keyword directories;
cause the identified keyword directories that include only the search term in second level domain labels of the respective keyword directories to be positioned at a first location in the search results; and
cause the identified keyword directories that include the search term and other text in second level domain labels of the respective keyword directories to be positioned at a second location in the search results.

17. The system as defined in claim 15, wherein identification of keyword directories that include the search term in domain names of the respective keyword directories further comprises:
identification of keyword directories that include only the search term in second level domain labels of the respective keyword directories;
identification of keyword directories that include the search term in top level domains of the respective keyword directories;
cause the identified keyword directories that include only the search term in second level domain labels of the respective keyword directories to be positioned at a first location in the search results; and
cause the identified keyword directories that include the search term in top level domains of the respective keyword directories to be positioned at a second location in the search results.

18. The system as defined in claim 15, wherein identification of keyword directories that include the search term in domain names of the respective keyword directories further comprises identification of keyword directories that include the search term in second level domain labels of the respective keyword directories.

19. The system as defined in claim 15, wherein the first user interface is provided via a webpage, the method further comprising enabling the user to limit the search to keyword directories having the same top level domain as the first user interface webpage.

20. The system as defined in claim 15, wherein executable program instructions further direct the computer system to at least:
provide a plurality of user-selectable icons for display on the user terminal, the plurality of user-selectable icons comprising at least a keyword directory icon and a top level domain icon,
wherein the user can select one or more of the user-selectable icons, and
wherein the search term is composed of at least one keyword directory icon and at least one top level domain icon.

21. The system as defined in claim 15, wherein executable program instructions further direct the computer system to at least:
provide a plurality of user-selectable icons for display on the user terminal, the plurality of user-selectable icons comprising at least a keyword directory icon,
wherein the user can select one or more of the user-selectable icons, and
wherein the search term is composed of at least the keyword directory icon and user entered text.

22. The system as defined in claim 15, wherein executable program instructions further direct the computer system to at least:
provide a plurality of user-selectable icons for display on the user terminal, the plurality of user-selectable icons comprising at least a keyword directory icon,
wherein the user can select one or more of the user-selectable icons, and
wherein the search term is composed of at least the keyword directory icon.

23. The system as defined in claim 15, wherein executable program instructions further direct the computer system to at least:
provide a plurality of user-selectable icons for display on the user terminal, the plurality of user-selectable icons comprising at least a top level domain icon,
wherein the user can select one or more of the user-selectable icons, and
wherein the search term is composed of at least the top level domain icon and user entered text.

24. A computer storage system comprising a non-transitory storage device, said computer storage system having stored thereon executable program instructions that direct a computer system to at least:
provide over a network, via the network interface, to a user terminal, a first user interface, the first user interface comprising a search field configured to receive keyword directory queries;
receive a search term from the user via the search field;
use a search engine to identify top level domain specific keyword directories that include the search term in domain names of the respective keyword directories,
wherein a given keyword directory has a top level domain, and the given directory comprises a first listing of website links, comprising domain names, of websites that offer products or services corresponding to one or more words in the domain name of the given keyword directory, and wherein the domain names included in the first listing have the same top level domain as the top level domain of the given keyword directory;
provide search results to the user terminal, the search results including links to the identified keyword directories that include the search term in the domain names of the identified keyword directories;
receive a user activation of a link included in the search results, the activated link corresponding to a domain name describing a product or service;
provide a second listing, the second listing corresponding to the activated link, wherein a given listing entry in the second listing corresponds to a website that offers the product or service described by the domain name corresponding to the activated link,
wherein activation of a second listing entry by the user causes a corresponding webpage to be presented.

25. The computer storage system as defined in claim 24, wherein the identification of keyword directories that include the search term in domain names of the respective keyword directories further comprises:
identification of keyword directories that include only the search term in second level domain labels of the respective keyword directories;
identification of keyword directories that include the search term and other text in second level domain labels of the respective keyword directories;
cause the identified keyword directories that include only the search term in second level domain labels of the respective keyword directories to be positioned at a first location in the search results; and
cause the identified keyword directories that include the search term and other text in second level domain labels of the respective keyword directories to be positioned at a second location in the search results.

26. The computer storage system as defined in claim 24, wherein identification of keyword directories that include the search term in domain names of the respective keyword directories further comprises:
identification of keyword directories that include only the search term in second level domain labels of the respective keyword directories;
identification of keyword directories that include the search term in top level domains of the respective keyword directories;
cause the identified keyword directories that include only the search term in second level domain labels of the respective keyword directories to be positioned at a first location in the search results; and
cause the identified keyword directories that include the search term in top level domains of the respective keyword directories to be positioned at a second location in the search results.

27. The computer storage system as defined in claim 24, wherein identification of keyword directories that include the search term in domain names of the respective keyword directories further comprises identification of keyword directories that include the search term in second level domain labels of the respective keyword directories.

28. The computer storage system as defined in claim 24, wherein executable program instructions further direct a computer system to at least:
provide a plurality of user-selectable icons for display on the user terminal, the plurality of user-selectable icons comprising at least a keyword directory icon and a top level domain icon,
wherein the user can select one or more of the user-selectable icons, and
wherein the search term is composed of at least one keyword directory icon and at least one top level domain icon.

29. The computer storage system as defined in claim 24, wherein executable program instructions further direct a computer system to at least:
provide a plurality of user-selectable icons for display on the user terminal, the plurality of user-selectable icons comprising at least a keyword directory icon,
wherein the user can select one or more of the user-selectable icons, and
wherein the search term is composed of at least the keyword directory icon and user entered text.

30. The computer storage system as defined in claim 24, wherein executable program instructions further direct a computer system to at least:
provide a plurality of user-selectable icons for display on the user terminal, the plurality of user-selectable icons comprising at least a keyword directory icon,
wherein the user can select one or more of the user-selectable icons, and
wherein the search term is composed of at least the keyword directory icon.

31. The computer storage system as defined in claim 24, wherein executable program instructions further direct a computer system to at least:
provide a plurality of user-selectable icons for display on the user terminal, the plurality of user-selectable icons comprising at least a top level domain icon,
wherein the user can select one or more of the user-selectable icons, and
wherein the search term is composed of at least the top level domain icon and user entered text.
